(19) United States
(12) Patent Application Publication
(10) Pub. No.: US 2010/0178512 A1
(43) Pub. Date: Jul. 15, 2010

(54) CHANGING SURFACE PROPERTIES BY FUNCTIONALIZED NANOPARTICLES

(75) Inventors: Thomas Giesenberg, Oberwil (CH); Pascal Hayoz, Hofstetten (CH); Thomas Vogel, Haltingen (DE); Andreas Muhlebach, Frick (CH); Markus Frey, Rheinfelden (CH); Stephan Ilg, Giebenach (CH); Rachel Kohli Steck, Basel (CH); Laurent Michau, Rosenau (FR); Francois Rime, Delemont (CH)

Correspondence Address: BASF Performance Products LLC;Patent Department, 540 White Plains Road, P.O. Box 2005, Tarrytown, NY, 10591, US

(73) Assignee: CIBA CORPORATION, Tarrytown, NY (US)

(21) Appl. No.: 12/516,890

(22) PCT Filed: Nov. 26, 2007
(86) PCT No.: PCT/EP2007/062800

§ 371 Date: Dec. 9, 2009

(30) Foreign Application Priority Data
Dec. 6, 2006 (EP) 06125507.1

(51) Int. Cl. B32B 5/16; B05D 3/00; B05D 3/06; C08G 79/00; C08G 79/10; C08F 20/06; C08F 14/06; C08F 12/08

(52) U.S. Cl. 428/405; 427/535; 427/551; 427/541; 428/447; 428/457; 428/500; 428/696; 428/702; 528/9; 526/317.1; 526/344; 526/346; 977/773

(57) ABSTRACT

A process for modifying the surface of an inorganic or organic substrate with strongly adherent nanoparticles is described, providing to the surface modified substrate durable effects like hydrophobicity, hydrophilicity, electrical conductivity, magnetic properties, flame retardance, color, adhesion, roughness, scratch resistance, UV-absorbance, antimicrobial properties, antifouling properties, antiprotein properties, antistatic properties, antifog properties, release properties. In this process, an optional first step a) a low-temperature plasma, ozonization, high energy irradiation, corona discharge or a flame is caused to act on the inorganic or organic substrate, and in a second step b) one or more defined nanoparticles or mixtures of defined nanoparticles with monomers, containing at least one ethylenically unsaturated group, or solutions, suspensions or emulsions of the afore-mentioned substances, are applied, preferably at normal pressure, to the inorganic or organic substrate. In a third step c) suitable methods are applied to dry or cure those afore-mentioned substances and, optionally, in a fourth step d) a further coating is applied on the substrate so pretreated.

The invention relates to a process for the surface modification of substrates with functionalized nanoparticles, to the preparation of functionalized nanoparticles, to the use of such nanoparticle modified substrates as well as to novel functional nanoparticles.

The treatment of substrates with nanoparticles is e.g. described in WO04/090053 (antistatic laminate) and WO06/016800 (hydrophilic coating), where compositions of nanoparticles together with additional monomers and additional photoinitiators are applied on the substrates, and then the so coated surfaces of the substrates are hardened to graft the nanoparticles on the substrates.

The production of low-temperature plasmas and the plasma-assisted deposition of thin organic or inorganic layers, both under vacuum conditions and under normal pressure, have been known for some time. Fundamental principles and applications are described, for example, by H. Suhr, Plasma Chem. Plasma Process 3(1), 1, (1983). Plastics surfaces can be subjected to a plasma treatment and, as a result, a certain finish subsequently applied exhibits improved adhesion to the plastics substrate especially after low pressure treatment (see J. Friedrich et al., Surf. Coat. Technol. 59, 371 (1993)).

WO 00/24527 describes the plasma treatment of substrates with immediate vapour-deposition and grafting-on of photoinitiators in vacuo. A disadvantage, however, is that vapour-deposition requires the use of vacuum apparatus and, because of low deposition rates, is not very efficient and is not suitable for industrial applications having high throughput rates. According to WO 06/067061, a plastics surface first coated with a photoinitiator and then dried may be used as printing substrate.

WO03/048258 and WO06/044375 each describe the application of methacryloyloxypropyl-modified silica particles in combination with a photoinitiator to a pre-treated plastics surface with irradiation drying. WO00/22039 teaches the curing of mixtures containing silica-nanoparticles, modifying agent and cartain oligomers by electron beam or, in combination with a photoinitiator, by UV radiation.

Due to the often inadequate adhesion of nanoparticles on the substrates, especially on non-polar substrates such as polyethylene, polypropylene or fluorine-containing polyolefines, and the undesired presence of photoinitiators, improved functionalized nanoparticles and an improved process to modify the surface of substrates with functionalized nanoparticles is needed in the art.

It has been found that the adhesion of functionalized nanoparticles on the substrates can be made stronger and more durable by application of functional nanoparticles containing a polymerizable group, and preferably at least one further modifying group, chemically bonded to their surface. A preferred process comprises a preliminary plasma, corona discharge, ozonization, high energy radiation or flame treatment of these substrates prior to the addition of the nanoparticles. Using this new process, a strong and durable adhesion of functionalized nanoparticles on the substrate may be achieved without application of further photoinitiators to the substrate, even in the absence of any photoinitiators and/or monomers.

### SUMMARY OF THE INVENTION

Thus, the invention pertains to a process for modifying the surface of an inorganic or organic substrate with strongly adherent nanoparticles, which process is characterized in that nanoparticles containing at least one polymerizable group chemically bonded to their surface, or mixtures of such nanoparticles with monomers or/and oligomers, or a solution, suspension or emulsion containing said nanoparticles, are applied to the surface without addition of a photoinitiator, and the surface thus pretreated is radiation dried using suitable methods.

Pretreatment of the surface may be advantageous in many cases; a corresponding process for modifying the surface of an inorganic or organic substrate with strongly adherent nanoparticles thus comprises the additional step

a) a low-temperature plasma treatment, a corona discharge treatment, an ozonization, an ultra-violet irradiation and/or a flame treatment is carried out on the surface, and
besides b) application of nanoparticles containing at least one ethylenically unsaturated group chemically bonded, or mixtures of such nanoparticles with monomers or/and oligomers, or a solution, suspension or emulsion containing said nanoparticles, with or without addition of a photoinitiator, to the surface and subsequently drying by irradiation with electromagnetic waves using suitable methods (step c).

### DETAILS OF THE INVENTION

Using the process of the invention, it is possible to modify surface related properties such as release properties, antistatic properties, hydrophobic properties, hydrophilic properties, magnetic properties, electrical conductivity properties, strong adhesion properties to applied coatings, electrical insulating properties, thermal properties, scratch resistant properties, antifog properties, antimicrobial properties, electromagnetic shielding properties, electromagnetic radiation absorption properties, electroluminescent properties, fluorescent properties, phosphorescent properties, dirt repelling properties, anti icing properties, dyeing properties, barrier properties, magnetic properties, flame retardance properties, color, roughness, anti fouling properties, protein adhesion prevention properties etc.

In a preferred process of the invention, the polymerizable group on the nanoparticle surface is an ethylenically unsaturated group, and/or the radiation applied in the drying step is from the ultraviolet and/or visible range. Typical wavelengths of radiation used in this drying step are from the range 10-800 nm, for example 50-800 nm, preferably light of a wavelength from the range 200-700 nm, or 100-500 nm such as 150-500 nm. More preferred is typical UV radiation e.g. from the range 200-400 nm, especially 250-400 nm.

More specifically, the invention relates to a process for the production of strongly adherent nanoparticles on an inorganic or organic substrate, wherein

a) a low-temperature plasma treatment, a corona discharge treatment, an ozonization, ultra-violet-irradiation or a flame treatment is carried out on the inorganic or organic substrate,
b) one or more specific nanoparticles or mixtures of such nanoparticles with monomers or/and oligomers, containing at least one ethylenically unsaturated group, or solutions, suspensions or emulsions of the afore-mentioned substances, are applied to the inorganic or organic substrate, and
c) using suitable methods those afore-mentioned substances are optionally dried and/or are irradiated with electromagnetic waves, characterized in that in step b) is used at least one nanoparticle of the formula I,

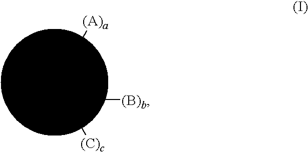

wherein
   the core nanoparticle is containing an inorganic or organic material and where
   A is an organic substituent bound to the core nanoparticle surface and containing at least one reactive polymerizable group L;
   B is an organic substituent bound to the core nanoparticle surface and containing at least one photoinitiator moiety G;
   C is an organic substituent bound to the core nanoparticle surface containing at least one functional group Z;
   a is a number from 1 to nₐ;
   b is a number from 0 to n_{b};
   c is a number from 0 to n_{c};
   where the sum of nₐ+n_{b}+n_{c} is a number from 1 up to n_{I}, where n_{I} is limited by the geometry and surface area of the core nanoparticle and the steric requirements of the respective substituents A, B, C.

Advantageous organic substituents include

### A as

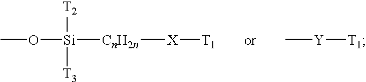

### B as

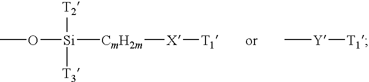

and

### C as

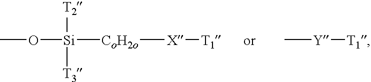

where
X, Y, X′, Y′, X″ and Y″, and n, m, o, T₁, T₁′, T₁″, T₂, T₂′, T₂″, T₃, T₃′, T₃″ are as defined below.

Usually, in the case of an inorganic core nanoparticle,

### A is

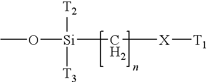

### B is

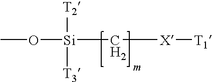

### C is

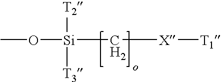

X, X′ and X″ are independently of one another —O—, —S—, —NR₁—, —NR₁₀₁—, —OCO—, —SCO—, —NR₁CO—, —OCOO—, —OCONR₁—, —NR₁COO—, —NR₁CONR₂— or a single bond;
n, m or o are independently of each other numbers from 0 to 8, preferably from the range 0 to 6 such as 1 to 6, especially 0 to 3 such as 3, and
if n is 0, then X is a single bond;
if m is 0, then X′ is a single bond;
if o is 0, then X″ is a single bond;
and in the case of an organic core nanoparticle

### A is —Y-T₁

### B is —Y′-T₁′

### C is —Y″-T₁″;

Y, Y′ and Y″ are independently of one another —O—, —S—, —NR₁—, —OCO—, —SCO—, —NR₁CO—, —OCOO—, —OCONR₁—, —NR₁COO—, —NR₁CONR₂—, —COO—, —CONR₁—, —CO— or a single bond;
R₁ and R₂ are independently of one another hydrogen, C₁-C₂₅ alkyl, C₃-C₂₅ alkyl which is interrupted by oxygen or sulfur, C₆-C₁₂ aryl or R;
R₁₀₁ is C₁-C₂₄acyl;
T₁ has the meaning of R and contains at least one reactive group L;
T₁′ has the meaning of R and contains at least one photoinitiator moiety G;
T₁″ has the meaning of R and contains at least one moiety Z;
T₂, T₂′, T₂″, T₃, T₃′, T₃″ are independently of one another hydrogen, C₁-C₂₅alkyl, C₃-C₂₅alkyl which is interrupted by oxygen or sulphur, C₂-C₂₄alkenyl, phenyl, C₇-C₉phenylalkyl, —OR₃,

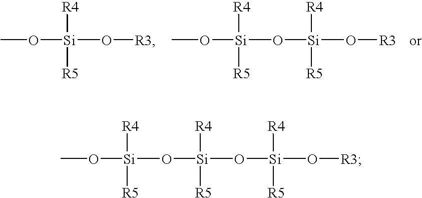

R₃ is hydrogen, C₁-C₂₅alkyl, C₃-C₂₅alkyl which is interrupted by oxygen or sulphur, C₂-C₂₄alkenyl, phenyl, C₇-C₉phenylalkyl,

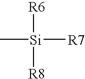

or nanoparticle surface;
R₄ and R₅ independently of each other are hydrogen, C₁-C₂₅alkyl, C₃-C₂₅alkyl which is interrupted by oxygen or sulphur, C₂-C₂₄alkenyl, phenyl, C₇-C₉phenylalkyl or —OR₃;
R₆, R₇ and R₈ independently of each other are hydrogen, C₁-C₂₅alkyl, C₃-C₂₅alkyl which is interrupted by oxygen or sulphur, C₂-C₂₄alkenyl, phenyl or C₇-C₉phenylalkyl;
R is C₁-C₂₀alkyl, C₅-C₁₂cycloalkyl, C₂-C₂₀alkenyl, C₅-C₁₂cycloalkenyl, C₂-C₂₀alkynyl, C₆-C₁₄aryl, C₁-C₂₀alkyl substituted by one or more D, C₂-C₂₀alkyl interrupted by one or more E, C₂-C₂₀alkyl substituted by one or more D and interrupted by one or more E, C₅-C₁₂cycloalkyl substituted by one or more D, C₂-C₁₂cycloalkyl interrupted by one or more E, C₂-C₁₂cycloalkyl substituted by one or more D and interrupted by one or more E, C₂-C₂₀alkenyl substituted by one or more D, C₃-C₂₀alkenyl interrupted by one or more E, C₃-C₂₀alkenyl substituted by one or more D and interrupted by one or more E, C₅-C₁₂cycloalkenyl substituted by one or more D, C₃-C₁₂cycloalkenyl interrupted by one or more E, C₃-C₁₂cycloalkenyl substituted by one or more D and interrupted by one or more E, or C₆-C₁₄aryl substituted by one or more D or, provided that X, X′, X″, Y, Y′ or Y″ has the meaning of a single bond, R can be L, G, or Z;
D is L, G, Z, R₉, OR₉, SR₉, NR₉R₁₀, halogen, NO₂, CN, O-glycidyl, O-vinyl, O-allyl, COR₉, NR₉COR₁₀, COOR₉, OCOR₉, CONR₉R₁₀, OCOOR₉, OCONR₉R₁₀, NR₉COOR₁₀, SO₃H, COOM_{C}, COO⁻, SO₃⁻ or SO₃M_{C}, phenyl, C₇-C₉alkylphenyl;

### E is O, S, COO, OCO, CO, NR₉, NCOR₉, NR₉CO, CONR₉, OCOO, OCONR₉, NR₉COO, SO₂, SO,

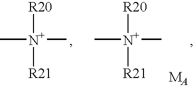

### CR₉═CR₁₀ or

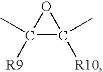

C≡C, N═C—R₉, R₉C═N, C₅-C₁₂Cycloalkylene, phenylene and/or phenylene substituted by D;

### L is

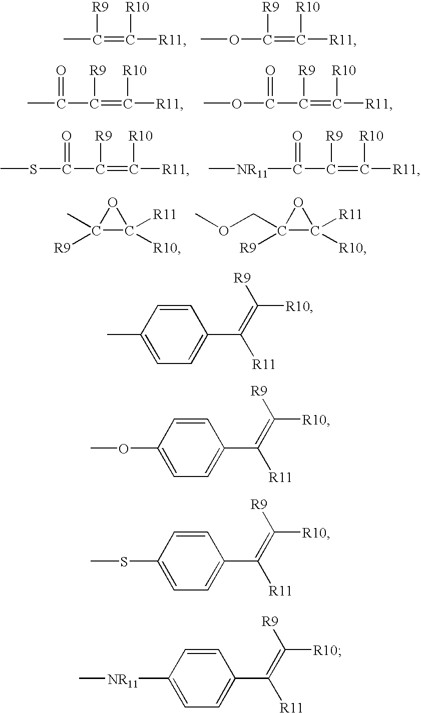

R₉, R₁₀ or R₁₁ independently of one another are hydrogen, C₁-C₁₂alkyl or phenyl;
G is a photo initiator moiety;
Z is halogen, CN, NO₂ or NCO, or a cationic moiety, anionic moiety, hydrophilic moiety, hydrophobic moiety, polysiloxane moiety, polyhalogenated moiety, polymerizable moiety, UV-absorber moiety, hindered-amine-light-stabilizer moiety, IR-absorbing moiety, dye moiety, polyethyleneglycole moiety, polypropyleneglycole moiety, fluorescent moiety, phosphorescent moiety, antimicrobial moiety, flame retarding moiety, antioxidant moiety, metal complex or a polymer;
M_{C} is an inorganic or organic cation;
M_{A} is an inorganic or organic anion.

In the case of a core nanoparticle comprising an oxygen compound of the elements Si, Al, In, Ga, Ti, Zn, Sn, Zr, Fe, Sb, for example,

A often is

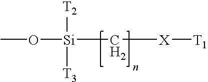

B often is

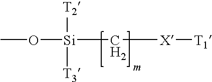

C often is

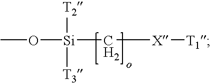

and in the case of an organic polymer or metal core nanoparticle
A often is —Y-T₁
B often is —Y′-T₁′
C often is —Y″-T₁′.

Generally, R as T₁ contains at least one reactive group L; R as T₁′ contains at least one photoinitiator moiety G; and R as T₁″ contains at least one moiety Z; this is to be understood as R being identical with said moiety, or R being substituted by one or more of said moieties. While one class of residues R generally may contain more than one, and more than one type, of functional moiety, e.g. R containing L and G, R containing L and Z, R containing G and Z, R containing L and G and Z, important components from the industrial point of view especially are those wherein R as T₁ contains at least one reactive group L and no G and no Z; R as T₁′ contains at least one photoinitiator moiety G and no L and no Z; and R as T₁″ contains at least one moiety Z and no reactive group L and no G. The functional moieties L, G and Z thereby may bond directly to R, or may be bonded over a spacer group such as Q₁, Q₂ or Q₃ (see definitions below).

G as a photoinitiator moiety is preferably selected from benzoins, benzil ketals, acetophenones, hydroxyalkylphenones, aminoalkylphenones, acylphosphine oxides, acylphosphine sulfides, acyloxyiminoketones, alkylamino-substituted ketones, such as Michler's ketone, peroxy compounds, dinitrile compounds, halogenated acetophenones, phenylglyoxalates, benzophenones, oximes and oxime esters, thioxanthones, coumarines, ferrocenes, titanocenes, onium salts, sulphonium salts, iodonium salts, diazonium salts, borates, triazines, bisimidazoles, polysilanes and dyes, each including derivatives thereof;

Z may, for example, be selected from, halogen, CN, NO₂, NCO, alkyls, aryls, alkylaryls, aryl-1,3,5-triazines, benzotriazoles, benzophenones, oxalanilides, cinnamates, 2,2,6,6-tetraalkylpiperidines, 2,6-polysiloxanes, dialkylphenoles, (per)halogenated alkyls, (per)halogenated aryls, (per)halogenated alkylaryls, polyethyleneglykoles, polypropyleneglykoles, hydroxylated alkyls, hydroxylated aryls, hydroxylated alkylaryls, ammonium salts, phosphonium salts, sulphonium salts, amines, carboxylates, cationic groups, anionic groups, sulfides, polycyclic groups, heterocyclic groups, metal complexes or a polymer, each including derivatives thereof. Of special interest is Z as:
a polysiloxane moiety, e.g. selected from polydimethylsiloxanes (characterized by containing the structural unit

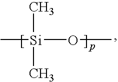

see below), and derivatives thereof;
a halogenated moiety e.g. selected from halogenated alkyls, halogenated aryls, halogenated alkylaryls, perhalogenated moieties such as perhalogenated alkyls, perhalogenated aryls, perhalogenated alkylaryls;
a dye moiety;
a phosphorescent moiety;
a fluorescent moiety;
a cationic moiety or ammonium moiety e.g. selected from ammonium salts, phosphonium salts, sulphonium salts;
an anionic moiety;
an IR-absorbing moiety;
a metal complex moiety; a transition metal complex moiety.

Examples for (per)halogenated moieties include —(CF₂)_{f}—CF₃, where f is a number from 0 to 100;

examples for polysiloxane moieties include those of the formulae

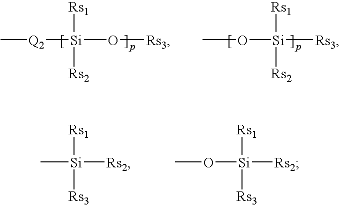

examples for cationic moieties include those of the formulae

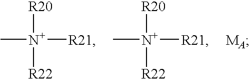

with meanings of symbols as given further below.

Preferred G are selected from the formulae

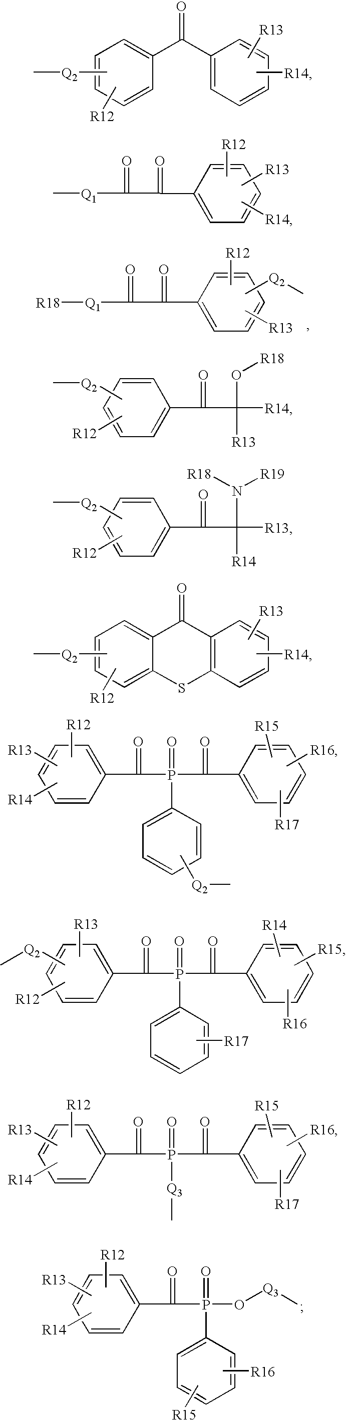

### Q₁ is O, S or NR₉;

Q₂ is O, S, NR₉, COO, OCO, CONR₉, NR₉CO, CO, single bond or C₁-C₆ alkylene;
Q₃ is single bond or C₁-C₆ alkylene;
R₁₂, R₁₃, R₁₄, R₁₅, R₁₆ or R₁₇ are each independently of one another Q₄-R_{G} or R_{G}, where two neighbouring substituents selected from R₁₂ to R₁₇ can optionally form a ring;
R₁₈ or R₁₉ are each independently of one another R_{G}, where R₁₈ and R₁₉ can optionally form a ring;
Q₄ is O, S, COO, OCO, CO, NR₉, NCOR₉, NR₉CO, CONR₉, OCOO, OCONR₉, NR₉COO, SO₂, SO or CR₉═CR₁₀;
R_{G} is hydrogen, C₁-C₂₀alkyl, C₅-C₁₂cycloalkyl, C₂-C₂₀alkenyl, C₅-C₁₂cycloalkenyl, C₂-C₂₀alkynyl, C₆-C₁₄aryl, C₁-C₂₀alkyl substituted by one or more D, C₂-C₂₀alkyl interrupted by one or more E, C₂-C₂₀alkyl substituted by one or more D and interrupted by one or more E, C₅-C₁₂cycloalkyl substituted by one or more D, C₂-C₁₂cycloalkyl interrupted by one or more E, C₂-C₁₂cycloalkyl substituted by one or more D and interrupted by one or more E, C₂-C₂₀alkenyl substituted by one or more D, C₃-C₂₀alkenyl interrupted by one or more E, C₃-C₂₀alkenyl substituted by one or more D and interrupted by one or more E, C₅-C₁₂cycloalkenyl substituted by one or more D, C₃-C₁₂cycloalkenyl interrupted by one or more E, C₃-C₁₂cycloalkenyl substituted by one or more D and interrupted by one or more E, or C₆-C₁₄aryl substituted by one or more D.

Preferred Z is selected from halogen, C₁-C₅₀alkyl, C₂-C₂₅₀alkyl which is interrupted by one or more oxygen, C₂-C₅₀alkyl which is substituted by one or more hydroxyl, C₂-C₅₀alkyl which is interrupted by one or more oxygen and substituted by one or more hydroxyl, -Q₂-C₆-C₁₈ aryl,

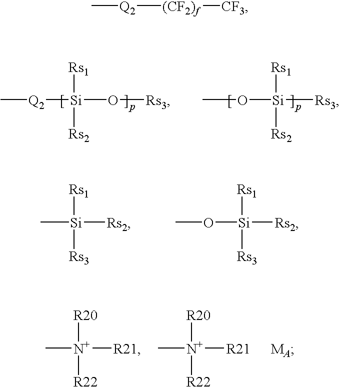

Rₛ₁, Rₛ₂ or Rₛ₃ are independently of one another hydrogen, C₁-C₂₅alkyl, C₁-C₂₅alkyl which is interrupted with oxygen or sulphur, phenyl, C₇-C₉phenylalkyl, —CH₂—CH═CH₂,

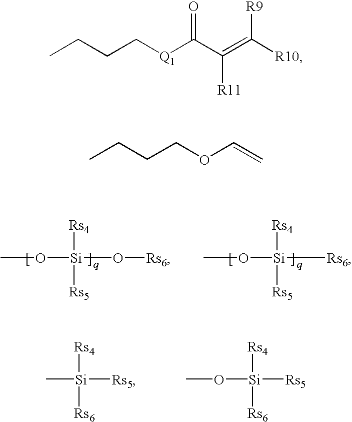

Rₛ₄, Rₛ₅ or Rₛ₆ are independently of one another hydrogen, C₁-C₂₅alkyl, C₁-C₂₅alkyl which is interrupted with oxygen or sulphur, phenyl, C₇-C₉phenylalkyl, —CH₂—CH═CH₂,

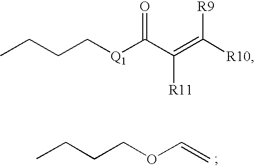

R₂₀, R₂₁ or R₂₂ are independently of one another R_{G};
f is a number from 0 to 100;
p is a number from 0 to 100;
q is a number from 0 to 100;
with all other symbols as defined above.

In preferred nanoparticles, R is C₁-C₂₀alkyl, C₅-C₁₂cycloalkyl, phenyl, naphthyl, biphenyl, C₁-C₂₀alkyl substituted by one or more D, C₂-C₂₀alkyl interrupted by one or more E, C₂-C₂₀alkyl substituted by one or more D and interrupted by one or more E, C₅-C₁₂cycloalkyl substituted by one or more D, C₂-C₁₂cycloalkyl interrupted by one or more E, C₂-C₁₂cycloalkyl substituted by one or more D and interrupted by one or more E, or phenyl substituted by one or more D or, provided that X, X′ or X″ has the meaning of a single bond, R can be L, G, Z;

D is L, G, Z, R₉, OR₉, SR₉, NR₉R₁₀, halogen, O-glycidyl, O-vinyl, O-allyl, COR₉, NR₉COR₁₀, COOR₉, OCOR₉, CONR₉R₁₀, SO₃H, COO⁻, SO₃⁻, COOM_{C} or SO₃M_{C}, phenyl, C₇-C₉alkylphenyl;

### E is O, S, COO, OCO, CO, NR₉, NCOR₉, NR₉CO, CONR₉,

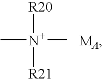

### CR₉═CR₁₀, or

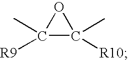

### L is

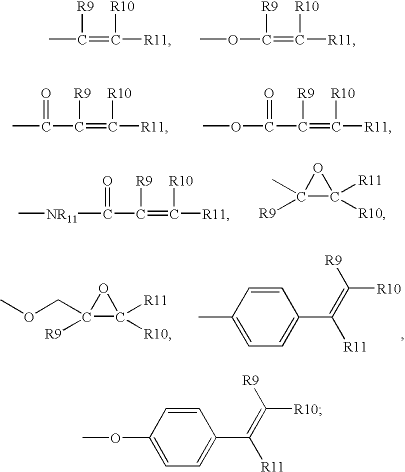

G is a group selected from

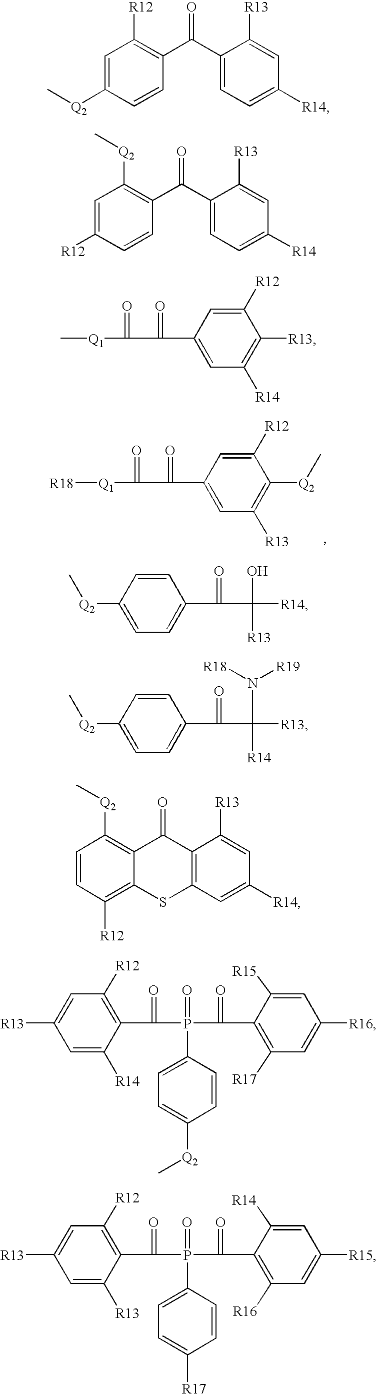

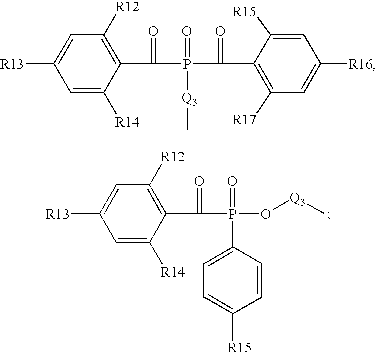

### Q₄ is O, S, COO, OCO, CO, NR₉, NCOR₉, NR₉CO, CONR₉;

R_{G} is hydrogen, C₁-C₂₀alkyl, C₅-C₁₂cycloalkyl, phenyl, naphthyl, biphenyl, C₁-C₂₀alkyl substituted by one or more D, C₂-C₂₀alkyl interrupted by one or more E, C₂-C₂₀alkyl substituted by one or more D and interrupted by one or more E, C₅-C₁₂cycloalkyl substituted by one or more D, C₂-C₁₂cycloalkyl interrupted by one or more E, C₂-C₁₂cycloalkyl substituted by one or more D and interrupted by one or more E, or phenyl substituted by one or more D;
and all the other substituents are as defined above.

Of interest are nanoparticles, especially of the formula (I), wherein

X, X′ and X″ are independently of one another —O—, —S—, —NR₁—, —OCO—, —NR₁CO— or a single bond;
n, m or o are independently of each other numbers from 0 to 6;
R₁ and R₂ are independently of one another hydrogen, C₁-C₁₂ alkyl, C₃-C₂₅ alkyl which is interrupted by oxygen, phenyl or R;
T2, T2′, T2″, T3, T3′, T3″ are independently of one another hydrogen, C₁-C₂₅alkyl, C₃-C₂₅alkyl which is interrupted by oxygen, C₂-C₂₄alkenyl, phenyl, C₇-C₉phenylalkyl, —OR₃,

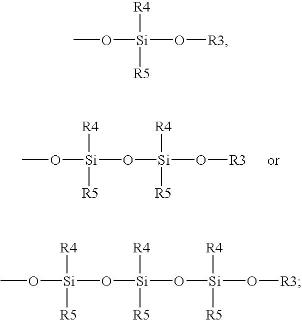

R₃ is hydrogen, C₁-C₂₅alkyl, C₃-C₂₅alkyl which is interrupted by oxygen, C₂-C₂₄alkenyl, phenyl, C₇-C₉phenylalkyl,

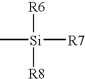

or nanoparticle surface;
R₄ and R₅ independently of each other are hydrogen, C₁-C₂₅alkyl, C₃-C₂₅alkyl which is interrupted by oxygen, C₂-C₂₄alkenyl, phenyl, C₇-C₉phenylalkyl or —OR₃;
R₆, R₇ and R₈ independently of each other are hydrogen, C₁-C₂₅alkyl, C₃-C₂₅alkyl which is interrupted by oxygen, C₂-C₂₄alkenyl, phenyl or C₇-C₉phenylalkyl;
R is C₁-C₂₀alkyl, phenyl, C₁-C₂₀alkyl substituted by one or more D, C₂-C₂₀alkyl interrupted by one or more E, C₂-C₂₀alkyl substituted by one or more D and interrupted by one or more E or phenyl substituted by one or more D or, provided that X, X′ or X″ has the meaning of a single bond, R can be L, G or Z;

### E is O, S, COO, OCO, CO, NR₉, NCOR₉, NR₉CO, CONR₉,

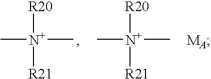

### L is

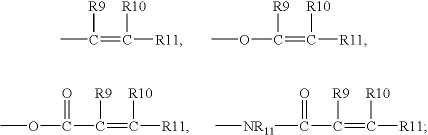

R₉, R₁₀ or R₁₁ independently of one another are hydrogen, C₁-C₁₂alkyl;
R₁₂, R₁₃, R₁₄, R₁₅, R₁₆ or R₁₇ are each independently of one another hydrogen, C₁-C₁₂alkyl, C₁-C₁₂alkoxy or phenyl where two neighbouring substituents R₁₃ and R₁₄ can optionally form a ring;
R₁₈ or R₁₉ are each independently of one another hydrogen, C₁-C₁₂alkyl or phenyl, where R₁₈ and R₁₉ can optionally form a ring;
R₂₀, R₂₁ or R₂₂ are independently of one another hydrogen, C₁-C₁₂alkyl, C₁-C₁₂alkyl interrupted with O, S or NR₉, C₁-C₁₂alkyl substituted with one or more COOM_{C}, SO₃M_{C}, COO⁻, SO₃⁻, or which are phenyl or benzyl;
especially those, wherein
T2, T2′, T2″, T3, T3′, T3″ are independently of one another hydrogen, C₁-C₁₂alkyl, phenyl, —OR₃,

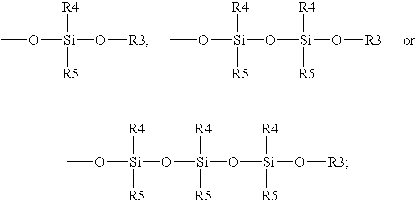

R₃ is hydrogen, C₁-C₁₂alkyl, phenyl,

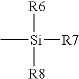

or nanoparticle surface;
R₄ and R₅ independently of each other are hydrogen, C₁-C₁₂alkyl, phenyl or —OR₃;
R₆, R₇ and R₈ independently of each other are hydrogen, C₁-C₁₂alkyl or phenyl;
D is L, G, Z, R₉, OR₉, SR₉, NR₉R₁₀, COR₉, NR₉COR₁₀, COOR₉, OCOR₉, CONR₉R₁₀, SO₃H, COO⁻, SO₃⁻, COOM_{C} or SO₃M_{C}, phenyl;

### E is O, S, COO, OCO, NR₉, NCOR₉, NR₉CO, CONR₉,

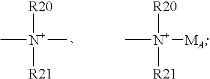

most especially those, wherein
D is L, G, Z, R₉, OR₉, SR₉, NR₉R₁₀, COR₉, COOR₉, OCOR₉, CONR₉R₁₀, SO₃H, COO⁻, SO₃⁻, COOM_{C} or SO₃M_{C}, phenyl;

### E is O, S, COO, OCO, NR₉,

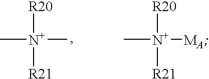

### L is

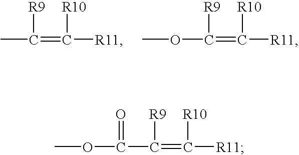

G is a group selected from

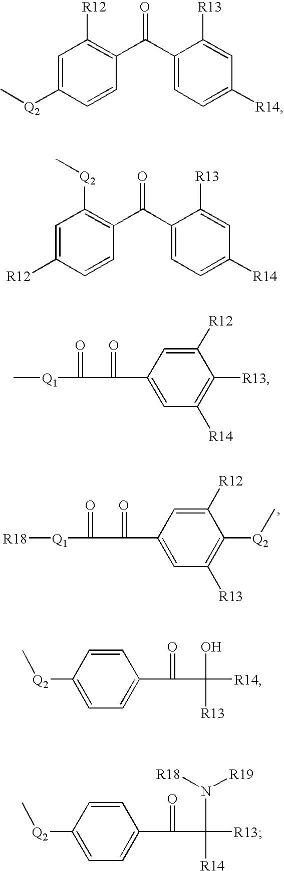

Z is halogen, C₁-C₅₀alkyl, C₁-C₂₅₀alkyl which is interrupted by one or more oxygen, C₁-C₅₀alkyl which is interrupted by one or more oxygen and substituted by one or more hydroxyl, -Q₂-(CF₂)_{f}—CF₃,

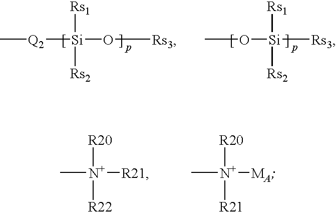

Rₛ₁, Rₛ₂ or Rₛ₃ are independently of one another hydrogen, C₁-C₁₂alkyl, phenyl, —CH₂—CH═CH₂,

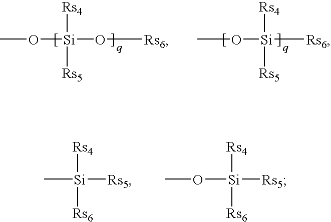

Rₛ₄, Rₛ₅ or Rₛ₆ are independently of one another hydrogen, C₁-C₁₂alkyl, phenyl, —CH₂—CH═CH₂,

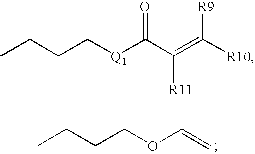

and all other substituents are as defined above.

Preferred T₁ include, for example, the moieties allyl, acryloyl, methacryloyl, as well as these moieties attached to X over a spacer group such as C₁-C₆alkylene, C₃-C₆hydroxyalkylene, C₁-C₆alkylene-O—, C₃-C₆hydroxyalkylene-O—, C₁-C₆alkylene-NR₁—, C₃-C₆hydroxyalkylene-NR₁—, C₁-C₆alkylene-NR₁₀₁—, C₃-C₆hydroxyalkylene-NR₁₀₁—, C₃-C₅₀alkylene interrupted by O such as polyoxyethylene:

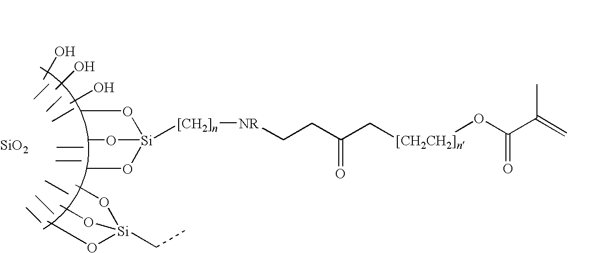

for example, with n being from the range 2-6, n′ being from the range 2-20, R being H or acetyl.

R₁₀₁ as a(n acyl) substituent on nitrogen is usually chosen in cases where lower basicity of the particle is desired, e.g. for preventing premature reaction or polymerization of other components applied together with the particle.

Organic substituents bond to the nanoparticle usually by reactive oxygen or sulfur groups (e.g. via —O— or —S—) on the surface of said particle; S-bonding is more preferred in case of a metallic nanoparticle (e.g. an Au particle), while O-bondings as in the above formulae are more preferred in case of an oxydic nanoparticle. Organic substituents bind preferably through groups like e.g. —O—, —S—, —COO—, —OCO—, —NR₁CO—, —CONR₁ (as defined for Y) to an organic nanoparticle.

Nanoparticles suitable for use in the process according to the invention usually are of the formula I as defined above. Said nanoparticles of the formula I are in particular suitable and mandatory in step b).

One type of nanoparticle or mixtures of different nanoparticles can be used. There can be any ratio of nₐ:n_{b}:n_{c} for the types of substituents A, B and C. On one nanoparticle there can be all the same or different kinds of substituents of type A containing a reactive group, all the same or different kinds of substituents of type B containing a photoinitiator moiety and all the same or different kinds of substituents of type C containing a functional group, which means that different reactive groups can be present on different substituents of type A, different photoinitiator groups can be present on different substituents B and different functional groups can be present on different substituents C on the same nanoparticle.

Nanoparticles of the formula (I) useful in step b) include those wherein a>0, b=0, c=0; or preferably where a>0, b=0, c>0 or where a>0, b>0, c>0.

The core nanoparticles are containing inorganic material e.g. selected from silicon oxide, silica gel, Al₂O₃, TiO₂, silicon oxide-coated TiO₂, ZnO, SnO₂, ZrO₂, Ag, Au, Cu, Sb—SnO₂, Fe₂O₃, magnetite, IndiumTinOxide, antimony-doped tin oxide (ATO), indium oxide, antimony oxide, fluorine-doped tin oxide, phosphorous-doped tin oxide, zinc antimonite, indium doped zinc oxide, or containing organic polymeric materials (description of polymers see description of organic substrates below), which are then modified chemically to obtain compounds of formula (I).

The nanoparticle core can be dense or porous.

The core nanoparticle usually consists of only one type of material; however, it is alternatively possible to use a core nanoparticle which comprises an inner core consisting of one material, e.g. a metal or an inorganic oxide, which is covered by one or more layers by another material, e.g. an organic polymer material or another inorganic oxide.

The core nanoparticle preferably contains an inorganic material such as silicon oxide, Al₂O₃, TiO₂, silicon oxide-coated TiO₂, ZnO, SnO₂, ZrO₂, Ag, Au, Cu, Sb—SnO₂, Fe₂O₃, magnetite, IndiumTinOxide (ITO), antimony-doped tin oxide (ATO), indium oxide, antimony oxide, fluorine-doped tin oxide, phosphorous-doped tin oxide, zinc antimonite or indium doped zinc oxide; more preferably silicon oxide, Al₂O₃, TiO₂, ZnO, SnO₂, ZrO₂, Sb—SnO₂, Fe₂O₃, magnetite, IndiumTinOxide (ITO), antimony-doped tin oxide (ATO) or indium oxide. Preferred are nanoparticle core materials are also selected from silicon oxide, Al₂O₃, TiO₂, ZnO, SnO₂, ZrO₂, Fe₂O₃, magnetite, IndiumTinOxide (ITO) or antimony-doped tin oxide (ATO). Of special industrial interest is silicon oxide (SiO₂), especially in its amorphous form.

The core nanoparticle usually expresses said inorganic materials on its surface, and preferably consists on one of said materials.

The inorganic nanoparticles (cores) can be produced by sol-gel processes, vapor deposition techniques etc.; the organic nanoparticles can e.g. be produced by microencapsulation techniques (described e.g. in WO 2005/023878). Inorganic nanoparticles as e.g. MT-ST (silicon oxide nano particles) from Nissan Chemical American Corporation, T-1 (ITO) from Mitsubishi Materials Corporation, Passtran (ITO, ATO) form Mitsui Mining & Smelting Co., Ltd., SN-100P (ATO) from Ishihara Sangyo Kaisha, Ltd., NanoTek ITO from C.I. Kasei Co., Ltd., ATO and FTO from Nissan Chemical Industries, Ltd., and other nano particles, e.g. disclosed in WO 2004/090053 are commercially available as e.g. dispersions, e.g. in water, methyl ethyl ketone or alcohols.

The preparation of the compounds of the formula (I) may be carried out in analogy to methods known in the art, e.g. as described in WO06045713 or WO05040289 and literature cited therein, or US-A-2004-138343, or to the examples given below. In general, the particle surface is first modified with a suitable silane coupling agent introducing an active linking group, which is then reacted with the agent(s) introducing the desired functionality or functionalities. Alternatively, the unmodified particle may be reacted directly with one or more coupling agents containing the desired functionality or functionalities. Reaction with more than one modifying agent may be carried out simultaneously or subsequently.

A variety of components as mentioned above, e.g. polymerizable moieties, photoinitiators or other functional components such as additives, may be chemically bonded to nanoparticle surfaces such as silica, alumina and silicon aluminum oxide. Possible synthetic routes include the following ones:
1) Particles showing active linkage groups such as —SH or —NH₂ (prepared e.g. in accordance or analogy to Example 1 of WO06045713) may easily be surface modified with additives bearing, for instance, a functional group selected from ester-, epoxy-, carboxy-, carbonyl-, acrylic-, methacrylic-, alkylhalogenide-, alkylsulfate-, anhydride-, terminal double bond-, nitrile- and α,β-unsaturated carbonyl-groups. The chemistry of these substances and the molecular organic syntheses (like nucleophilic substitutions, nucleophilic additions, Michael additions, ring-opening reactions, radical addition, etc.) is well known or can easily be adapted to the present solid phase organic chemistry (see also Ex. 9, 10, 11, etc. of WO06045713).
2) Particles showing functional groups on their surfaces such as ester-, epoxy-, carboxy-, carbonyl, acrylic-, methacrylic-, alkylhalogenide-, alkylsulfate-, anhydride-, terminal double bond-, nitrile- and for instance α,β-unsaturated carbonyl-groups may easily be further reacted with an additive bearing a group like —SH, —RNH or —NH₂ with the chemical reactions mentioned above.
3) Components such as additives containing a group —OH, —RNH or —NH₂ may be activated by using acryloylchlorid under basic conditions to generate a functional acrylate (acylation), which may easily be reacted with particles bearing —SH or —NH₂ groups by using a Michael addition; other syntheses leading to functional groups mentioned under 1) and 2) are well known and described in standard chemical literature.
4) Components such as additives may be functionalized by using a reactive agent, such as an alkoxysilane, using functional groups and mechanisms as mentioned under 1), 2) or 3) above, and then directly grafted onto the particle surface, e.g. oxide particle surface such as nano-silica using a state of the art silanisation reaction.

In general, the reactions can be carried out without using a solvent, e.g. with one of the reaction components which is liquid acting as solvent. It is also possible, however, to carry out the reactions in an inert solvent. Examples of suitable solvents are aliphatic or aromatic hydrocarbons such as alkanes and alkane mixtures, cyclohexane, benzene, toluene or xylene, alcohols like methanol or ethanol, ethers like diethylether, dibutylether, dioxane, tetrahydrofuran (THF), for example.

The reactions are conveniently carried out at temperatures adapted to the starting materials and solvents used. The temperatures and other reaction conditions required for the corresponding reactions are generally known and are familiar to the skilled worker.

The reaction products can be separated and purified by general, customary methods, for example using centrifugation, precipitation, distillation, recrystallization etc.

Some of the nanoparticles of the present invention are novel. The invention therefore includes a nanoparticle of the formula I, wherein both a and c are 1 or larger than 1 and Z is selected from polysiloxane moieties; halogenated moieties; perhalogenated moieties; dye moieties; phosphorescent moieties; fluorescent moieties; cationic moieties; ammonium moieties; anionic moieties; IR-absorbing moieties; metal complex moieties; transition metal complex moieties; and a compound of the formula I wherein c is 0 and A is a moiety of the formula

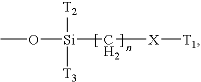

where
X is —NR₁₀₁—, R₁₀₁ is C₁-C₂₄acyl, and all other symbols are as defined above.

Preferred definitions for novel particles are, within the above condition, as defined above for compounds of the formula I.

Furthermore preferred is a novel nanoparticle of the formula I wherein both b and c are 0 comprises a core of SiO₂, Al₂O₃ or mixed SiO₂ and Al₂O₃, and on the surface a covalently bound radical of the formula II

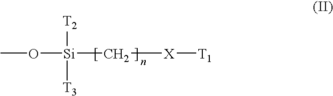

wherein

### X is

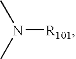

T₁ is C₂-C₂₄alkenyl, C₅-C₁₂cycloalkenyl, or a polymerizable group L or C₁-C₂₀alkyl substituted by a polymerizable group L, where L is as defined above;
T₂ and T₃ independently of each other are hydrogen, C₁-C₂₅alkyl, C₃-C₂₅alkyl which is interrupted by oxygen or sulfur; C₂-C₂₄alkenyl, phenyl, C₇-C₉phenylalkyl, —OR₅,

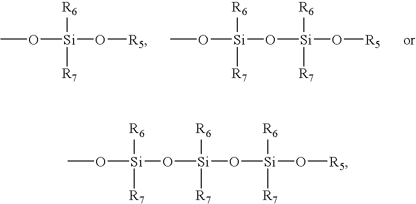

R₄ is hydrogen, C₁-C₂₅alkyl or C₃-C₂₅alkyl which is interrupted by oxygen or sulfur;
R₅ is hydrogen, C₁-C₂₅alkyl, C₃-C₂₅alkyl which is interrupted by oxygen or sulfur; C₂-C₂₄alkenyl, phenyl, C₇-C₉phenylalkyl,

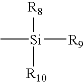

or the nanoparticle surface,
R₆ and R₇ independently of each other are hydrogen, C₁-C₂₅alkyl, C₃-C₂₅alkyl which is interrupted by oxygen or sulfur; C₂-C₂₄alkenyl, phenyl, C₇-C₉phenylalkyl or —OR₅,
R₈, R₉ and R₁₀ independently of each other are hydrogen, C₁-C₂₅alkyl, C₃-C₂₅alkyl which is interrupted by oxygen or sulfur; C₂-C₂₄alkenyl, phenyl or C₇-C₉phenylalkyl, and
n is 1, 2, 3, 4, 5, 6, 7 or 8.

Highly preferred nanoparticles comprising a radical of formula II are those of formula SiO₂ surface

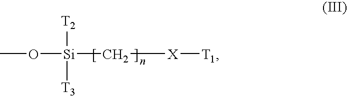

wherein T₁, T₂, T₃, X and n are as defined under formula (II), especially wherein T₂ and T₃ are oxygen linked to the nanoparticle surface, which is preferably a SiO₂ surface.

In step b) of the present process, compositions can be used containing at least one nanoparticle, e.g. of formula (I), in combination with at least one additional photoinitiator and/or in combination with at least one additional monomer. Preferably, compositions with at least one nanoparticle in combination with at least one additional monomer and without an additional photoinitiator are used. More preferably, a composition containing at least one nanoparticle without any additional monomer and without any additional photoinitiator is used in step b).

The invention further pertains to a process as described above, wherein

d) optionally a further coating, e.g. an ink, a laquer or a metallayer or an adhesion layer or release layer, is applied and dried or cured.

The process is simple to carry out and allows a high throughput per unit of time.

In the process according to the invention, after the nanoparticle(s), or a solution or dispersion thereof in a solvent or monomer, has or have been applied to the substrate which has been plasma-, corona-, ozonization-, ultra-violet- or flame-pretreated and after any drying step for evaporating off any solvent used, a fixing step for the nanoparticle(s) (step c) is carried out by exposure to electromagnetic waves or a corona discharge or a plasma treatment. In the context of the present Application, the term “drying” includes both variants, both the removal of the solvent and the fixing of the nanoparticle(s). In this step c), the removal of the solvent is optional; it may be omitted, for example, when no solvent is used. The fixing of the nanoparticle(s) in step c) by irradiation with electromagnetic waves, corona discharge or plasma treatment is highly recommended; corona discharge or UV radiation is preferred, most preferred is a UV radiation.

Process step b) in the above-described process is preferably carried out under normal pressure.

Possible ways of obtaining plasmas under vacuum conditions have been described frequently in the literature. The electrical energy can be coupled in by inductive or capacitive means. It may be direct current or alternating current; the frequency of the alternating current may range from a few kHz up into the MHz range. A power supply in the microwave range (GHz) is also possible.

The principles of plasma production and maintenance are described, for example, in the review article by H. Suhr mentioned above.

As primary plasma gases it is possible to use, for example, He, argon, xenon, N₂, O₂, H₂, CO₂, steam or air.

The process according to the invention is not sensitive per se in respect of the coupling-in of the electrical energy.

The process can be carried out batchwise, for example in a rotating drum, or continuously in the case of films, fibres or woven fabrics. Such methods are known and are described in the prior art.

The process can also be carried out under corona discharge conditions. Corona discharges are produced under normal pressure conditions, the ionised gas used being most frequently air. In principle, however, other gases and mixtures are also possible, as described, for example, in COATING Vol. 2001, No. 12, 426, (2001). The advantage of air as ionisation gas in corona discharges is that the operation can be carried out in an apparatus open to the outside and, for example, a film can be drawn through continuously between the discharge electrodes. Such process arrangements are known and are described, for example, in J. Adhesion Sci. Technol. Vol 7, No. 10, 1105, (1993). Three-dimensional workpieces can be treated with a plasma jet, the contours, for example, being followed with the assistance of robots.

The flame treatment of substrates is known to the person skilled in the art. Corresponding industrial apparatus, for example for the flame treatment of films, is commercially available. In such a treatment, a film is conveyed on a cooled cylindrical roller past the flame-treatment apparatus, which consists of a chain of burners arranged in parallel, usually along the entire length of the cylindrical roller. Details can be found in the brochures of the manufacturers of flame-treatment apparatus (e.g. esse CI, flame treaters, Italy). The parameters to be chosen are governed by the particular substrate to be treated. For example, the flame temperatures, the flame intensity, the dwell times, the distance between substrate and burner, the nature of the combustion gas, air pressure, humidity, are matched to the substrate in question. As flame gases it is possible to use, for example, methane, propane, butane or a mixture of 70% butane and 30% propane.

The ozonization procedure is known to the person skilled in the art and for example described in Ullmans Encyclopedia of Industrial Research, Wiley-VCH Verlag GmbH 2002, chapter “Ozone”; or by R. N. Jagtap, Popular Plastics and Packaging, August 2004.

Ultra-violet irradiation is carried out as described below for step c) or d).

In the process according to the invention in step a) a plasma, corona- or flame treatment is preferred. In particular preferred in step a) is a corona treatment.

The inorganic or organic substrate to be treated can be in any solid form. The substrate is preferably in the form of a woven or non-woven fabric, a fibre, a film or a three-dimensional workpiece. The substrate may be, for example, a thermoplastic, elastomeric, inherently crosslinked or crosslinked polymer, a metal, a metal oxide, a ceramic material, glass, leather or textile.

The pretreatment of the substrate in the form of plasma-, corona- or flame-treatment (step a) may, for example, be carried out immediately after the extrusion of a fibre or film, and also directly after film-drawing.

The substrate used may be an already pretreated one, subjected to e.g. corona, plasma or flame by the provider. Advantageously, such substrates are again treated by corona, ozonization, high energy irradiation, plasma or flame before applying the formulation according to step b) of the process according to the invention. That is, irrespective of a previous treatment of the substrate, both steps a) and b), preferably all steps a)-c), or a)-d), respectively, of the process according to the invention are carried out subsequently.

The inorganic or organic substrate is preferably a thermoplastic, elastomeric, inherently crosslinked or crosslinked polymer, a ceramic material or a glass, or metal, especially a thermoplastic, elastomeric, inherently crosslinked or crosslinked polymer.

Examples of thermoplastic, elastomeric, inherently crosslinked or crosslinked polymers are listed below.

1. Polymers of mono- and di-olefins, for example polypropylene, for example bisaxial oriented polypropylene (BOPP), polyisobutylene, polybutene-1, poly-4-methylpentene-1, polyisoprene or polybutadiene and also polymerisates of cyclo-olefins, for example of cyclopentene or norbornene; and also polyethylene (which may optionally be crosslinked), for example high density polyethylene (HDPE), high density polyethylene of high molecular weight (HDPE-HMW), high density polyethylene of ultra-high molecular weight (HDPE-UHMW), medium density polyethylene (MDPE), low density polyethylene (LDPE), and linear low density polyethylene (LLDPE), (VLDPE) and (ULDPE).

Polyolefins, that is to say polymers of mono-olefins, as mentioned by way of example in the preceding paragraph, especially polyethylene and polypropylene, can be prepared by various processes, especially by the following methods:

a) by free radical polymerisation (usually at high pressure and high temperature);
b) by means of a catalyst, the catalyst usually containing one or more metals of group IVb, Vb, VIb or VIII. Those metals generally have one or more ligands, such as oxides, halides, alcoholates, esters, ethers, amines, alkyls, alkenyls and/or aryls, which may be either π- or σ-coordinated. Such metal complexes may be free or fixed to carriers, for example to activated magnesium chloride, titanium(III) chloride, aluminium oxide or silicon oxide. Such catalysts may be soluble or insoluble in the polymerisation medium. The catalysts can be active as such in the polymerisation or further activators may be used, for example metal alkyls, metal hydrides, metal alkyl halides, metal alkyl oxides or metal alkyl oxanes, the metals being elements of group(s) Ia, IIa and/or IIIa. The activators may have been modified, for example, with further ester, ether, amine or silyl ether groups. Such catalyst systems are usually referred to as Phillips, Standard Oil Indiana, Ziegler (-Natta), TNZ (DuPont), metallocene or Single Site Catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of mono- and di-olefins with one another or with other vinyl monomers, for example ethylene/propylene copolymers, linear low density polyethylene (LLDPE) and mixtures thereof with low density polyethylene (LDPE), propylene/butene-1 copolymers, propylene/isobutylene copolymers, ethylene/butene-1 copolymers, ethylene/hexene copolymers, ethylene/methylpentene copolymers, ethylene/heptene copolymers, ethylene/octene copolymers, propylene/butadiene copolymers, isobutylene/isoprene copolymers, ethylene/-alkyl acrylate copolymers, ethylene/alkyl methacrylate copolymers, ethylene/vinyl acetate copolymers and copolymers thereof with carbon monoxide, or ethylene/acrylic acid copolymers and salts thereof (ionomers), and also terpolymers of ethylene with propylene and a diene, such as hexadiene, dicyclopentadiene or ethylidenenorbornene; and also mixtures of such copolymers with one another or with polymers mentioned under 1), for example polypropylene-ethylene/propylene copolymers, LDPE-ethylene/vinyl acetate copolymers, LDPE-ethylene/acrylic acid copolymers, LLDPE-ethylene/vinyl acetate copolymers, LLDPE-ethylene/acrylic acid copolymers and alternately or randomly structured polyalkylene-carbon monoxide copolymers and mixtures thereof with other polymers, for example polyamides.

4. Hydrocarbon resins (for example C₅-C₉) including hydrogenated modifications thereof (for example tackifier resins) and mixtures of polyalkylenes and starch.

5. Polystyrene, poly(p-methylstyrene), poly(α-methylstyrene).

6. Copolymers of styrene or α-methylstyrene with dienes or acrylic derivatives, for example styrene/butadiene, styrene/acrylonitrile, styrene/alkyl methacrylate, styrene/butadiene/alkyl acrylate and methacrylate, styrene/maleic anhydride, styrene/acrylonitrile/methyl acrylate; high-impact-strength mixtures consisting of styrene copolymers and another polymer, for example a polyacrylate, a diene polymer or an ethylene/propylene/diene terpolymer; and also block copolymers of styrene, for example styrene/butadiene/styrene, styrene/isoprene/styrene, styrene/ethylene-butylene/styrene or styrene/ethylene-propylene/-styrene.

7. Graft copolymers of styrene or α-methylstyrene, for example styrene on polybutadiene, styrene on polybutadiene/styrene or polybutadiene/acrylonitrile copolymers, styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleic acid imide on polybutadiene; styrene and maleic acid imide on polybutadiene, styrene and alkyl acrylates or alkyl methacrylates on polybutadiene, styrene and acrylonitrile on ethylene/propylene/diene terpolymers, styrene and acrylonitrile on polyalkyl acrylates or polyalkyl methacrylates, styrene and acrylonitrile on acrylate/butadiene copolymers, and mixtures thereof with the copolymers mentioned under 6), such as those known, for example, as so-called ABS, MBS, ASA or AES polymers.

8. Halogen-containing polymers, for example polychloroprene, chlorinated rubber, chlorinated and brominated copolymer of isobutylene/isoprene (halobutyl rubber), chlorinated or chlorosulfonated polyethylene, copolymers of ethylene and chlorinated ethylene, epichlorohydrin homo- and co-polymers, especially polymers of halogen-containing vinyl compounds, for example polyvinyl chloride, polyvinylidene chloride, polyvinyl fluoride, polyvinylidene fluoride; and copolymers thereof, such as vinyl chloride/vinylidene chloride, vinyl chloride/vinyl acetate or vinylidene chloride/vinyl acetate.

9. Polymers derived from α,β-unsaturated acids and derivatives thereof, such as polyacrylates and polymethacrylates, or polymethyl methacrylates, polyacrylamides and polyacrylonitriles impact-resistant-modified with butyl acrylate.

10. Copolymers of the monomers mentioned under 9) with one another or with other unsaturated monomers, for example acrylonitrile/butadiene copolymers, acrylonitrile/alkyl acrylate copolymers, acrylonitrile/alkoxyalkyl acrylate copolymers, acrylonitrile/vinyl halide copolymers or acrylonitrile/alkyl methacrylate/butadiene terpolymers.

11. Polymers derived from unsaturated alcohols and amines or their acyl derivatives or acetals, such as polyvinyl alcohol, polyvinyl acetate, stearate, benzoate or maleate, polyvinylbutyral, polyallyl phthalate, polyallylmelamine; and the copolymers thereof with olefins mentioned in Point 1.

12. Homo- and co-polymers of cyclic ethers, such as polyalkylene glycols, polyethylene oxide, polypropylene oxide or copolymers thereof with bisglycidyl ethers.

13. Polyacetals, such as polyoxymethylene, and also those polyoxymethylenes which contain comonomers, for example ethylene oxide; polyacetals modified with thermoplastic polyurethanes, acrylates or MBS.

14. Polyphenylene oxides and sulfides and mixtures thereof with styrene polymers or polyamides.

15. Polyurethanes derived from polyethers, polyesters and polybutadienes having terminal hydroxyl groups on the one hand and aliphatic or aromatic polyisocyanates on the other hand, and their initial products.

16. Polyamides and copolyamides derived from diamines and dicarboxylic acids and/or from aminocarboxylic acids or the corresponding lactams, such as polyamide 4, polyamide 6, polyamide 6/6, 6/10, 6/9, 6/12, 4/6, 12/12, polyamide 11, polyamide 12, aromatic polyamides derived from m-xylene, diamine and adipic acid; polyamides prepared from hexamethylenediamine and iso- and/or tere-phthalic acid and optionally an elastomer as modifier, for example poly-2,4,4-trimethylhexamethylene terephthalamide or poly-m-phenylene isophthalamide. Block copolymers of the above-mentioned polyamides with polyolefins, olefin copolymers, ionomers or chemically bonded or grafted elastomers; or with polyethers, for example with polyethylene glycol, polypropylene glycol or polytetramethylene glycol. Also polyamides or copolyamides modified with EPDM or ABS; and polyamides condensed during processing (“RIM polyamide systems”).

17. Polyureas, polyimides, polyamide imides, polyether imides, polyester imides, polyhydantoins and polybenzimidazoles.

18. Polyesters derived from dicarboxylic acids and dialcohols and/or from hydroxycarboxylic acids or the corresponding lactones, such as polyethylene terephthalate, polybutylene terephthalate, poly-1,4-dimethylolcyclohexane terephthalate, polyhydroxybenzoates, and also block polyether esters derived from polyethers with hydroxyl terminal groups; and also polyesters modified with polycarbonates or MBS.

19. Polycarbonates and polyester carbonates.

20. Polysulfones, polyether sulfones and polyether ketones.

21. Crosslinked polymers derived from aldehydes on the one hand and phenols, urea or melamine on the other hand, such as phenol-formaldehyde, urea-formaldehyde and melamine-formaldehyde resins.

22. Drying and non-drying alkyd resins.

23. Unsaturated polyester resins derived from copolyesters of saturated and unsaturated dicarboxylic acids with polyhydric alcohols, and also vinyl compounds as crosslinking agents, and also the halogen-containing, difficulty combustible modifications thereof.

24. Crosslinkable acrylic resins derived from substituted acrylic esters, e.g. from epoxy acrylates, urethane acrylates or polyester acrylates.

25. Alkyd resins, polyester resins and acrylate resins that are crosslinked with melamine resins, urea resins, isocyanates, isocyanurates, polyisocyanates or epoxy resins.

26. Crosslinked epoxy resins derived from aliphatic, cycloaliphatic, heterocyclic or aromatic glycidyl compounds, e.g. products of bisphenol-A diglycidyl ethers, bisphenol-F diglycidyl ethers, that are crosslinked using customary hardeners, e.g. anhydrides or amines with or without accelerators.

27. Natural polymers, such as cellulose, natural rubber, gelatin, or polymer-homologously chemically modified derivatives thereof, such as cellulose acetates, propionates and butyrates, and the cellulose ethers, such as methyl cellulose; and also colophonium resins and derivatives.

28. Mixtures (polyblends) of the afore-mentioned polymers, for example PP/EPDM, polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

The substrate can be a pure compound or a mixture of compounds containing at least one component as listed above.

The substrate can also be a multilayer construction containing at least one of the components listed above obtained e.g. by coextrusion, coating, lamination, sputtering etc.

The substrate can be the top layer or the bulk material of a three dimensional article.

The substrate can optionally be chemically or physically pretreated prior to the process steps of the invention.

The substrate can be e.g. a plastic part like e.g. a bumper, body part or other work piece from e.g. a car, truck, ship, aircraft, machine housing etc. or the substrate can for example be a plastic part from the inside or outside of a building. These examples restrict by no means other applications of the described process.

The substrate can for example be one as used in the commercial printing area, sheet-fed- or web-printing, posters, calendars, forms, labels, wrapping foils, tapes, credit cards, furniture profiles, etc. The substrate is not restricted to the use in the non-food area. The substrate may also be, for example, a material for use in the field of nutrition, e.g. as packaging for foodstuffs; cosmetics, medicaments, etc.

Where substrates have been pretreated according to process of the invention, it is also possible, for example, for substrates that usually have poor compatibility with one another to be adhesively bonded to one another or laminated.

The substrates are preferably labels and films, e.g. published in catalogues or in the internet by producers like DOW, ExxonMobil, Avery, UCB, BASF, Innovia, Klocke Gruppe, Raflatac, Treofan etc.

Within the context of the present invention, paper should also be understood as being an inherently crosslinked polymer, especially in the form of cardboard, which can additionally be coated with e.g. Teflon®. Many substrates of these classes are commercially available.

The thermoplastic, crosslinked or inherently crosslinked plastics is preferably a polyolefin, polyamide, polyacrylate, polycarbonate, polyester, polystyrene; or an acrylic/melamine, alkyd or polyurethane surface-coating.

Polycarbonate, polyester, polyethylene and polypropylene are especially preferred as pure compounds or as main compounds of multilayer systems.

The plastics may be, for example, in the form of films, injection-moulded articles, extruded workpieces, fibres, felts or woven fabrics.

Substrates of specific technical interest are polyolefines or their copolymers or polyamides, especially in the form of films or multilayer films, each including mono- as well as biaxially oriented films, fabrics, nonwovens or sheets, or polyolefines, polycarbonates or polyamides in the form of molded articles.

Special workpieces which are surface treated with nanoparticles according to the invention are computer screens, touch panels, optical lenses, solar cells, antireflective coatings etc. known by the person skilled in the art.

As inorganic substrates there come into consideration especially glass, ceramic materials, metal oxides and metals. They may be silicates and semi-metal or metal oxide glasses which are preferably in the form of layers or in the form of powders preferably having average particle diameters ranging from 10 nm to 2000 μm. The particles may be dense or porous. Examples of oxides and silicates are SiO₂, TiO₂, ZrO₂, MgO, NiO, WO₃, Al₂O₃, La₂O₃, silica gels, clays and zeolites. Preferred inorganic substrates, in addition to metals, are silica gels, aluminium oxide, titanium oxide and glasses and mixtures thereof.

As metal substrates there come into consideration especially Fe, Al, Ti, Ni, Mo, Cr and steel alloys.

The meanings of the substituents defined in formula I in the different radicals are explained below.

Alkyl such as C₁-C₂₀alkyl is linear or branched and is, for example, C₁-C₁₈-, C₁-C₁₄-, C₁-C₁₂-, C₁-C₈-, C₁-C₆- or C₁-C₄alkyl. Specific examples are methyl, ethyl, propyl, isopropyl, n-butyl, sec-butyl, isobutyl, tert-butyl, pentyl, hexyl, heptyl, 2,4,4-trimethylpentyl, 2-ethylhexyl, octyl, nonyl, decyl, dodecyl, tetradecyl, pentadecyl, hexadecyl, octadecyl, icosyl.

C₂-C₂₀alkyl interrupted by one or more E, that is by O, S, COO, OCO, CO, NR₉, NCOR₉, NR₉CO, CONR₉, OCOO, CONR₉, NR₉COO, SO₂, SO,

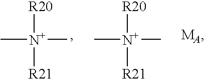

### CR₉═CR₁₀ or

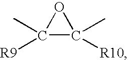

C≡C, N═C—R₉, R₉C═N, phenylene and/or phenylene substituted by D, for example, interrupted 1-20 times, for example 1-15, 1-10, 1-8, 1-6, 1-5, 1-3, 1-2, or once or twice. The alkyl is linear or branched. This produces structural units such as, for example, —CH₂—O—CH₂—,

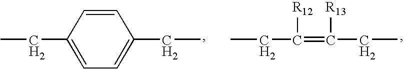

—CH₂—S—CH₂—, —CH₂—N(CH₃)—CH₂—, —CH₂CH₂—O—CH₂CH₂—, —[CH₂CH₂O]_{y}—, —[CH₂CH₂O]_{y}—CH₂—, where e.g. y=1-10, —(CH₂CH₂O)₇CH₂CH₂—, —CH₂—CH(CH₃)—O—CH₂—CH(CH₃)— or —CH₂—CH(CH₃)—O—CH₂—CH₂CH₂—. Interrupting O-atoms are non-successive. If E is O the structural units for interrupted alkyl may also be derived from conventional polyethyleneglycols or polypropyleneglycols, or polytetrahydrofurane of diversified chain lengths. Preferred are such structures to be derived from commercially available polyethyleneglycols, polypropyleneglycols, and polytetrahydrofurane, with for example, MW up to 35000 for polyethyleneglycols, MW up to 35000 for polypropyleneglycols, and MW up to 50000 for polytetrahydrofurane.

Interrupted C₂-C₂₀alkyl is for example C₂-C₁₈-, C₂-C₁₅-, C₂-C₁₂-, C₂-C₁₀, C₂-C₈-, C₂-C₅-, C₂-C₃alkyl. C₂-C₂₀-, C₂-C₁₈-, C₂-C₁₅-, C₂-C₁₂-, C₂-C₁₀-, C₂-C₈-, C₂-C₅-, C₂-C₃alkyl interrupted by one or more E have the same meanings as given for C₂-C₂₀alkyl interrupted by one or more E up to the corresponding number of C-atoms.

If any of the definitions combined with one another lead to consecutive O-atoms, these should be considered excluded in the compounds of formula I in the context of the present application.

C₂-C₂₀alkenyl radicals are mono or polyunsaturated, linear or branched and are for example C₂-C₁₂-, C₂-C₁₀-, C₂-C₈-, C₂-C₆- or C₂-C₄alkenyl. Examples are allyl, methallyl, vinyl, 1,1-dimethylallyl, 1-butenyl, 3-butenyl, 2-butenyl, 1,3-pentadienyl, 5-hexenyl or 7-octenyl, especially allyl or vinyl.

C₃-C₂₀alkenyl interrupted by one or more E produces similar units as described for interrupted alkyl, wherein one or more alkylene units will be replaced by unsaturated units, that is, the interrupted alkenyl is mono- or polyunsaturated and linear or branched.

C₅-C₁₂Cycloalkyl is for example C₄-C₁₂-, C₅-C₁₀cycloalkyl. Examples are cyclopentyl, cyclohexyl, cyclooctyl, cyclo-dodecyl, especially cyclopentyl and cyclohexyl, preferably cyclohexyl. C₅-C₁₂cycloalkyl in the context of the present application is to be also understood as alkyl which at least comprises one ring. For example methyl-cyclopentyl, methyl- or dimethylcyclohexyl,

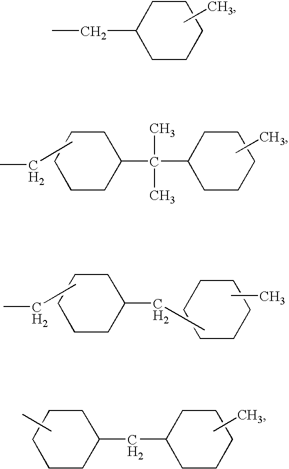

as well as bridged or fused ring systems, e.g.

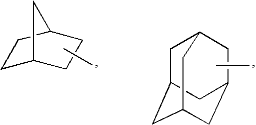

etc. are also meant to be covered by the term.

C₂-C₂₀alkinyl radicals are mono or polyunsaturated, linear or branched and are for example C₂-C₈-, C₂-C₆- or C₂-C₄alkinyl. Examples are ethinyl, propinyl, butinyl, 1-butinyl, 3-butinyl, 2-butinyl, pentinyl hexinyl, 2-hexinyl, 5-hexinyl, octinyl, etc.

C₅-C₁₂Cycloalkylene (C₅-C₁₂Cycloalkyldiyl) is for example C₅-C₁₀-, C₅-C₈-, C₅-C₆cycloalkylene. Examples are cyclopentylene, cyclohexylene, cyclooctylene, cyclododecylene, especially cyclopentylene and cyclohexylene, preferably cyclohexylen. C₅-C₁₂cycloalkylene in the context of the present application is to be also understood as alkylene (alkanediyl) which at least comprises one ring. For example methyl-cyclopentylene, methyl- or dimethylcyclohexylene,

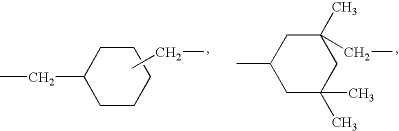

as well as bridged or fused ring systems, e.g.

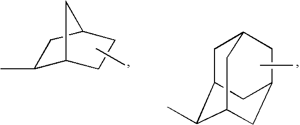

etc. are also meant to be covered by the term.

The meanings of the other radicals are as described above.

Any aryl radical usually stands for an aromatic hydrocarbon moiety of 6 to 14 carbon atoms; specific examples are phenyl, alpha- or beta-naphthyl, biphenylyl.

C₇-C₉Phenylalkyl is for example benzyl, phenylethyl, α-methylbenzyl, phenylpropyl, or α,α-dimethylbenzyl, especially benzyl.

Any acyl radical such as R₁₀₁ as C₁-C₂₄acyl is usually selected from mono-acyl residues of C₁-C₂₄ carboxylic acids, which may be aliphatic or aromatic; examples include R₁₀₁ as —CO—-C₁-C₂₃alkyl; —CO-phenyl; —CO-alkyl which is substituted by COOR₁′ or COOH or COOMe′, where the sum of carbon atoms in the CO, alkyl and COOR₁′ or COOH or COOMe′ moiety in total is from the range 3 to 24; —CO-phenyl which is substituted by R₁′, COOR₁′, COOH and/or COOMe′, where the sum of carbon atoms in the CO, phenyl, R₁′ and/or COOR₁′, COOH, COOMe′ present is in total from the range 8 to 24; while R₁′ is alkyl within the range of carbon atoms as defined above, preferably C₁-C₄alkyl, and Me′ is an equivalent of a metal cation in oxidation state 1+ or 2+ as defined below for Mc, especially, Li+, Na+, K+. Preferred acyl are residues of C₁-C₁₂ monocarboxylic acids such as formyl, acetyl, propanoyl, butanoyl, pentanoyl, hexanoyl, heptanoyl, ocanoyl, nonanoyl, decanoyl, undecanoyl (each including straight chain as well as branched variants such as trimethylacetyl), dodecanoyl, acryloyl, methacryloyl, pentenoyl, cinnamoyl, cyclopentanoyl, cyclohexanoyl, cycloheptanoyl, benzoyl, phenylacetyl, hydroxybenzoyl, methylbenzoyl; more preferred are C₂-C₈alkanoyl, especially acetyl.

Substituted phenyl is substituted one to four times, for example once, twice or three times, especially once. The substituents are for example in 2-, 3-, 4-, 2,4-, 2,6-, 2,3-, 2,5-, 2,4,6-, 2,3,4-, 2,3,5-position of the phenyl ring.

Halogen is fluorine, chlorine, bromine and iodine, especially fluorine, chlorine and bromine, preferably fluorine and chlorine.

If alkyl is substituted one or more times by halogen, then there are for example 1 to 3 or 1 or 2 halogen substituents on the alkyl radical.

M_{C} is an inorganic or organic cation;
M_{C} as an n-valent cation is for example M_{C1}, a monovalent cation, M_{C2}, a divalent cation, M_{C3}, a trivalent cation or M_{C4}, a tetravalent cation.
M_{C} is for example a metal cation in the oxidation state +1, such as Li⁺, Na⁺, K⁺, Cs⁺, an “onium” cation, such as ammonium-, phosphonium-, iodonium- or sulfonium cation, a metal cation in the oxidation state +2, such as Mg²⁺, Ca²⁺, Zn²⁺, Cu²⁺, a metal cation in the oxidation state +3, such as Al³⁺, a metal cation in the oxidation state +4, such as Sn⁴⁺ or Ti⁴⁺. Examples for onium cations are ammonium, tetra-alkylammonium, tri-alkyl-aryl-ammonium, di-alkyl-di-aryl-ammonium, tri-aryl-alkyl-ammonium, tetra-aryl-ammonium, tetra-alkylphosphonium, tri-alkyl-aryl-phosphonium, di-alkyl-di-aryl-phosphonium, tri-aryl-alkyl-phosphonium, tetra-aryl-phosphonium. E.g. N⁺R_{A1}R_{A2}R_{A3}R_{A4} or P⁺R_{A1}R_{A2}R_{A3}R_{A4}, wherein R_{A1}, R_{A2}, R_{A3}, R_{A4} independently of one another are hydrogen, C₁-C₂₀alkyl, phenyl; C₁-C₂₀alkyl substituted by OH or phenyl; phenyl substituted by OH or C₁-C₄ alkyl.
M_{C1} is for example, a metal cation in the oxidation state +1, N⁺R_{A1}R_{A2}R_{A3}R_{A4} or P⁺R_{A1}R_{A2}R_{A3}R_{A4}, wherein R_{A1}, R_{A2}, R_{A3}, R_{A4} independently of one another are hydrogen, C₁-C₂₀alkyl, phenyl; C₁-C₂₀alkyl substituted by OH or phenyl; phenyl substituted by OH or C₁-C₄ alkyl.
M_{C1} is preferably Li⁺, Na⁺, K⁺, Cs⁺, N⁺R_{A1}R_{A2}R_{A3}R_{A4} or P⁺R_{A1}R_{A2}R_{A3}R_{A4}; in particular Li⁺, Na⁺, K⁺, N⁺R_{A1}R_{A2}R_{A3}R_{A4} or P⁺R_{A1}R_{A2}R_{A3}R_{A4}.
M_{C2} is for example a metal cation in the oxidation state +2; such as for example Mg²⁺, Ca²⁺, Zn²⁺, M₂ is preferably Mg²⁺ or Ca²⁺.
M_{C3} is a metal cation in the oxidation state +3; such as for example Al³⁺;
M_{C4} is a metal cation in the oxidation state +4; such as for example Sn⁴⁺ or Ti⁴⁺.
Monovalent cations M_{C1} are preferred;
M_{A} is an inorganic or organic anion;
M_{A} as an n-valent cation is for example M_{A1}, a monovalent anion, M_{A2}, a divalent anion, M_{A3}, a trivalent anion or M_{A4}, a tetravalent anion.
M_{A1} is for example F⁻, Cl⁻, Br⁻, I⁻, OH⁻, C₁-C₂₀—COO⁻, C₆-C₁₂aryl-COO⁻, C₇-C₉alkylphenyl-COO⁻, C₁-C₂₀—SO₃⁻, halogenated C₁-C₂₀—SO₃⁻, C₇-C₉alkylphenyl-SO₃⁻ or C₆-C₁₂aryl-SO₃⁻; M_{A1} is preferably F⁻, Cl⁻, Br⁻, I⁻, C₁-C₂₀—COO⁻, CF₃—COO⁻, C₁-C₂₀—SO₃⁻, CF₃—SO₃⁻ or C₇-C₉alkylphenyl-SO₃⁻; M_{A1} is more preferably Cl⁻, Br⁻ or C₁-C₆—COO⁻;
M_{A2} is for example CO₃²⁻, SO₄²⁻, ⁻OOC—C₁-C₈-alkylene-COO⁻ or ⁻OOC-phenylene-COO⁻; M_{A2} is preferably CO₃²⁻, SO₄²⁻,

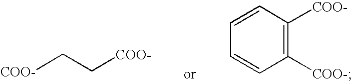

M_{A2} is more preferably CO₃²⁻ or SO₄²⁻;
M_{A3} is for example PO₄³⁻ or

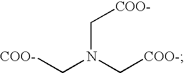

M_{A4} is for example

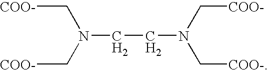

Monovalent anions M_{A1} are preferred.

The above-given examples for the definitions of the radicals are considered illustrative and non-limiting in view of the claimed scope.

The terms “and/or” or “or/and” in the present context are meant to express that not only one of the defined alternatives (substituents) may be present, but also several of the defined alternatives (substituents) together, namely mixtures of different alternatives (substituents).

The term “at least” is meant to define one or more than one, for example one or two or three, preferably one or two.

The term “optionally substituted” means, that the radical to which it refers is either unsubstituted or substituted.

Throughout this specification and the claims which follow, unless the context requires otherwise, the word “comprise”, or variations such as “comprises” or “comprising”, will be understood to imply the inclusion of a stated integer or step or group of integers or steps but not the exclusion of any other integer or step or group of integers or steps.

The above nanoparticles of the formula I in the process according to the invention may be used singly or in any combination with one another or with further known nanoparticles and in principle any compounds and mixtures that form a nanoparticle modified surface when irradiated with electromagnetic waves. These include compositions consisting of a plurality of compounds including nanoparticles, monomers, solvents, photoinitiators, coinitiators etc.

In addition to coinitiators, for example amines, thiols, borates, enolates, phosphines, carboxylates and imidazoles, it is also possible to use sensitisers, for example acridines, xanthenes, thiazenes, coumarins, thioxanthones, triazines and dyes. A description of such compounds and initiator systems can be found e.g. in Crivello J. V., Dietliker K. K., (1999): Chemistry & Technology of UV & EB Formulation for Coatings, Inks & Paints, and in Bradley G. (ed.) Vol. 3: Photoinitiators for Free Radical and Cationic Polymerisation 2nd Edition, John Wiley & Son Ltd.

In step b) of the present process, compounds (nanoparticles) such as those of the formula I can be combined for example with compounds and derivatives of the following classes: benzoins, benzil ketals, acetophenones, hydroxyalkylphenones, aminoalkylphenones, mono- and bis-acylphosphine oxides, mono- and bisacylphosphine sulfides, acyloxyiminoketones, alkylamino-substituted ketones, such as Michler's ketone, peroxy compounds, dinitrile compounds, halogenated acetophenones, other phenylglyoxylates, other dimeric phenylglyoxalates, benzophenones, oximes and oxime esters, thioxanthones, coumarins, ferrocenes, titanocenes, onium salts, sulfonium salts, iodonium salts, diazonium salts, borates, triazines, bisimidazoles, polysilanes and dyes. It is also possible to use combinations of the compounds from the mentioned classes of compounds with one another and combinations with corresponding coinitiator systems and/or sensitisers.

Examples of such additional photoinitiator compounds are α-hydroxycyclohexylphenylketone or 2-hydroxy-2-methyl-1-phenyl-propanone, (4-methylthiobenzoyl)-1-methyl-1-morpholino-ethane, (4-morpholino-benzoyl)-1-benzyl-1-dimethylamino-propane, (4-morpholino-benzoyl)-1-(4-methylbenzyl)-1-dimethylamino-propane, (3,4-dimethoxy-benzoyl)-1-benzyl-1-dimethylamino-propane, benzildimethylketal, (2,4,6-trimethylbenzoyl)-diphenyl-phosphinoxid, (2,4,6-trimethylbenzoyl)-ethoxy-phenyl-phosphinoxid, bis(2,6-dimethoxybenzoyl)-(2,4,4-trimethyl-pent-1-yl)phosphinoxid, bis(2,4,6-trimethylbenzoyl)-phenyl-phosphinoxid, bis(2,4,6-trimethylbenzoyl)-isopropylphosphinoxid, or bis(2,4,6-trimethylbenzoyl)-(2,4-dipentoxyphenyl)-phosphinoxid, dicyclopentadienyl-bis(2,6-difluor-3-pyrrolo)titan, bisacridine derivatives like 1,7-bis(9-acridinyl)heptane, oxime esters, for example 1-phenyl-1,2-propanedione-2-(o-benzoyl)oxime, 1-phenyl-1,2-propanedione-2-(o-ethoxycarbonyl)oxime or other oxime esters as for example described in GB 2339571 and US2001/0012596; as well as benzophenone, 4-phenylbenzophenone, 4-phenyl-3′-methylbenzophenone, 4-phenyl-2′,4′,6′-trimethylbenzophenone, 4-methoxybenzophenone, 4,4′-dimethoxybenzophenone, 4,4′-dimethylbenzophenone, 4,4′-dichlorobenzophenone, 4,4′-dimethylaminobenzophenone, 4,4′-diethylaminobenzophenone, 4-methylbenzophenone, 2,4,6-trimethylbenzophenone, 4-(4-methylthiophenyl)-benzophenone, 3,3′-dimethyl-4-methoxybenzophenone, methyl-2-benzoylbenzoat, 4-(2-hydroxyethylthio)-benzophenone, 4-(4-tolylthio)benzophenone, 4-benzoyl-N,N,N-trimethylbenzolmethanaminiumchloride, 2-hydroxy-3-(4-benzoylphenoxy)-N,N,N-trimethyl-1-propanaminiumchloride monohydrate, 4-(13-acryloyl-1,4,7,10,13-pentaoxamidecyl)-benzophenone, 4-benzoyl-N,N-dimethyl-N-[2-(1-oxo-2-propenyl)oxy]ethyl-benzolmethanaminiumchloride; 2,2-dichloro-1-(4-phenoxyphenyl)-ethanone, 4,4′-bis(chloromethyl)-benzophenone, 4-methylbenzophenone, 2-methylbenzophenone, 3-methylbenzophenone, 4-chlorobenzophenone; as well as 2-chlorothioxanthone, 2,4-diethylthioxanthone, 2-isopropylthioxanthone, 3-isopropylthioxanthone, 1-chloro-4-propoxythioxanthone.

Further, photoinitiators having an unsaturated group may be used in combination with compounds of the formula I.

The publications indicated below provide specific examples of such photoinitiator compounds having an ethylenically unsaturated function, and the preparation thereof:

Unsaturated aceto- and benzo-phenone derivatives are described, for example, in U.S. Pat. No. 3,214,492, U.S. Pat. No. 3,429,852, U.S. Pat. No. 3,622,848 and U.S. Pat. No. 4,304,895, for example

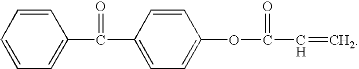

Also suitable, for example, are

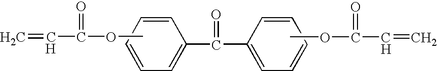

and further copolymerisable benzophenones, e.g. from UCB, Ebecryl P36 or in the form of Ebecryl P38 diluted in 30% tripropylene glycol diacrylate.

Copolymerisable, ethylenically unsaturated acetophenone compounds can be found, for example, in U.S. Pat. No. 4,922,004, for example

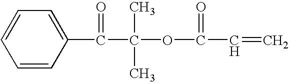

or

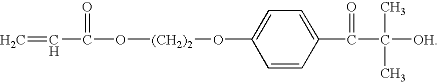

2-Acryloyl-thioxanthone has been published in Eur. Polym. J. 23, 985 (1987). Examples such as

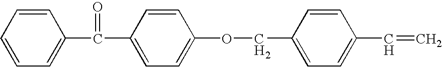

are described in DE 2 818 763. Further unsaturated carbonate-group-containing photoinitiator compounds can be found in EP 377 191. Uvecryl® P36 (already mentioned above), from UCB, is a benzophenone bonded to an acrylic function by ethylene oxide units (see Technical Bulletin 2480/885 (1985) from UCB or New. Polym. Mat. 1, 63 (1987)):

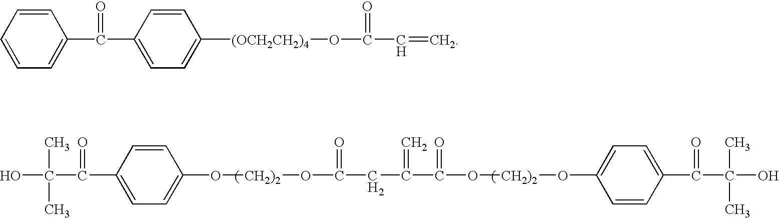

has been published in Chem. Abstr. 128: 283649r.

DE 195 01 025 gives further suitable ethylenically unsaturated photoinitiator compounds. Examples are 4-vinyloxycarbonyloxybenzophenone, 4-vinyloxycarbonyloxy-4′-chlorobenzophenone, 4-vinyloxycarbonyloxy-4′-methoxybenzophenone, N-vinyloxycarbonyl-4-aminobenzophenone, vinyloxycarbonyloxy-4′-fluorobenzophenone, 2-vinyloxycarbonyloxy-4′-methoxybenzophenone, 2-vinyloxycarbonyloxy-5-fluoro-4′-chlorobenzophenone, 4-vinyloxycarbonyloxyacetophenone, 2-vinyloxycarbonyloxyacetophenone, N-vinyloxycarbonyl-4-aminoacetophenone, 4-vinyloxycarbonyloxybenzil, 4-vinyloxycarbonyloxy-4′-methoxybenzil, vinyloxycarbonylbenzoin ether, 4-methoxybenzoinvinyloxycarbonyl ether, phenyl(2-vinyloxycarbonyloxy-2-propyl)-ketone, (4-isopropylphenyl)-(2-vinyloxycarbonyloxy-2-propyl)-ketone, phenyl-(1-vinyloxycarbonyloxy)-cyclohexyl ketone, 2-vinyloxycarbonyloxy-9-fluorenone, 2-(N-vinyloxycarbonyl)-9-aminofluorenone, 2-vinylcarbonyloxymethylanthraquinone, 2-(N-vinyloxycarbonyl)-aminoanthraquinone, 2-vinyloxycarbonyloxythioxanthone, 3-vinylcarbonyloxythioxanthone or

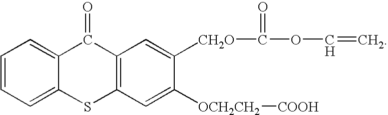

U.S. Pat. No. 4,672,079 discloses inter alia the preparation of 2-hydroxy-2-methyl(4-vinylpropiophenone), 2-hydroxy-2-methyl-p-(1-methylvinyl)propiophenone, p-vinylbenzoylcyclohexanol, p-(1-methylvinyl)benzoyl-cyclohexanol.

Also suitable are the reaction products, described in JP Kokai Hei 2-292307, of 4-[2-hydroxyethoxy)-benzoyl]-1-hydroxy-1-methyl-ethane (Irgacure® 2959, Ciba Spezialitätenchemie) and isocyanates containing acryloyl or methacryloyl groups, for example

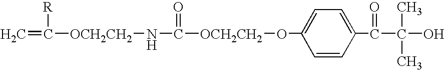

or

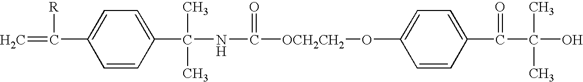

(wherein R═H or CH₃).

Further examples of suitable photoinitiators are

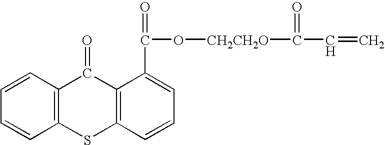

and

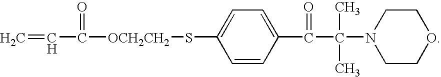

The following examples are described in Radcure '86, Conference Proceedings, 4-43 to 4-54 by W. Bäumer et al.

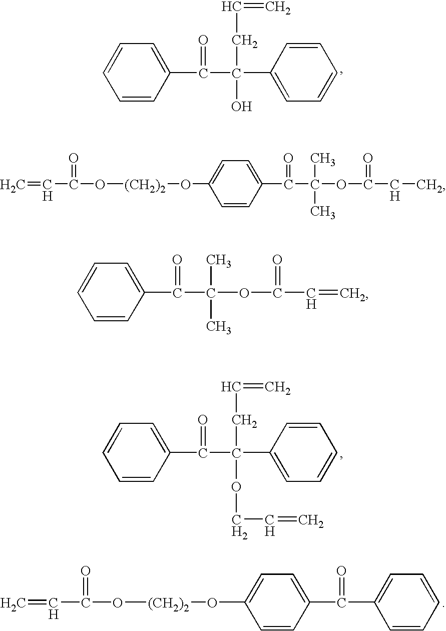

G. Wehner et al. report in Radtech '90 North America on

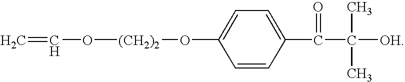

In the process according to the invention there are also suitable the compounds presented at RadTech 2002, North America

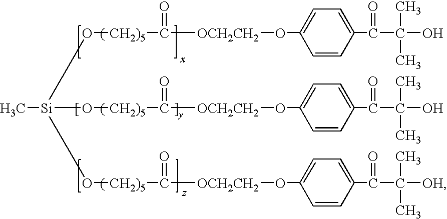

wherein x, y and z are an average of 3 (SiMFPI2) and

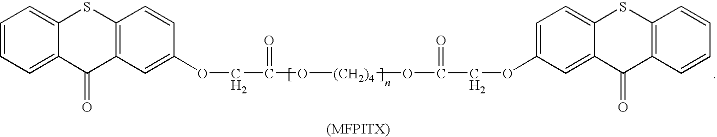

Such photoinitiator compounds are known to the person skilled in the art, see, for example, U.S. Pat. No. 4,922,004. Many of the photoinitiators to be optionally used are commercially available, e.g. under the trademark IRGACURE (Ciba Specialty Chemicals), ESACURE (Fratelli Lamberti), LUCIRIN (BASF), VICURE (Stauffer), GENOCURE, QUANTACURE (Rahn/Great Lakes), SPEEDCURE (Lambsons), KAYACURE (Nippon Kayaku), CYRACURE (Union Carbide Corp.), DoubleCure (Double Bond), EBECRYL P (UCB), FIRSTCURE (First Chemical), etc. Commercially available unsaturated photoinitiators are, for example, 4-(13-acryloyl-1,4,7,10,13-pentaoxamidecylybenzophenone (Uvecryl P36 from UCB), 4-benzoyl-N,N-dimethyl-N-[2-(1-oxo-2-propenyl)oxy]ethylphenylmethanaminium chloride (Quantacure ABQ from Great Lakes), and some copolymerisable unsaturated tertiary amines (Uvecryl P101, Uvecryl P104, Uvecryl P105, Uvecryl P115 from UCB Radcure Specialties) or copolymerisable aminoacrylates (Photomer 4116 and Photomer 4182 from Ackros; Laromer LR8812 from BASF; CN381 and CN386 from Cray Valley).

In the process according to the invention, in particular in step b), it is possible to use either saturated or unsaturated photoinitiators together with the present nanoparticles. In the process according to the invention it is of course also possible to employ mixtures of different photoinitiators, for example mixtures of saturated and unsaturated photoinitiators, as well as mixtures e.g. of compounds of the formula I with other photoinitiators.

The nanoparticles, or where applicable the mixture of a plurality of nanoparticles, are applied to the corona-, plasma- or flame-pretreated substrate, for example, in pure form, that is to say without further additives, or in combination with a monomer or oligomer, or dissolved in a solvent, optionally in the presence of additional photoinitiator(s). The nanoparticles, or the nanoparticle mixture, can also e.g. be in molten form. The nanoparticles, or the nanoparticle mixture, can for example, be dispersed, suspended or emulsified with water or a solvent, a dispersant being added as necessary. Of course, it is also possible to use any mixture of the above-mentioned components, photoinitiator, monomer, oligomer, solvent, water.

Suitable dispersants, e.g. any surface-active compounds, preferably anionic and non-ionic surfactants, and also polymeric dispersants, are usually known to the person skilled in the art and are described, for example, in U.S. Pat. No. 4,965,294 and U.S. Pat. No. 5,168,087.

Suitable solvents include principle any substance in which the nanoparticles can be converted into a state suitable for application, whether in the form of a solution or in the form of a suspension or emulsion. Suitable solvents are, for example, alcohols, such as ethanol, propanol, isopropanol, butanol, ethylene glycol etc., ketones, such as acetone, methyl ethyl ketone, acetonitrile, aromatic hydrocarbons, such as toluene and xylene, esters and aldehydes, such as ethyl acetate, ethyl formate, aliphatic hydrocarbons, e.g. petroleum ether, pentane, hexane, cyclohexane, halogenated hydrocarbons, such as dichloromethane, chloroform, or water, or alternatively oils, natural oils, castor oil, vegetable oil etc., and also synthetic oils. This description is on no account exhaustive and is given merely by way of example. Alcohols, water and esters are preferred.

The monomers and/or oligomers containing at least one ethylenically unsaturated group, which optionally are used in step b) of the process according to the invention may contain one or more ethylenically unsaturated double bonds. They may be lower molecular weight (monomeric) or higher molecular weight (oligomeric). Examples of monomers having a double bond are alkyl and hydroxyalkyl acrylates and methacrylates, e.g. methyl, ethyl, butyl, 2-ethylhexyl and 2-hydroxyethyl acrylate, isobornyl acrylate and methyl and ethyl methacrylate. Further examples are acrylonitrile, acrylamide, methacrylamide, N-substituted (meth)acrylamides, vinyl esters, such as vinyl acetate, vinyl ethers, such as isobutyl vinyl ether, styrene, alkyl- and halo-styrenes, N-vinylpyrrolidone, vinyl chloride and vinylidene chloride, glycidyl(meth)acrylate.

Examples of monomers having more than one double bond are ethylene glycol diacrylate, 1,6-hexanediol diacrylate, propylene glycol diacrylate, dipropylene glycol diacrylate, tripropylene glycol diacrylate, neopentyl glycol diacrylate, hexamethylene glycol diacrylate and bisphenol-A diacrylate, 4,4′-bis(2-acryloyloxyethoxy)diphenylpropane, trimethylolpropane triacrylate, pentaerythritol triacrylate, pentaerythritol tetraacrylate, vinyl acrylate, divinylbenzene, divinyl succinate, diallyl phthalate, triallyl phosphate, triallyl isocyanurate, tris-(hydroxyethyl) isocyanurate triacrylate (Sartomer 368; from Cray Valley) and tris(2-acryloylethyl) isocyanurate, ethyleneglycoldivinylether, diethyleneglycoldivinylether, triethyleneglycoldivinylether, polyethyleneglycol-mono-(meth)acrylate, polyethyleneglycol-di-(meth)acrylate, vinyl(meth)acrylate, CN435, SR415, SR9016 (Sartomer Company).

It is also possible to use acrylic esters of alkoxylated polyols, for example glycerol ethoxylate triacrylate, glycerol propoxylate triacrylate, trimethylolpropaneethoxylate triacrylate, trimethylolpropanepropoxylate triacrylate, pentaerythritol ethoxylate tetraacrylate, pentaerythritol propoxylate triacrylate, pentaerythritol propoxylate tetraacrylate, neopentyl glycol ethoxylate diacrylate or neopentyl glycol propoxylate diacrylate. The degree of alkoxylation of the polyols used may vary.

Examples of higher molecular weight (oligomeric) polyunsaturated compounds are acrylated epoxy resins, acrylated or vinyl-ether- or epoxy-group-containing polyesters, polyurethanes and polyethers. Further examples of unsaturated oligomers are unsaturated polyester resins, which are usually produced from maleic acid, phthalic acid and one or more diols and have molecular weights of about from 500 to 3000. In addition it is also possible to use vinyl ether monomers and oligomers, and also maleate-terminated oligomers having polyester, polyurethane, polyether, polyvinyl ether and epoxide main chains. In particular, combinations of vinyl-ether-group-carrying oligomers and polymers, as described in WO 90/01512, are very suitable, but copolymers of monomers functionalised with maleic acid and vinyl ether also come into consideration.

Also suitable are, for example, esters of ethylenically unsaturated carboxylic acids and polyols or polyepoxides, and oligomers having ethylenically unsaturated groups in the chain or in side groups, e.g. unsaturated polyesters, polyamides and polyurethanes and copolymers thereof, alkyd resins, polybutadiene and butadiene copolymers, polyisoprene and isoprene copolymers, polymers and copolymers having (meth)acrylic groups in side chains, and also mixtures of one or more such polymers.

Examples of unsaturated carboxylic acids are acrylic acid, methacrylic acid, crotonic acid, maleic acid, fumaric acid, itaconic acid, cinnamic acid and unsaturated fatty acids such as linolenic acid or oleic acid. Acrylic and methacrylic acid are preferred.

Suitable polyols are aromatic and especially aliphatic and cycloaliphatic polyols. Examples of aromatic polyols are hydroquinone, 4,4′-dihydroxydiphenyl, 2,2-di(4-hydroxyphenyl)propane, and novolaks and resols. Examples of polyepoxides are those based on the said polyols, especially the aromatic polyols and epichlorohydrin. Also suitable as polyols are polymers and copolymers that contain hydroxyl groups in the polymer chain or in side groups, e.g. polyvinyl alcohol and copolymers thereof or polymethacrylic acid hydroxyalkyl esters or copolymers thereof. Further suitable polyols are oligoesters having hydroxyl terminal groups.

Examples of aliphatic and cycloaliphatic polyols include alkylenediols having preferably from 2 to 12 carbon atoms, such as ethylene glycol, 1,2- or 1,3-propanediol, 1,2-, 1,3- or 1,4-butanediol, pentanediol, hexanediol, octanediol, dodecanediol, diethylene glycol, triethylene glycol, polyethylene glycols from 200-35000, preferably from 200 to 1500, polypropylene glycols having molecular weights from 200-35000, preferably from 200 to 1500, polytetrahydrofuranes having molecular weights from 200-50000, preferably from 200 to 2000, 1,3-cyclopentanediol, 1,2-, 1,3- or 1,4-cyclohexanediol, 1,4-dihydroxymethylcyclohexane, glycerol, tris(β-hydroxyethyl)amine, trimethylolethane, trimethylolpropane, pentaerythritol, dipentaerythritol and sorbitol.

The polyols may have been partially or fully esterified by one or by different unsaturated carboxylic acid(s), it being possible for the free hydroxyl groups in partial esters to have been modified, for example etherified, or esterified by other carboxylic acids.

Examples of esters are:

trimethylolpropane triacrylate, trimethylolethane triacrylate, trimethylolpropane trimethacrylate, trimethylolethane trimethacrylate, tetramethylene glycol dimethacrylate, triethylene glycol dimethacrylate, tetraethylene glycol diacrylate, pentaerythritol diacrylate, pentaerythritol triacrylate, pentaerythritol tetraacrylate, dipentaerythritol diacrylate, dipentaerythritol triacrylate, dipentaerythritol tetraacrylate, dipentaerythritol pentaacrylate, dipentaerythritol hexaacrylate, tripentaerythritol octaacrylate, pentaerythritol dimethacrylate, pentaerythritol trimethacrylate, dipentaerythritol dimethacrylate, dipentaerythritol tetramethacrylate, tripentaerythritol octamethacrylate, pentaerythritol diitaconate, dipentaerythritol trisitaconate, dipentaerythritol pentaitaconate, dipentaerythritol hexaitaconate, ethylene glycol diacrylate, 1,3-butanediol diacrylate, 1,3-butanediol dimethacrylate, 1,4-butanediol diitaconate, sorbitol triacrylate, sorbitol tetraacrylate, pentaerythritol-modified triacrylate, sorbitol tetramethacrylate, sorbitol pentaacrylate, sorbitol hexaacrylate, oligoester acrylates and methacrylates, glycerol di- and tri-acrylate, 1,4-cyclohexane diacrylate, bisacrylates and bismethacrylates of polyethylene glycol having a molecular weight of from 200 to 1500, and mixtures thereof.

Also suitable are the amides of identical or different unsaturated carboxylic acids and aromatic, cycloaliphatic and aliphatic polyamines having preferably from 2 to 6, especially from 2 to 4, amino groups. Examples of such polyamines are ethylenediamine, 1,2- or 1,3-propylenediamine, 1,2-, 1,3- or 1,4-butylenediamine, 1,5-pentylenediamine, 1,6-hexylenediamine, octylenediamine, dodecylenediamine, 1,4-diamino-cyclohexane, isophoronediamine, phenylenediamine, bisphenylenediamine, di-β-aminoethyl ether, diethylenetriamine, triethylenetetramine and di(β-aminoethoxy)- and di(β-aminopropoxy)-ethane. Further suitable polyamines are polymers and copolymers which may have additional amino groups in the side chain and oligoamides having amino terminal groups. Examples of such unsaturated amides are: methylene bisacrylamide, 1,6-hexamethylene bisacrylamide, diethylenetriamine trismethacrylamide, bis(methacrylamidopropoxy)ethane, β-methacrylamidoethyl methacrylate and N-[(β-hydroxyethoxy)ethyl]-acrylamide.

Specific examples are SARTOMER® 259, 344, 610, 603, 252 (provided by Cray Valley)

Suitable unsaturated polyesters and polyamides are derived, for example, from maleic acid and diols or diamines. The maleic acid may have been partially replaced by other dicarboxylic acids. They may be used together with ethylenically unsaturated comonomers, e.g. styrene. The polyesters and polyamides may also be derived from dicarboxylic acids and ethylenically unsaturated diols or diamines, especially from those having longer chains of e.g. from 6 to 20 carbon atoms. Examples of polyurethanes are those composed of saturated diisocyanates and unsaturated diols or unsaturated diisocyanates and saturated diols.

Polybutadiene and polyisoprene and copolymers thereof are known. Suitable comonomers include, for example, olefins, such as ethylene, propene, butene, hexene, (meth)acrylates, acrylonitrile, styrene and vinyl chloride. Polymers having (meth)acrylate groups in the side chain are likewise known. Examples are reaction products of novolak-based epoxy resins with (meth)acrylic acid; homo- or co-polymers of vinyl alcohol or hydroxyalkyl derivatives thereof that have been esterified with (meth)acrylic acid; and homo- and co-polymers of (meth)acrylates that have been esterified with hydroxyalkyl (meth)acrylates.

In the context of the present Application the term (meth)acrylate includes both the acrylate and the methacrylate.

An acrylate or methacrylate compound is especially used as the mono- or poly-ethylenically unsaturated compound.

Very special preference is given to polyunsaturated acrylate compounds, such as have already been mentioned above.

In process step b) for example a compound of the formula I, comprising an unsaturated group is used as such. Or, for example, a compound of the formula I, comprising an unsaturated group is used together with another nanoparticle, without an unsaturated group. For example the use of a compound of the formula I, comprising an unsaturated group together with a monomer or oligomer is suitable. Or, all combinations as mentioned above together with a monomer or oligomer may be employed. It's evident, that all combination may further be incorporated in a solvent, e.g. water.

The invention relates also to a process wherein the nanoparticles or mixtures thereof with monomers or oligomers are used in combination with one or more liquids (such as solvents, e.g. water) in the form of solutions, suspensions and emulsions.

After the application of the nanoparticle in step b) and step c), the workpiece can be stored or immediately processed further.

In the context of the present invention electromagnetic radiation is used. In step c) this is preferably UV/VIS radiation, which is to be understood as being electromagnetic radiation in a wavelength range from 150 nm to 700 nm. Preference is given to the range from 250 nm to 500 nm. Suitable lamps are known to the person skilled in the art and are commercially available.

A large number of the most varied kinds of light source may be used. Both point sources and planiform radiators (lamp arrays) are suitable. Examples are: carbon arc lamps, xenon arc lamps, medium-pressure, super-high-pressure, high-pressure and low-pressure mercury radiators doped, where appropriate, with metal halides (metal halide lamps), microwave-excited metal vapour lamps, excimer lamps, superactinic fluorescent tubes, fluorescent lamps, argon incandescent lamps, flash lamps, photographic floodlight lamps, light-emitting diodes (LED), electron beams and X-rays. The distance between the lamp and the substrate to be irradiated may vary according to the intended use and the type and strength of the lamp and may be, for example, from 2 cm to 150 cm. Also suitable are laser light sources, for example excimer lasers, such as Krypton-F lasers for irradiation at 248 nm. Lasers in the visible range may also be used.

Such UV-Vis irradiation might be optionally used in steps a) and d) as well.

Advantageously the dose of radiation used in process step c) is e.g. from 1 to 1000 mJ/cm², such as 1-800 mJ/cm², or, for example, 1-500 mJ/cm², e.g. from 5 to 300 mJ/cm², preferably from 10 to 200 mJ/cm².

The process according to the invention can be carried out within a wide pressure range, the discharge characteristics shifting as the pressure increases from a pure low-temperature plasma towards a corona discharge and finally changing into a pure corona discharge at an atmospheric pressure of about 1000-1100 mbar.

The process is preferably carried out at a process pressure of from 10⁻⁶ mbar up to atmospheric pressure (1013 mbar), especially in the range of from 10⁻⁴ to 10⁻² mbar as a plasma process and at atmospheric pressure as a corona process. The flame treatment is usually carried out at atmospheric pressure.

The process is preferably carried out using as the plasma gas an inert gas or a mixture of an inert gas with a reactive gas in step a).

When a corona discharge is used, this can be done in any gas atmosphere. Preferred gases are air, carbon containing gases (e.g. CO₂, CO), nitrogen containing gases (e.g. N₂, N₂O, NO₂, NO), oxygen containing gases (e.g. O₂, O₃), hydrogen containing gases (e.g. H₂, HCl, HCN), sulfur containing gases (e.g. SO₂), noble gases (e.g. He, Ne, Ar, Kr, Xe) or water, singly or in the form of mixtures.

Most preferred main gases are air, N₂ or CO₂ singly or in the form of mixtures, where there might be added minor quantities of one or more dopant gases, like e.g. carbon containing gases (e.g. CO₂, CO), nitrogen containing gases (e.g. N₂, N₂O, NO₂, NO), oxygen containing gases (e.g. O₂, O₃), hydrogen containing gases (e.g. H₂, HCl, HCN), sulfur containing gases (e.g. SO₂), noble gases (e.g. He, Ne, Ar, Kr, Xe) or water, where minor quantity means that the sum of the dopant gases is less than 50%, preferably less than 40%, more preferably less than 30% and still more preferred less than 20% and even more preferred less than 10% of the total gas mixture.

Most preferred main gases are air or N₂, singly or in the form of a mixture.

Most preferred dopant gases are CO₂, N₂O or H₂ singly or in the form of a mixture.

The nanoparticle (formulation/solution) layer deposited in step b) has a thickness up to 50 microns, preferably from e.g. a monoparticular layer to 5 microns, especially from a monoparticular layer to 1 micron.

After carrying out step c) the nanoparticle (formulation) has preferably a thickness ranging up to 10 microns, more preferably up to 1 micron, from e.g. a monoparticular layer to 500 nm, especially from a monoparticular layer to 200 nm, more preferably from a monoparticular layer to 100 nm, and more preferred a monoparticular layer having a thickness of up to 50 nm.

The nanoparticles of formula I have preferably a diameter ranging up to 10 microns, more preferred up to 1 micron, preferably up to 500 nm, especially up to 200 nm and more preferred a diameter of less than 100 nm and most preferred a diameter of less than 50 nm.

Nanoparticles of different diameters can be used together.

The nanoparticles can be after step c) in touch with neighboring nanoparticles, or sit free on the substrate surface without touching another nanoparticle. The distribution of the nanoparticles on the substrate surface can be dense or not, according to the desired effect of the surface modification.

The nanoparticles can after step c) sit free on the substrate surface, or be embedded in a polymer, where the polymer layer can be thicker or thinner than the diameter of the nanoparticles used.

The plasma treatment of the inorganic or organic substrate in the optional step a) preferably takes place for from 1 ms to 300 s, especially from 10 ms to 200 s.

In principle, it is advantageous to apply the nanoparticles as quickly as possible after the optional plasma-, corona- or flame-pretreatment, but for many purposes it may also be acceptable to carry out reaction step b) after a time delay or even without a pretreatment step a). It is preferable, however, to carry out process step b) immediately after process step a) or within 24 hours after process step a).

Of interest is a process wherein process step c) is carried out immediately after process step b) or within 24 hours after process step b).

After the optional plasma-, corona- or flame-pretreatment, it is therefore possible in process step b) to apply to the pretreated substrate, for example, 0.0001-100%, e.g. 0.001-50%, 0.01-20%, 0.01-10%, 0.01-5%, 0.1-5%, especially 0.1-1% of nanoparticle(s) or, for example, 0.0001-99.9999%, e.g. 0.001-50%, 0.01-20%, 0.01-10%, 0.01-5%, 0.1-5%, especially 0.1-1% of nanoparticle(s), and e.g. 0.0001-99.9999%, e.g. 0.001-50%, 0.01-20%, 0.01-10%, 0.01-5%, 0.1-5%, especially 0.1-1% of a monomer, such as an acrylate, methacrylate, vinyl ether etc. based on the total formulation which preferably contains solvent(s) and optionally other compounds such as defoamers, emulsifiers, surfactants, anti-fouling agents, wetting agents and other additives customarily used in the industry, especially the coating and paint industries.

The application of the nanoparticles, or mixtures thereof with one another or with monomers or oligomers, undiluted, in the form of melts, solutions, dispersions, suspensions or emulsions, aerosols, can be carried out in various ways. Application can be effected by vapor deposition, immersion, spraying, coating, brush application, knife application, roller application, offset printing, gravure printing, flexo printing, ink jet printing, screen printing, spin-coating and pouring. In the case of mixtures of nanoparticles with one another and with other components, all possible mixing ratios can be used.

The nanoparticle (formulation/solution) in step b) can be applied on the whole surface of the substrate, or can be applied only on selected areas.

Many possible methods of drying are known and they can all be used in the claimed process, in step c) as well as in optional step d). For example, it is possible to use hot gases, IR radiators, microwaves and radio frequency radiators, ovens and heated rollers. Drying can also be effected, for example, by absorption, e.g. penetration into the substrate. This relates especially to the drying in process step c). Drying can take place, for example, at temperatures of from 0° C. to 300° C., for example from 20° C. to 200° C., preferably from 20° C. to 100° C. and more preferably from 40° C. to 80° C.

The irradiation of the coating in order to fix the nanoparticle(s) in process step c) (and also to cure a formulation in optional process step d) can be carried out, as already mentioned above, using any sources that emit electromagnetic waves of wavelengths that are effective to fix the nanoparticles used on the substrate. Such sources are generally light sources that emit light in the range from 200 nm to 700 nm. It may also be possible to use electron beams. In addition to customary radiators and lamps it is also possible to use lasers and LEDs (Light Emitting Diodes).

Another source of UV-radiation (instead or in addition to UV-lamps) is for example corona treatment or plasma treatment as described above for step a). Said corona- or plasma treatment, in particular corona treatment, can also be applied in steps c) and/or d), especially in c). Preferably the irradiation in step c) is carried out with UV-lamps. Accordingly, in the context of the present invention the term “irradiation of the nanoparticle(s) in order to fix the nanoparticle(s) in process step c)” and “irradiation with electromagnetic waves” according to step c) besides a conventional irradiation via UV-lamps also encompasses a plasma- or corona treatment.

The whole area of the added nanoparticles or parts thereof may be irradiated. Partial irradiation is of advantage when only certain regions are to be rendered adherent. Irradiation can also be carried out using electron beams.

The drying and/or irradiation (in steps c) and/or d)) can be carried out under air or under inert gas. Nitrogen gas comes into consideration as inert gas, but other inert gases, such as CO₂ or argon, helium etc. or mixtures thereof, can also be used. Suitable systems and apparatus are known to the person skilled in the art and are commercially available.

For image-forming purposes, for example in resist and printing plate technology, the irradiation can be effected through a mask or by writing using moving laser beams (Laser Direct Imaging—LDI). Such partial irradiation can be followed by a development or washing step in which portions of the applied coating are removed by means of solvents and/or water or mechanically.

When the process according to the invention is used for image-forming purposes, the image-forming step can be carried out in process step c).

The invention therefore relates also to a process wherein portions of the nanoparticles, or mixtures thereof with monomers and/or oligomers, applied in process step b) that have not been crosslinked after irradiation in process step c) are removed by treatment with a solvent and/or water and/or mechanically.

The nanoparticle modified substrate can be subjected to a further process step d), which means to apply a further coating, which after drying and/or curing strongly adheres to the substrate via the nanoparticle layer applied in step b).

Process step d) can be performed immediately after the coating and drying in accordance with process steps a), b) and c) or the nanoparticle modified substrate can be stored in the this form until the application of an optional step d) is desired.

The formulation applied in step d) may for example be d1) a customary photocurable composition to be cured with UV/VIS or an electron beam, or d2) a customary coating, such coating being dried, for example, in air or thermally. The drying can be effected, for example, also by absorption, for example by penetration into the substrate.

In step d) on the substrate pretreated according to steps a), b) and c) also d3) a metal, half-metal or metal oxide may be deposited as final coating. In such a case metals can be applied by sputtering or as vapors. Metals or metal oxides can also be applied in the form of nanoparticles with a diameter of 1-10 microns, 1-1000 nm, preferably from 1-200 nm and more preferably with a diameter less than 100 nm.

The application of the formulations according to d1) and d2) can be performed in the same manner as described above for the formulation of step b). The further coating according to step d) in addition may be a metal layer.

A coating according to d1) is preferred.

Interesting therefore is a process, wherein the further coating d) is

d1) a solvent or waterborne composition, comprising at least one polymerizable monomer, e.g. an epoxide or an ethylenically unsaturated monomer or oligomer, that is cured with UV/VIS radiation or electron beam; or
d2) a solvent or waterborne customary drying coating, e.g. a printing ink or laquer; or
d3) a metal layer.

A formulation curable by UV/VIS or an electron beam is for example a radically curable composition (d1.1), a cationically curable composition (d1.2) or a composition which cures or crosslinks on the action of a base (d1.3).

Suitable ethylenically unsaturated compounds in step d1.1) may comprise one or more ethylenically unsaturated double bonds and are low molecular (monomer) or higher molecular (oligomer), e.g. monomers or oligomers as described above for step b).

Preferably the composition according to d1.1) in addition to at least one unsaturated monomer or oligomer comprises, at least one photoinitiator and/or coinitiator for the curing with UV/VIS radiation.

Accordingly, subject of the invention also is a process, wherein step d1.1) a photopolymerizable composition, comprising at least one ethylenically unsaturated monomer and/or oligomer and at least one photoinitiator and/or coinitiator, is applied to the substrate, which has been pretreated with steps a), b) and c), and is cured with UV/VIS radiation or electron beam, preferably with UV/VIS radiation.

As photoinitiator in the photocurable compositions according to step d1.1) compounds of the formula I may be used, but also, preferably, all other photoinitiators or photoinitiator systems known in the art.

Examples of suitable compounds are given above in connection with step b). In particular suitable are the described compounds other than the ones of formula I.

Preferably in the compositions according to step d1.1) photoinitiators without unsaturated groups are used.

The compositions used in process step d1.1) need not necessarily comprise a photoinitiator—for example they may be customary electron-beam-curable compositions (without photoinitiator) known to the person skilled in the art. Compositions comprising a photoinitiator are preferred.

The compositions can be applied in layer thicknesses of from about 0.1 μm to about 1000 μm, especially about from 1 μm to 100 μm. In the range of low layer thicknesses <50 μm, pigmented compositions e.g. are also referred to as printing inks.

The compositions may comprise further additives as for example light stabilizers, coinitiators and/or sensitizers.

As coinitiators there come into consideration, for example, sensitisers which shift or broaden the spectral sensitivity and thus bring about an acceleration of the photopolymerisation. They are especially aromatic carbonyl compounds, for example benzophenone, thioxanthone, especially isopropyl thioxanthone, anthraquinone and 3-acylcoumarin derivatives, terphenyls, styryl ketones, and also 3-(aroylmethylene)-thiazolines, camphor quinone, and also eosine, rhodamine and erythrosine dyes.

Amines, for example, can also be regarded as photosensitisers when the nanoparticle layer grafted on according to the invention consists of a benzophenone derived nanoparticle or if an additional benzophenone is added to the nanoparticles.

Further examples of photosensitisers are

### 1. Thioxanthones

Thioxanthone, 2-isopropylthioxanthone, 2-chlorothioxanthone, 2-dodecylthioxanthone, 2,4-diethylthioxanthone, 2,4-dimethylthioxanthone, 1-methoxycarbonylthioxanthone, 2-ethoxycarbonylthioxanthone, 3-(2-methoxyethoxycarbonyl)-thioxanthone, 4-butoxycarbonylthioxanthone, 3-butoxycarbonyl-7-methylthioxanthone, 1-cyano-3-chlorothioxanthone, 1-ethoxycarbonyl-3-chlorothioxanthone, 1-ethoxycarbonyl-3-ethoxythioxanthone, 1-ethoxycarbonyl-3-aminothioxanthone, 1-ethoxycarbonyl-3-phenylsulfurylthioxanthone, 3,4-di[2-(2-methoxyethoxy)ethoxycarbonyl]thioxanthone, 1-ethoxycarbonyl-3-(1-methyl-1-morpholinoethyl)-thioxanthone, 2-methyl-6-dimethoxymethyl-thioxanthone, 2-methyl-6-(1,1-dimethoxybenzyl)-thioxanthone, 2-morpholinomethylthioxanthone, 2-methyl-6-morpholinomethylthioxanthone, N-allylthioxanthone-3,4-dicarboximide, N-octylthioxanthone-3,4-dicarboximide, N-(1,1,3,3-tetramethylbutyl)-thioxanthone-3,4-dicarboximide, 1-phenoxythioxanthone, 6-ethoxycarbonyl-2-methoxythioxanthone, 6-ethoxycarbonyl-2-methylthioxanthone, thioxanthone-2-polyethylene glycol ester, 2-hydroxy-3-(3,4-dimethyl-9-oxo-9H-thioxanthon-2-yloxy)-N,N,N-trimethyl-1-propanaminium chloride;

### 2. Benzophenones

Benzophenone, 4-phenylbenzophenone, 4-methoxybenzophenone, 4,4′-dimethoxybenzophenone, 4,4′-dimethylbenzophenone, 4,4′-dichlorobenzophenone, 4,4′-dimethylaminobenzophenone, 4,4′-diethylaminobenzophenone, 4-methylbenzophenone, 2,4,6-trimethylbenzophenone, 4-(4-methylthiophenyl)-benzophenone, 3,3′-dimethyl-4-methoxybenzophenone, methyl-2-benzoyl benzoate, 4-(2-hydroxyethylthio)-benzophenone, 4-(4-tolylthio)-benzophenone, 4-benzoyl-N,N,N-trimethylbenzenemethanaminium chloride, 2-hydroxy-3-(4-benzoylphenoxy)-N,N,N-trimethyl-1-propanaminium chloride monohydrate, 4-(13-acryloyl-1,4,7,10,13-pentaoxamidecyl)-benzophenone, 4-benzoyl-N,N-dimethyl-N-[2-(1-oxo-2-propenyl)oxy]ethyl-benzenemethanaminium chloride;

### 3. 3-Acylcoumarins

3-Benzoylcoumarin, 3-benzoyl-7-methoxycoumarin, 3-benzoyl-5,7-di(propoxy)coumarin, 3-benzoyl-6,8-dichlorocoumarin, 3-benzoyl-6-chlorocoumarin, 3,3′-carbonyl-bis[5,7-di(propoxy)coumarin], 3,3′-carbonyl-bis(7-methoxycoumarin), 3,3′-carbonyl-bis(7-diethylaminocoumarin), 3-isobutyroylcoumarin, 3-benzoyl-5,7-dimethoxycoumarin, 3-benzoyl-5,7-diethoxycoumarin, 3-benzoyl-5,7-dibutoxycoumarin, 3-benzoyl-5,7-di(methoxyethoxy)-coumarin, 3-benzoyl-5,7-di(allyloxy)coumarin, 3-benzoyl-7-dimethylaminocoumarin, 3-benzoyl-7-diethylaminocoumarin, 3-isobutyroyl-7-dimethylaminocoumarin, 5,7-dimethoxy-3-(1-naphthoyl)-coumarin, 5,7-dimethoxy-3-(1-naphthoyl)-coumarin, 3-benzoylbenzo[f]coumarin, 7-diethylamino-3-thienoylcoumarin, 3-(4-cyanobenzoyl)-5,7-dimethoxycoumarin;

### 4. 3-(Aroylmethylene)-thiazolines

3-Methyl-2-benzoylmethylene-6-naphthothiazoline, 3-methyl-2-benzoylmethylene-benzothiazoline, 3-ethyl-2-propionylmethylene-6-naphthothiazoline;

### 5. Other Carbonyl Compounds

Acetophenone, 3-methoxyacetophenone, 4-phenylacetophenone, benzil, 2-acetylnaphthalene, 2-naphthaldehyde, 9,10-anthraquinone, 9-fluorenone, dibenzosuberone, xanthone, 2,5-bis(4-diethylaminobenzylidene)cyclopentanone, α-(para-dimethylaminobenzylidene)-ketones, such as 2-(4-dimethylamino-benzylidene)-indan-1-one or 3-(4-dimethylaminophenyl)-1-indan-5-yl-propenone, 3-phenylthiophthalimide, N-methyl-3,5-di(ethylthio)phthalimide, N-methyl-3,5-di(ethylthio)phthalimide.

In addition to those additives it is also possible for the composition to comprise further additives, especially light stabilisers. The nature and amount of such additional additives is governed by the intended use of the coating in question and will be familiar to the person skilled in the art.

As light stabilisers it is possible to add UV absorbers, e.g. those of the hydroxyphenylbenzotriazole, hydroxyphenylbenzophenone, oxalic acid amide or hydroxyphenyl-s-triazine type. Such compounds can be used singly or in the form of mixtures, with or without the use of sterically hindered amines (HALS).

Examples of such UV absorbers and light stabilisers are

1. 2-(2′-Hydroxyphenyl)-benzotriazoles, e.g. 2-(2′-hydroxy-5′-methylphenyl)-benzotriazole, 2-(3′,5′-di-tert-butyl-2′-hydroxyphenyl)-benzotriazole, 2-(5′-tert-butyl-2′-hydroxyphenyl)-benzotriazole, 2-(2′-hydroxy-5-(1,1,3,3-tetramethylbutyl)-phenyl)-benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)-benzotriazole, 2-(2′-hydroxy-4′-octyloxyphenyl)-benzotriazole, 2-(3′,5′-di-tert-amyl-2′-hydroxyphenyl)-benzotriazole, 2-(3′,5′-bis(α,α-dimethylbenzyl)-2′-hydroxyphenyl)benzotriazole, mixture of 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)-benzotriazole, 2-(3′-tert-butyl-2′-hydroxy-5′-(2-octyloxycarbonylethyl)phenyl)-benzotriazole, 2-(3′-tert-butyl-5′-[2-(2-ethylhexyloxy)carbonylethyl]-2′-hydroxyphenyl)-benzotriazole, 2-(3′-dodecyl-2′-hydroxy-5′-methylphenyl)-benzotriazole and 2-(3′-tert-butyl-2′-hydroxy-5′-(2-isooctyloxycarbonylethyl)-phenyl-benzotriazole, 2,2′-methylene-bis[4-(1,1,3,3-tetramethylbutyl)-6-benzotriazol-2-yl-phenol]; transesterification product of 2-[3′-tert-butyl-5′-(2-methoxycarbonylethyl)-2′-hydroxyphenyl]-benzotriazole with polyethylene glycol 300; [R—CH₂CH₂—COO(CH₂)₃]₂— wherein R=3′-tert-butyl-4′-hydroxy-5′-2H-benzotriazol-2-yl-phenyl.

2. 2-Hydroxybenzophenones, e.g. the 4-hydroxy, 4-methoxy, 4-octyloxy, 4-decyloxy, 4-dodecyloxy, 4-benzyloxy, 4,2′,4′-trihydroxy or 2′-hydroxy-4,4′-dimethoxy derivative.

3. Esters of unsubstituted or substituted benzoic acids, e.g. 4-tert-butyl-phenyl salicylate, phenyl salicylate, octylphenyl salicylate, dibenzoylresorcinol, bis(4-tert-butylbenzoyl)-resorcinol, benzoylresorcinol, 3,5-di-tert-butyl-4-hydroxybenzoic acid 2,4-di-tert-butylphenyl ester, 3,5-di-tert-butyl-4-hydroxybenzoic acid hexadecyl ester, 3,5-di-tert-butyl-4-hydroxybenzoic acid octadecyl ester, 3,5-di-tert-butyl-4-hydroxybenzoic acid 2-methyl-4,6-di-tert-butylphenyl ester.

4. Acrylates, e.g. α-cyano-β,β-diphenylacrylic acid ethyl ester or isooctyl ester, α-methoxycarbonylcinnamic acid methyl ester, α-cyano-β-methyl-p-methoxycinnamic acid methyl ester or butyl ester, α-methoxycarbonyl-p-methoxycinnamic acid methyl ester, N-(β-methoxycarbonyl-β-cyanovinyl)-2-methyl-indoline.

5. Sterically hindered amines, e.g. bis(2,2,6,6-tetramethylpiperidyl) sebacate, bis(2,2,6,6-tetramethylpiperidyl) succinate, bis(1,2,2,6,6-pentamethylpiperidyl) sebacate, n-butyl-3,5-ditert-butyl-4-hydroxybenzylmalonic acid bis(1,2,2,6,6-pentamethylpiperidyl) ester, condensation product of 1-hydroxyethyl-2,2,6,6-tetramethyl-4-hydroxypiperidine and succinic acid, condensation product of N,N′-bis(2,2,6,6-tetramethyl-4-piperidyl)hexamethylenediamine and 4-tert-octylamino-2,6-dichloro-1,3,5-s-triazine, tris(2,2,6,6-tetramethyl-4-piperidyl) nitrilotriacetate, tetrakis(2,2,6,6-tetramethyl-4-piperidyl)-1,2,3,4-butanetetraoate, 1,1′-(1,2-ethanediyl)bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl) malonate, 3-n-octyl-7,7,9,9-tetramethyl-1,3,8-triazaspiro[4.5]decane-2,4-dione, bis(1-octyloxy-2,2,6,6-tetramethylpiperidyl) sebacate, bis(1-octyloxy-2,2,6,6-tetramethylpiperidyl) succinate, condensation product of N,N′-bis(2,2,6,6-tetramethyl-4-piperidyl)-hexamethylenediamine and 4-morpholino-2,6-dichloro-1,3,5-triazine, condensation product of 2-chloro-4,6-di(4-n-butylamino-2,2,6,6-tetramethylpiperidyl)-1,3,5-triazine and 1,2-bis(3-aminopropylamino)ethane, condensation product of 2-chloro-4,6-di(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)-pyrrolidine-2,5-dione.

6. Oxalic acid diamides, e.g. 4,4′-dioctyloxyoxanilide, 2,2′-diethoxyoxanilide, 2,2′-dioctyloxy-5,5′-di-tert-butyl oxanilide, 2,2′-didodecyloxy-5,5′-di-tert-butyl oxanilide, 2-ethoxy-2′-ethyl oxanilide, N,N′-bis(3-dimethylaminopropyl) oxalamide, 2-ethoxy-5-tert-butyl-2′-ethyl oxanilide and a mixture thereof with 2-ethoxy-2′-ethyl-5,4′-di-tert-butyl oxanilide, mixtures of o- and p-methoxy- and also of o- and p-ethoxy-di-substituted oxanilides.

7. 2-(2-Hydroxyphenyl)-1,3,5-triazines, e.g. 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-[2-hydroxy-4-(2-hydroxy-3-butyloxypropyloxy)phenyl]-4,6-bis(2,4-dimethylphenyl)-1,3,5-triazine, 2-[2-hydroxy-4-(2-hydroxy-3-octyloxypropyloxy)phenyl]-4,6-bis(2,4-dimethylphenyl)-1,3,5-triazine, 2-[4-(dodecyloxy/tridecyloxy-2-hydroxypropyl)oxy-2-hydroxyphenyl]-4,6-bis(2,4-dimethylphenyl)-1,3,5-triazine, 2-(2-hydroxy-4-(2-ethylhexyl)oxy)-phenyl-4,6-di(4-phenyl)phenyl-1,3,5-triazine, 2-(2-hydroxy-4-(1-octyloxycarbonyl-ethoxy)-phenyl-4,6-di(4-phenyl)phenyl-1,3,5-triazine.

In addition to the light stabilisers mentioned above, other stabilisers, for example, such as phosphites or phosphonites, are also suitable.

8. Phosphites and phosphonites, e.g. triphenyl phosphite, diphenylalkyl phosphites, phenyldialkyl phosphites, tris(nonylphenyl)phosphite, trilauryl phosphite, trioctadecyl phosphite, distearyl-pentaerythritol diphosphite, tris(2,4-di-tert-butylphenyl)phosphite, diisodecylpentaerythritol diphosphite, bis(2,4-di-tert-butylphenyl)pentaerythritol diphosphite, bis(2,6-di-tertbutyl-4-methylphenyl)pentaerythritol diphosphite, bis-isodecyloxy-pentaerythritol diphosphite, bis(2,4-di-tert-butyl-6-methylphenyl)pentaerythritol diphosphite, bis(2,4,6-tri-tert-butylphenyl)-pentaerythritol diphosphite, tristearyl sorbitol triphosphite, tetrakis(2,4-di-tert-butylphenyl)-4,4′-biphenylene diphosphonite, 6-isooctyloxy-2,4,8,10-tetra-tert-butyl-12H-dibenzo[d,g]-1,3,2-dioxaphosphocine, 6-fluoro-2,4,8,10-tetra-tert-butyl-12-methyl-dibenzo[d,g]-1,3,2-dioxaphosphocine, bis(2,4-di-tert-butyl-6-methylphenyl)methyl phosphite, bis(2,4-di-tert-butyl-6-methylphenyl)ethyl phosphite.

Depending upon the field of use, it is also possible to use additives customary in the art, e.g. antistatics, antifogs, antimicrobials, antifoulings, dyes, UV-absorbers, hindered amine light stabilizers, flame retarders, flow improvers, release compounds and adhesion promoters.

The compositions may also be pigmented when a suitable photoinitiator is chosen, it being possible for coloured pigments as well as white pigments to be used.

Subject of the invention also is a process, wherein after irradiation in optional process step d) portions of the coating are removed by treatment with a solvent and/or water and/or mechanically.

Compositions applied in process step d1) or d2) are, for example, pigmented or unpigmented surface coatings, release layers, inks, ink-jet inks; printing inks, for example screen printing inks, offset printing inks, flexographic printing inks; or overprint varnishes; or primers; or printing plates, offset printing plates; powder coatings, adhesives or repair coatings, repair varnishes or repair putty compositions.

The compositions according to d1.2) comprise cationically curable components and an initiator to start the crosslinking. Examples for cationically curable components are resins and compounds that can be cationically polymerised by alkyl- or aryl-containing cations or by protons. Examples thereof include cyclic ethers, especially epoxides and oxetanes, and also vinyl ethers and hydroxy-containing compounds. Lactone compounds and cyclic thioethers as well as vinyl thioethers can also be used. Further examples include aminoplastics or phenolic resole resins. These are especially melamine, urea, epoxy, phenolic, acrylic, polyester and alkyd resins, but especially mixtures of acrylic, polyester or alkyd resins with a melamine resin. These include also modified surface-coating resins, such as, for example, acrylic-modified polyester and alkyd resins. Examples of individual types of resins that are included under the terms acrylic, polyester and alkyd resins are described, for example, in Wagner, Sarx/Lackkunstharze (Munich, 1971), pages 86 to 123 and 229 to 238, or in Ullmann/Encyclopädie der techn. Chemie, 4^{th} edition, volume 15 (1978), pages 613 to 628, or Ullmann's Encyclopedia of Industrial Chemistry, Verlag Chemie, 1991, Vol. 18, 360 ff., Vol. A19, 371 ff. The surface-coating preferably comprises an amino resin. Examples thereof include etherified and non-etherified melamine, urea, guanidine and biuret resins. Of special importance is acid catalysis for the curing of surface-coatings comprising etherified amino resins, such as, for example, methylated or butylated melamine resins (N-methoxymethyl- or N-butoxymethyl-melamine) or methylated/butylated glycolurils.

It is possible, for example, to use all customary epoxides, such as aromatic, aliphatic or cycloaliphatic epoxy resins. These are compounds having at least one, preferably at least two, epoxy group(s) in the molecule. Examples thereof are the glycidyl ethers and 8-methyl glycidyl ethers of aliphatic or cycloaliphatic diols or polyols, e.g. those of ethylene glycol, propane-1,2-diol, propane-1,3-diol, butane-1,4-diol, diethylene glycol, polyethylene glycol, polypropylene glycol, glycerol, trimethylolpropane or 1,4-dimethylolcyclohexane or of 2,2-bis(4-hydroxycyclohexyl)propane and N,N-bis(2-hydroxyethyl)aniline; the glycidyl ethers of di- and poly-phenols, for example of resorcinol, of 4,4′-dihydroxyphenyl-2,2-propane, of novolaks or of 1,1,2,2-tetrakis(4-hydroxyphenyl)ethane. Examples thereof include phenyl glycidyl ether, p-tert-butyl glycidyl ether, o-icresyl glycidyl ether, polytetrahydrofuran glycidyl ether, n-butyl glycidyl ether, 2-ethylhexyl glycidyl ether, C_{12/15}alkyl glycidyl ether and cyclohexanedimethanol diglycidyl ether. Further examples include N-glycidyl compounds, for example the glycidyl compounds of ethyleneurea, 1,3-propyleneurea or 5-dimethyl-hydantoin or of 4,4′-methylene-5,5′-tetramethyldihydantoin, or compounds such as triglycidyl isocyanurate.

Further examples of glycidyl ether components that are suitable for the formulations are glycidyl ethers of polyhydric phenols obtained by the reaction of polyhydric phenols with an excess of chlorohydrin, such as, for example, epichlorohydrin (e.g. glycidyl ethers of 2,2-bis(2,3-epoxypropoxyphenol)propane. Further examples of glycidyl ether epoxides that can be used in connection with the present invention are described, for example, in U.S. Pat. No. 3,018,262 and in “Handbook of Epoxy Resins” by Lee and Neville, McGraw-Hill Book Co., New York (1967).

There is also a large number of commercially available glycidyl ether epoxides that are suitable, such as, for example, glycidyl methacrylate, diglycidyl ethers of bisphenol A, for example those obtainable under the trade names EPON 828, EPON 825, EPON 1004 and EPON 1010 (Shell); DER-331, DER-332 and DER-334 (Dow Chemical); 1,4-butanediol diglycidyl ethers of phenolformaldehyde novolak, e.g. DEN-431, DEN-438 (Dow Chemical); and resorcinol diglycidyl ethers; alkyl glycidyl ethers, such as, for example, C₈-C₁₀glycidyl ethers, e.g. HELOXY Modifier 7, C₁₂-C₁₄glycidyl ethers, e.g. HELOXY Modifier 8, butyl glycidyl ethers, e.g. HELOXY Modifier 61, cresyl glycidyl ethers, e.g. HELOXY Modifier 62, p-tert-butylphenyl glycidyl ethers, e.g. HELOXY Modifier 65, polyfunctional glycidyl ethers, such as diglycidyl ethers of 1,4-butanediol, e.g. HELOXY Modifier 67, diglycidyl ethers of neopentyl glycol, e.g. HELOXY Modifier 68, diglycidyl ethers of cyclohexanedimethanol, e.g. HELOXY Modifier 107, trimethylolethane triglycidyl ethers, e.g. HELOXY Modifier 44, trimethylolpropane triglycidyl ethers, e.g. HELOXY Modifier 48, polyglycidyl ethers of aliphatic polyols, e.g. HELOXY Modifier 84 (all HELOXY glycidyl ethers are obtainable from Shell).

Also suitable are glycidyl ethers that comprise copolymers of acrylic esters, such as, for example, styrene-glycidyl methacrylate or methyl methacrylate-glycidyl acrylate. Examples thereof include 1:1 styrene/glycidyl methacrylate, 1:1 methyl methacrylate/glycidyl acrylate, 62.5:24:13.5 methyl methacrylate/ethyl acrylate/glycidyl methacrylate.

The polymers of the glycidyl ether compounds can, for example, also comprise other functionalities provided that these do not impair the cationic curing.

Other suitable glycidyl ether compounds that are commercially available are polyfunctional liquid and solid novolak glycidyl ether resins, e.g. PY 307, EPN 1179, EPN 1180, EPN 1182 and ECN 9699.

It will be understood that mixtures of different glycidyl ether compounds may also be used.

The glycidyl ethers are, for example, compounds of formula X

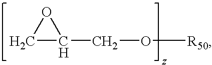

wherein z is a number from 1 to 6; and R₅₀ is a mono- to hexa-valent alkyl or aryl radical.

Preference is given, for example, to glycidyl ether compounds, wherein z s the number 1, 2 or 3; and R₅₀, when z=1, is unsubstituted or C₁-C₁₂alkyl-substituted phenyl, naphthyl, anthracyl, biphenylyl, C₁-C₂₀alkyl, or C₂-C₂₀alkyl interrupted by one or more oxygen atoms, or R₅₀, when z=2, is 1,3-phenylene, 1,4-phenylene, C₆-C₁₀cycloalkylene, unsubstituted or halo-substituted C₁-C₄₀alkylene, C₂-C₄₀alkylene interrupted by one or more oxygen atoms, or a group

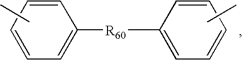

or R₅₀, when z=3, is a radical

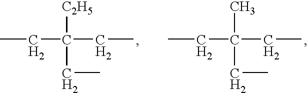

or

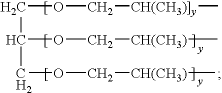

y is a number from 1 to 10; and R₆₀ is C₁-C₂₀alkylene, oxygen or

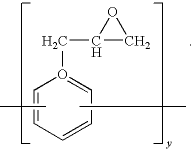

Further examples are polyglycidyl ethers and poly(β-methylglycidyl)ethers obtainable by the reaction of a compound containing at least two free alcoholic and/or phenolic hydroxy groups per molecule with the appropriate epichlorohydrin under alkaline conditions, or alternatively in the presence of an acid catalyst with subsequent alkali treatment. Mixtures of different polyols may also be used. Such ethers can be prepared with poly(epichlorohydrin) from acyclic alcohols, such as ethylene glycol, diethylene glycol and higher poly(oxyethylene) glycols, propane-1,2-diol and poly(oxypropylene) glycols, propane-1,3-diol, butane-1,4-diol, poly(oxytetramethylene) glycols, pentane-1,5-diol, hexane-1,6-diol, hexane-2,4,6-triol, glycerol, 1,1,1-trimethylol-propane, pentaerythritol and sorbitol, from cycloaliphatic alcohols, such as resorcitol, quinitol, bis(4-hydroxycyclohexyl)methane, 2,2-bis(4-hydroxycyclohexyl)propane and 1,1-bis-(hydroxymethyl)cyclohex-3-ene, and from alcohols having aromatic nuclei, such as N,N-bis(2-hydroxyethyl)aniline and p,p′-bis(2-hydroxyethylamino)diphenylmethane. They can also be prepared from mononuclear phenols, such as resorcinol and hydroquinone, and polynuclear phenols, such as bis(4-hydroxyphenyl)methane, 4,4-dihydroxydiphenyl, bis(4-hydroxyphenyl)sulfone, 1,1,2,2-tetrakis(4-hydroxyphenyl)ethane, 2,2-bis(4-hydroxyphenyl)-propane (bisphenol A) and 2,2-bis(3,5-dibromo-4-hydroxyphenyl)propane. Further hydroxy compounds suitable for the preparation of polyglycidyl ethers and poly(β-methylglycidyl)ethers are the novolaks obtainable by the condensation of aldehydes, such as formaldehyde, acetaldehyde, chloral and furfural, with phenols, such as, for example, phenol, o-cresol, m-cresol, p-cresol, 3,5-dimethylphenol, 4-chlorophenol and 4-tert-butylphenol.

Poly(N-glycidyl) compounds can be obtained, for example, by dehydrochlorination of the reaction products of epichlorohydrin with amines containing at least two aminohydrogen atoms, such as aniline, n-butylamine, bis(4-aminophenyl)methane, bis(4-aminophenyl)-propane, bis(4-methylaminophenyl)methane and bis(4-aminophenyl)ether, sulfone and sulfoxide. Further suitable poly(N-glycidyl) compounds include triglycidyl isocyanurate, and N,N′-diglycidyl derivatives of cyclic alkyleneureas, such as ethyleneurea and 1,3-propyleneurea, and hydantoins, such as, for example, 5,5-dimethylhydantoin.

Poly(S-glycidyl) compounds are also suitable. Examples thereof include the di-S-glycidyl derivatives of dithiols, such as ethane-1,2-dithiol and bis(4-mercaptomethylphenyl)ether. There also come into consideration epoxy resins in which the glycidyl groups or β-methyl glycidyl groups are bonded to hetero atoms of different types, for example the N,N,O-triglycidyl derivative of 4-aminophenol, the glycidyl ether/glycidyl ester of salicylic acid or p-hydroxybenzoic acid, N-glycidyl-N′-(2-glycidyloxypropyl)-5,5-dimethyl-hydantoin and 2-glycidyloxy-1,3-bis(5,5-dimethyl-1-glycidylhydantoin-3-yl)propane.

Preference is given to diglycidyl ethers of bisphenols. Examples thereof include diglycidyl ethers of bisphenol A, e.g. ARALDIT GY 250, diglycidyl ethers of bisphenol F and diglycidyl ethers of bisphenol S. Special preference is given to diglycidyl ethers of bisphenol A.

Further glycidyl compounds of technical importance are the glycidyl esters of carboxylic acids, especially di- and poly-carboxylic acids. Examples thereof are the glycidyl esters of succinic acid, adipic acid, azelaic acid, sebacic acid, phthalic acid, terephthalic acid, tetra- and hexa-hydrophthalic acid, isophthalic acid or trimellitic acid, or of dimerised fatty acids. Examples of polyepoxides that are not glycidyl compounds are the epoxides of vinylcyclohexane and dicyclopentadiene, 3-(3′,4′-epoxycyclohexyl)-8,9-epoxy-2,4-dioxaspiro-[5.5]undecane, the 3′,4′-epoxycyclohexylmethyl esters of 3,4-epoxycyclohexanecarboxylic acid, (3,4-epoxycyclohexyl-methyl 3,4-epoxycyclohexanecarboxylate), butadiene diepoxide or isoprene diepoxide, epoxidised linoleic acid derivatives or epoxidised polybutadiene.

Further suitable epoxy compounds are, for example, limonene monoxide, epoxidised soybean oil, bisphenol-A and bisphenol-F epoxy resins, such as, for example, Araldit® GY 250 (A), Araldit® GY 282 (F), Araldit® GY 285 (F).

Further suitable cationically polymerisable or crosslinkable components can be found, for example, also in U.S. Pat. No. 3,117,099, U.S. Pat. No. 4,299,938 and U.S. Pat. No. 4,339,567.

From the group of aliphatic epoxides there are suitable especially the monofunctional symbol α-olefin epoxides having an unbranched chain consisting of 10, 12, 14 or 16 carbon atoms. Because nowadays a large number of different epoxy compounds are commercially available, the properties of the binder can vary widely. One possible variation, for example depending upon the intended use of the composition, is the use of mixtures of different epoxy compounds and the addition of flexibilisers and reactive diluents.

The epoxy resins can be diluted with a solvent to facilitate application, for example when application is effected by spraying, but the epoxy compound is preferably used in the solventless state. Resins that are viscous to solid at room temperature can be applied hot.

Also suitable are all customary vinyl ethers, such as aromatic, aliphatic or cycloaliphatic vinyl ethers and also silicon-containing vinyl ethers. These are compounds having at least one, preferably at least two, vinyl ether groups in the molecule. Examples of vinyl ethers suitable for use in the compositions according to the invention include triethylene glycol divinyl ether, 1,4-cyclohexanedimethanol divinyl ether, 4-hydroxybutyl vinyl ether, the propenyl ether of propylene carbonate, dodecyl vinyl ether, tert-butyl vinyl ether, tert-amyl vinyl ether, cyclohexyl vinyl ether, 2-ethylhexyl vinyl ether, ethylene glycol monovinyl ether, butanediol monovinyl ether, hexanediol monovinyl ether, 1,4-cyclohexanedimethanol monovinyl ether, diethylene glycol monovinyl ether, ethylene glycol divinyl ether, ethylene glycol butylvinyl ether, butane-1,4-diol divinyl ether, hexanediol divinyl ether, diethylene glycol divinyl ether, triethylene glycol divinyl ether, triethylene glycol methylvinyl ether, tetra-ethylene glycol divinyl ether, pluriol-E-200 divinyl ether, polytetrahydrofuran divinyl ether-290, trimethylolpropane trivinyl ether, dipropylene glycol divinyl ether, octadecyl vinyl ether, (4-cyclohexyl-methyleneoxyethene)-glutaric acid methyl ester and (4-butoxyethene)-isophthalic acid ester.

Examples of hydroxy-containing compounds include polyester polyols, such as, for example, polycaprolactones or polyester adipate polyols, glycols and polyether polyols, castor oil, hydroxy-functional vinyl and acrylic resins, cellulose esters, such as cellulose acetate butyrate, and phenoxy resins.

Further cationically curable formulations can be found, for example, in EP 119425.

If desired, the cationically curable composition can also contain free-radically polymerisable components, such as ethylenically unsaturated monomers, oligomers or polymers as described above. Suitable materials contain at least one ethylenically unsaturated double bond and are capable of undergoing addition polymerisation.

Advantageously, the formulations comprise at least one photoinitiator. Suitable examples are known to the person skilled in the art and commercially available in a considerable number.

Representative examples are for example disclosed by J. V. Crivelleo and K. Dietliker in Photoinitiators for Free Radical Cationic & Anionic Photopolymerisation, 2^{nd} Ed. Vol III, Wiley. Examples are benzoyl peroxides (as e.g. described in U.S. Pat. No. 4,950,581, column 19, lines 17-25), or aromatic sulfonium salts, as e.g. disclosed in WO 03/008404 and WO 03/072567, phosphonium or iodonium salts, such as are described, for example, in U.S. Pat. No. 4,950,581, column 18, line 60 to column 19, line 10, WO 99/35188, WO 98/02493, WO 99/56177 and U.S. Pat. No. 6,306,555. Further suitable initiators are oximesulfonates.

Suitable sulfonium salts are obtainable, for example, under the trade names ®Cyracure UVI-6990, ®Cyracure UVI-6974 (Union Carbide), ®Degacure KI 85 (Degussa), SP-55, SP-150, SP-170 (Asahi Denka), GE UVE 1014 (General Electric), SarCat®KI-85 (=triarylsulfonium hexafluorophosphate; Sartomer), SarCat® CD 1010 (=mixed triarylsulfonium hexafluoroantimonate; Sartomer); SarCat® CD 1011 (=mixed triarylsulfonium hexafluorophosphate; Sartomer).

Suitable iodonium salts are e.g. tolylcumyliodonium tetrakis(pentafluorophenyl)borate, 4-[(2-hydroxy-tetradecyloxy)phenyl]phenyliodonium hexafluoroantimonate or hexafluorophosphate (SarCat® CD 1012; Sartomer), tolylcumyliodonium hexafluorophosphate, 4-isobutylphenyl-4′-methylphenyliodonium hexafluorophosphate (IRGACURE® 250, Ciba Specialty Chemicals), 4-octyloxyphenyl-phenyliodonium hexafluorophosphate or hexafluoroantimonate, bis(dodecylphenyl)iodonium hexafluoroantimonate or hexafluorophosphate, bis(4-methylphenyl)-iodonium hexafluorophosphate, bis(4-methoxyphenyl)iodonium hexafluorophosphate, 4-methylphenyl-4′-ethoxyphenyliodonium hexafluorophosphate, 4-methylphenyl-4′-dodecylphenyliodonium hexafluorophosphate, 4-methylphenyl-4′-phenoxyphenyliodonium hexafluorophosphate. Of all the iodonium salts mentioned, compounds with other anions are, of course, also suitable. The preparation of iodonium salts is known to the person skilled in the art and described in the literature, for example U.S. Pat. No. 4,151,175, U.S. Pat. No. 3,862,333, U.S. Pat. No. 4,694,029, EP 562897, U.S. Pat. No. 4,399,071, U.S. Pat. No. 6,306,555, WO 98/46647 J. V. Crivello, “Photoinitiated Cationic Polymerization” in: UV Curing: Science and Technology, Editor S. P. Pappas, pages 24-77, Technology Marketing Corporation, Norwalk, Conn. 1980, ISBN No. 0-686-23773-0; J. V. Crivello, J. H. W. Lam, Macromolecules, 10, 1307 (1977) and J. V. Crivello, Ann. Rev. Mater. Sci. 1983, 13, pages 173-190 and J. V. Crivello, Journal of Polymer Science, Part A: Polymer Chemistry, Vol. 37, 4241-4254 (1999).

Specific examples of oxime sulfonates are α-(octylsulfonyloxyimino)-4-methoxybenzylcyanide, 2-methyl-α-[5-[4-[[methyl-sulfonyl]oxy]imino]-2(5H)-thienylidene]-benzeneacetonitrile, 2-methyl-α-[5-[4-[[(n-propyl)sulfonyl]oxy]imino]-2(5H)-thienylidene]-benzeneacetonitrile, 2-methyl-α-[5-[4-[[(camphoryl)sulfonyl]oxy]imino]-2(5H)-thienylidene]-benzeneacetonitrile, 2-methyl-α-[5-[4-[[(4-methylphenyl)sulfonyl]oxy]imino]-2(5H)-thienylidene]-benzeneacetonitrile, 2-methyl-α-[5-[4-[[(n-octyl)sulfonyl]oxy]imino]-2(5H)-thienylidene]-benzeneacetonitrile, 2-methyl-α[5-[[[[4-[[(4-methylphenyl)sulfonyl]oxy]phenyl]sulfonyl]oxy]imino]-2(5H)-thienylidene]-benzeneacetonitrile, 1,1′-[1,3-propanediylbis(oxy-4,1-phenylene)]bis[2,2,2-trifluoro-bis[O-(trifluoromethylsulfonyl)oxime]-ethanone, 1,1′-[1,3-propanediylbis(oxy-4,1-phenylene)]bis[2,2,2-trifluoro-bis[O-(propylsulfonyl)oxime]-ethanone, 1,1′-[1,3-propanediylbis(oxy-4,1-phenylene)]bis[2,2,2-trifluoro-bis[O-((4-methylphenyl)sulfonyl)oxime]-ethanone, α-(methylsulfonyloxyimino)-4-methoxybenzylcyanide, α-(methylsulfonyloxyimino)-3-methoxybenzylcyanide, α-(methylsulfonyloxyimino)-3,4-dimethylbenzylcyanide, α-(methylsulfonyloxyimino)-thiophene-3-acetonitrile, α-(isopropylsulfonyloxyimino)-thiophene-2-acetonitrile, cis/trans-α-(dodecylsulfonyloxyimino)-thiophene-2-acetonitrile.

Suitable oximesulfonates and their preparation can be found, for example, in WO 00/10972, WO 00/26219, GB 2348644, U.S. Pat. No. 4,450,598, WO 98/10335, WO 99/01429, EP 780729, EP 821274, U.S. Pat. No. 5,237,059, EP 571330, EP 241423, EP 139609, EP 361907, EP 199672, EP 48615, EP 12158, U.S. Pat. No. 4,136,055, WO 02/25376, WO 02/98870, WO 03/067332 and WO 04/74242. A summary of further photolatent acid donors is given in the form of a review by M. Shirai and M. Tsunooka in Prog. Polym. Sci., Vol. 21, 1-45 (1996). and in J. Crivello, K. Dietliker, “Photoinititiators for Free Radical Cationic & Anionic Photopolymerisation”, 2^{nd} Edition, Volume III in the Series “Chemistry & Technology of UV & EB Formulation for Coatings, Inks & Paints”, John Wiley/SITA Technology Limited, London, 1998, chapter III (p. 329-463).

It is evident for the person skilled in the art, that also the cationically curable formulations may further comprise customary additives, sensitizers, pigments and colorants etc. Examples are given above.

The base-catalysed polymerization, addition, condensation or substitution reaction may be carried out with low molecular mass compounds (monomers), with oligomers, with polymeric compounds, or with a mixture of such compounds. Examples of reactions which can be conducted both on monomers and on oligomers/polymers using the photoinitiators of the invention are the Knoevenagel reaction and the Michael addition reaction.

Of particular interest are compositions comprising an anionically polymerizable or crosslinkable organic material. The organic material may be in the form of monofunctional or polyfunctional monomers, oligomers or polymers.

Particularly preferred oligomeric/polymeric systems are binders such as are customary in the coatings industry.

Examples of base-catalysable binders of this kind are

a) two-component systems comprising hydroxyl-containing polyacrylates, polyesters and/or polyethers and aliphatic or aromatic polyisocyanates;
b) two-component systems comprising functional polyacrylates and polyepoxide, the polyacrylate containing thiol, amino, carboxyl and/or anhydride groups, as described, for example, in EP 898202;
c) two-component systems comprising (poly)ketimines and aliphatic or aromatic polyisocyanates;
d) two-component systems comprising (poly)ketimines and unsaturated acrylic resins or acetoacetate resins or methyl α-acrylamidomethylglycolate;
e) two-component systems comprising (poly)oxazolidines and polyacrylates containing anhydride groups or unsaturated acrylic resins or polyisocyanates;
f) two-component systems comprising epoxy-functional polyacrylates and carboxyl-containing or amino-containing polyacrylates;
g) polymers based on allyl glycidyl ether;
h) two-component systems comprising a (poly)alcohol and/or (poly)thiol and a (poly)isocyanate;
i) two-component systems comprising an α,β-ethylenically unsaturated carbonyl compound and a polymer containing activated CH₂ groups, the activated CH₂ groups being present either in the main chain or in the side chain or in both, as is described, for example, in EP 161697 for (poly)malonate groups. Other compounds containing activated CH₂ groups are (poly)acetoacetates and (poly)cyanoacetates;
k) Two-component systems comprising a polymer containing activated CH₂ groups, the activated CH₂ groups being present either in the main chain or in the side chain or in both, or a polymer containing activated CH₂ groups such as (poly)acetoacetates and (poly)cyanoacetates, and a polyaldehyde crosslinker, such as terephthalaldehyde. Such systems are described, for example, in Urankar et al., Polym. Prepr. (1994), 35, 933.

The components of the system react with one another under base catalysis at room temperature to form a crosslinked coating system which is suitable for a large number of applications. Because of its already good weathering stability it is also suitable, for example, for exterior applications and can where necessary be further stabilized by UV absorbers and other light stabilizers.

Further suitable components in the compositions include epoxy systems. Suitable epoxy resins are described above in connection with the cationically curable systems.

The curable component may also comprise compounds which are converted into a different form by exposure to bases. These are, for example, compounds which under base catalysis alter their solubility in suitable solvents, by elimination of protective groups, for example. Examples are chemically amplified photoresist formulations which react under base catalysis, as described, for example, by Leung in Polym. Mat. Sci. Eng. 1993, 68, 30.

Examples for basically curable components as well as the corresponding initiator compounds are to be found in WO 98/32756, WO 98/38195, WO 98/41524, EP 898202, WO 00/10964, EP 1243632, WO 03/33500, WO 97/31033.

The compositions contain the photoinitiator in an amount, for example, of from 0.01 to 20% by weight, preferably from 0.01 to 10% by weight, based on the curable component.

In addition, the photopolymerizable mixtures may include various customary additives known to the person skilled in the art, e.g. thermal inhibitors, fillers and reinforcing agents, for example calcium carbonate, silicates, glass fibres, glass beads, asbestos, talc, kaolin, mica, barium sulfate, metal oxides and hydroxides, carbon black, graphite, wood flour and flours or fibres of other natural products, synthetic fibres, plasticizers, lubricants, emulsifiers, pigments, rheological additives, catalysts, levelling assistants, optical brighteners, flameproofing agents, antistatics, blowing agents. In addition to the additives indicated above it is also possible for additional coinitiators or sensitizers to be present. Examples are given above.

The formulations which cure upon the action of a base comprise a base-releasing compound. As photolatent bases there come into consideration, for example, capped amine compounds, for example generally the photolatent bases known in the art. Examples are compounds of the classes: o-nitrobenzyloxycarbonylamines, 3,5-dimethoxy-α,α-dimethylbenzyloxycarbonylamines, benzoin carbamates, derivatives of anilides, photolatent guanidines, generally photolatent tertiary amines, for example ammonium salts of α-ketocarboxylic acids, or other carboxylates, benzhydrylammonium salts, N-(benzophenonylmethyl)-tri-N-alkylammonium triphenylalkyl borates, photolatent bases based on metal complexes, e.g. cobalt amine complexes, tungsten and chromium pyridinium pentacarbonyl complexes, anion-generating photoinitators based on metals, such as chromium and cobalt complexes “Reinecke salts” or metalloporphyrins. Examples thereof are published in J. V. Crivello, K. Dietliker “Photoinitiators for Free Radical, Cationic & Anionic Photopolymerisation”, Vol. III of “Chemistry & Technology of UV & EB Formulation for Coatings, Inks & Paints”, 2nd Ed., J. Wiley and Sons/SITA Technology (London), 1998. Suitable compounds are for example disclosed in WO 98/32756, WO 98/38195, WO 98/41524, EP 898202, WO 00/10964, EP 1243632, WO 03/33500, WO 97/31033.

The coating used in process step d2) also may be a radically or cationically crosslinking formulation as well as formulation which is cured upon the action of a base. Said formulations may for example cure by drying or thermally, optionally with corresponding thermal initiators being present. The person skilled in the art is familiar with suitable compositions.

d2) is preferably a printing ink.

Such printing inks are known to the person skilled in the art, are used widely in the art and are described in the literature.

They are, for example, pigmented printing inks and printing inks coloured with dyes.

A printing ink is, for example, a liquid or paste-form dispersion that comprises colorants (pigments or dyes), binders and also optionally solvents and/or optionally water and additives. In a liquid printing ink, the binder and, if applicable, the additives are generally dissolved in a solvent. Customary viscosities in the Brookfield viscometer are, for example, from 20 to 5000 mPa·s, for example from 20 to 1000 mPa·s, for liquid printing inks. For paste-form printing inks, the values range, for example, from 1 to 100 Pa·s, preferably from 5 to 50 Pa·s. The person skilled in the art will be familiar with the ingredients and compositions of printing inks.

Suitable pigments, like the printing ink formulations customary in the art, are generally known and widely described.

Printing inks comprise pigments advantageously in a concentration of, for example, from 0.01 to 40% by weight, preferably from 1 to 25% by weight, especially from 5 to 10% by weight, based on the total weight of the printing ink.

The printing inks can be used, for example, for intaglio printing, flexographic printing, screen printing, offset printing, lithography or continuous or dropwise ink-jet printing on material pretreated in accordance with the process of the invention using generally known formulations, for example in publishing, packaging or shipping, in logistics, in advertising, in security printing or in the field of office equipment.

Suitable printing inks are both solvent-based printing inks and water-based printing inks.

Of interest are, for example, printing inks based on aqueous acrylate. Such inks are to be understood as including polymers or copolymers that are obtained by polymerisation of at least one monomer containing a group

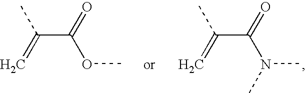

and that are dissolved in water or a water-containing organic solvent. Suitable organic solvents are water-miscible solvents customarily used by the person skilled in the art, for example alcohols, such as methanol, ethanol and isomers of propanol, butanol and pentanol, ethylene glycol and ethers thereof, such as ethylene glycol methyl ether and ethylene glycol ethyl ether, and ketones, such as acetone, ethyl methyl ketone or cyclo, for example isopropanol. Water and alcohols are preferred.

Suitable printing inks comprise, for example, as binder primarily an acrylate polymer or copolymer and the solvent is selected, for example, from the group consisting of water, C₁-C₅alcohols, ethylene glycol, 2-(C₁-C₅alkoxy)-ethanol, acetone, ethyl methyl ketone and any mixtures thereof.

In addition to the binder, the printing inks may also comprise customary additives known to the person skilled in the art in customary concentrations.

For intaglio or flexographic printing, a printing ink is usually prepared by dilution of a printing ink concentrate and can then be used in accordance with methods known per se.

The printing inks may, for example, also comprise alkyd systems that dry oxidatively.

The printing inks are dried in a known manner customary in the art, optionally with heating of the coating.

A suitable aqueous printing ink composition comprises, for example, a pigment or a combination of pigments, a dispersant and a binder.

Dispersants that come into consideration include, for example, customary dispersants, such as water-soluble dispersants based on one or more arylsulfonic acid/formaldehyde condensation products or on one or more water-soluble oxalkylated phenols, non-ionic dispersants or polymeric acids.

The arylsulfonic acid/formaldehyde condensation products are obtainable, for example, by sulfonation of aromatic compounds, such as naphthalene itself or naphthalene-containing mixtures, and subsequent condensation of the resulting arylsulfonic acids with formaldehyde. Such dispersants are known and are described, for example, in U.S. Pat. No. 5,186,846 und DE-A-197 27 767. Suitable oxalkylated phenols are likewise known and are described, for example, in U.S. Pat. No. 4,218,218 und DE-A-197 27 767. Suitable non-ionic dispersants are, for example, alkylene oxide adducts, polymerisation products of vinylpyrrolidone, vinyl acetate or vinyl alcohol and co- or ter-polymers of vinyl pyrrolidone with vinyl acetate and/or vinyl alcohol.

It is also possible, for example, to use polymeric acids which act both as dispersants and as binders.

Examples of suitable binder components that may be mentioned include acrylate-group-containing, vinyl-group-containing and/or epoxy-group-containing monomers, prepolymers and polymers and mixtures thereof. Further examples are melamine acrylates and silicone acrylates. The acrylate compounds may also be non-ionically modified (e.g. provided with amino groups) or ionically modified (e.g. provided with acid groups or ammonium groups) and used in the form of aqueous dispersions or emulsions (e.g. EP-A-704 469, EP-A-12 339). Furthermore, in order to obtain the desired viscosity the solventless acrylate polymers can be mixed with so-called reactive diluents, for example vinyl-group-containing monomers. Further suitable binder components are epoxy-group-containing compounds.

The printing ink compositions may also comprise as additional component, for example, an agent having a water-retaining action (humectant), e.g. polyhydric alcohols, polyalkylene glycols, which renders the compositions especially suitable for ink-jet printing.

It will be understood that the printing inks may comprise further auxiliaries, such as are customary especially for (aqueous) ink-jet inks and in the printing and coating industries, for example preservatives (such as glutardialdehyde and/or tetramethylolacetyleneurea, anti-oxidants, degassers/defoamers, viscosity regulators, flow improvers, anti-settling agents, gloss improvers, lubricants, adhesion promoters, anti-skin agents, matting agents, emulsifiers, stabilisers, hydrophobic agents, light stabilisers, handle improvers and antistatics. When such agents are present in the compositions, their total amount is generally ≦1% by weight, based on the weight of the preparation.

Printing inks suitable in process step d2) include, for example, those comprising a dye (with a total content of dyes of e.g. from 1 to 35% by weight, based on the total weight of the ink). Dyes suitable for colouring such printing inks are known to the person skilled in the art and are widely available commercially, e.g. from Ciba Spezialitätenchemie AG, Basel.

Such printing inks may comprise organic solvents, e.g. water-miscible organic solvents, for example C₁-C₄alcohols, amides, ketones or ketone alcohols, ethers, nitrogen-containing heterocyclic compounds, polyalkylene glycols, C₂-C₆alkylene glycols and thioglycols, further polyols, e.g. glycerol and C₁-C₄alkyl ethers of polyhydric alcohols, usually in an amount of from 2 to 30% by weight, based on the total weight of the printing ink.

The printing inks may also, for example, comprise solubilisers, e.g. ε-caprolactam.

The printing inks may, inter alia for the purpose of adjusting the viscosity, comprise thickeners of natural or synthetic origin. Examples of thickeners include commercially available alginate thickeners, starch ethers or locust bean flour ethers. The printing inks comprise such thickeners e.g. in an amount of from 0.01 to 2% by weight, based on the total weight of the printing ink.

It is also possible for the printing inks to comprise buffer substances, for example borax, borate, phosphate, polyphosphate or citrate, in amounts of e.g. from 0.1 to 3% by weight, in order to establish a pH value of e.g. from 4 to 9, especially from 5 to 8.5.

As further additives, such printing inks may comprise surfactants or humectants. Surfactants that come into consideration include commercially available anionic and non-ionic surfactants. Humectants that come into consideration include, for example, urea or a mixture of sodium lactate (advantageously in the form of a 50 to 60% aqueous solution) and glycerol and/or propylene glycol in amounts of e.g. from 0.1 to 30% by weight, especially from 2 to 30% by weight, in the printing inks.

Furthermore, the printing inks may also comprise customary additives, for example foam-reducing agents or especially substances that inhibit the growth of fungi and/or bacteria.

Such additives are usually used in amounts of from 0.01 to 1% by weight, based on the total weight of the printing ink.

The printing inks may also be prepared in customary manner by mixing the individual components together, for example in the desired amount of water.

As already mentioned, depending upon the nature of the use, it may be necessary for e.g. the viscosity or other physical properties of the printing ink, especially those properties which influence the affinity of the printing ink for the substrate in question, to be adapted accordingly.

The printing inks are also suitable, for example, for use in recording systems of the kind in which a printing ink is expressed from a small opening in the form of droplets which are directed towards a substrate on which an image is formed. Suitable substrates are, for example, textile fibre materials, paper, plastics or aluminium foils pretreated by the process according to the invention. Suitable recording systems are e.g. commercially available ink-jet printers.

Preference is given to printing processes in which aqueous printing inks are used.

Examples for coatings according to d3) are metals, half-metals or metal oxides, for example deposited from the gas phase.

Examples for metals, half-metals and metal oxides to be deposited on the pre-treated substrate after the pre-treatment are the following: zinc, copper, nickel, gold, silver, platinum, palladium, chromium, molybdenum, aluminum, iron, titanium. Preferred are gold, silver, chromium, molybdenum, aluminum or copper, especially silver, aluminum and copper. Interesting further are the following half-metals and metal oxides: aluminum oxide, chromium oxide, iron oxide, copper oxide and silicon oxide.

Preferred are gold, Silver, chromium, molybdenum, aluminum or copper.

The metals, half-metals or metal oxides are evaporated under vacuum conditions and deposited onto the substrate which is pretreated with the photoinitiator layer. This deposition may take place while irradiating with electromagnetic radiation. On the other hand, it is possible to carry out the irradiation after the deposition of the metal. The pot-temperatures for the deposition step depend on the metal which is used and preferably are for example in the range from 300 to 2000° C., in particular in the range from 800 to 1800° C.

The UV radiation during the deposition step can for example be produced by an anodic light arc, while for the UV radiation after the deposition the usual lamps as described above are also suitable.

Preferably, an irradiation with electromagnetic radiation is carried out in step d3), either during the deposition of the metal, half-metal or metal oxide or after the deposition.

The substrates coated with the metals are for example suitable as diffusion inhibiting layers, as printing plates, for electromagnetic shields or they can be used as decorative elements, for decorative foils, or for films or foils used for packaging, for example, for food, cosmetics, pharmaceuticals etc.

The invention also includes the strongly adherent nanoparticles obtained by any process as described above, and the substrates treated with these particles in one of the processes described.

The examples which follow illustrate the invention in more detail, without restricting the scope to said examples only. Where alkyl radicals having more than three carbon atoms are referred to in the examples without any mention of specific isomers, the n-isomers are meant in each case. In the examples as well as in other parts of this specification, quantities of solutions and liquids are usually given by volume, all other amounts by weight, if not stated otherwise. Parts and percentages are, as in the remainder of this specification and in the claims, by weight, unless stated otherwise. Room temperature denotes a temperature in the range 20-25° C. Abbreviations:

| | |
|---|---|
| EtOH | ethanol; |
| meq | mili-equivalents; |
| MPEG | methyl-polyethyleneglycol; |
| PDMS | polydimethylsiloxane; |
| DLS | Dynamic light scattering; |
| BOPP | biaxially oriented polypropylene; |
| HEPES | N-2-hydroxyethylpiperazine-N′-2-ethanesulfonic acid. |

### Example 1

### Modified Silica Nanoparticles with Allylether and MPEG(3) Groups

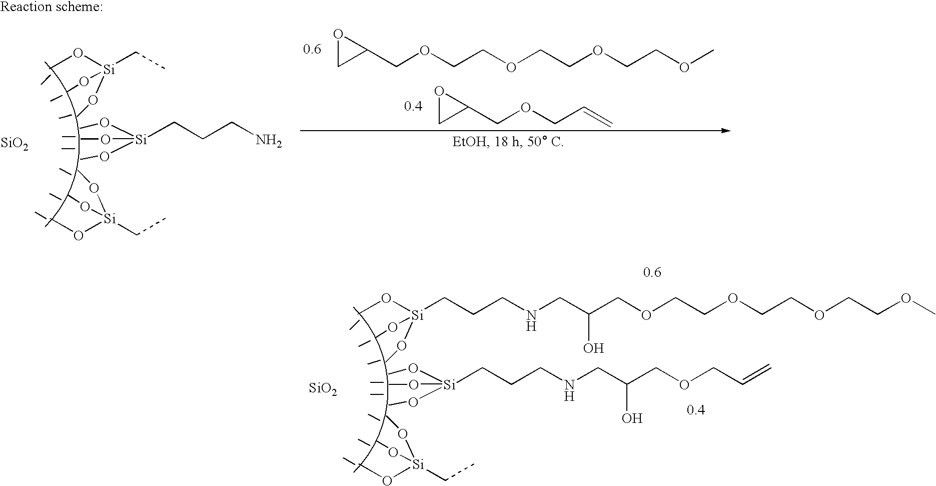

50 g of an aminopropyl modified silica nanoparticle dispersion 27.1 wt. % in EtOH (see Ex. 1 of WO 06/045713; solid content: 13.55 g; nitrogen content: 64.6 mmol) is mixed with 9.08 g (38.8 mmol) of glycidyl-triethyleneglycol-monomethylether [made from triethyleneglycol monomethylether (Fluka purum) with 5× excess of epichlorohydrine (Fluka purum) in 50% NaOH and azeotropic distillation of H2O/epichlorohydrine at 50° C., 3 h, p=95 mbar; epoxy-content: 4.27 meq/g] and 2.94 g (25.8 mmol) allyl-glycidylether (Fluke, purum) and stirred at 50° C. for 18 h. The solvent (EtOH) is evaporated in the rotary evaporator to obtain 24.51 g of a colorless liquid, which is re-dispersed in isopropanol to obtain a 25.0 wt. % dispersion.

### Analytics:

¹H-NMR confirms the structure and shows a ratio of MPEG/allylether of 60/40.

Thermogravimetric analysis (TGA; heating rate: 10° C./min from 50° C. to 800° C.): Weight loss: 63.5% corresponding well to the calculated organic material (61.9%).

Dynamic light scattering (DLS): Average diameter d=75.3 nm.

### Example 2

### Modified Silica Nanoparticles with “Zwitterionic” (=Betaine) Groups

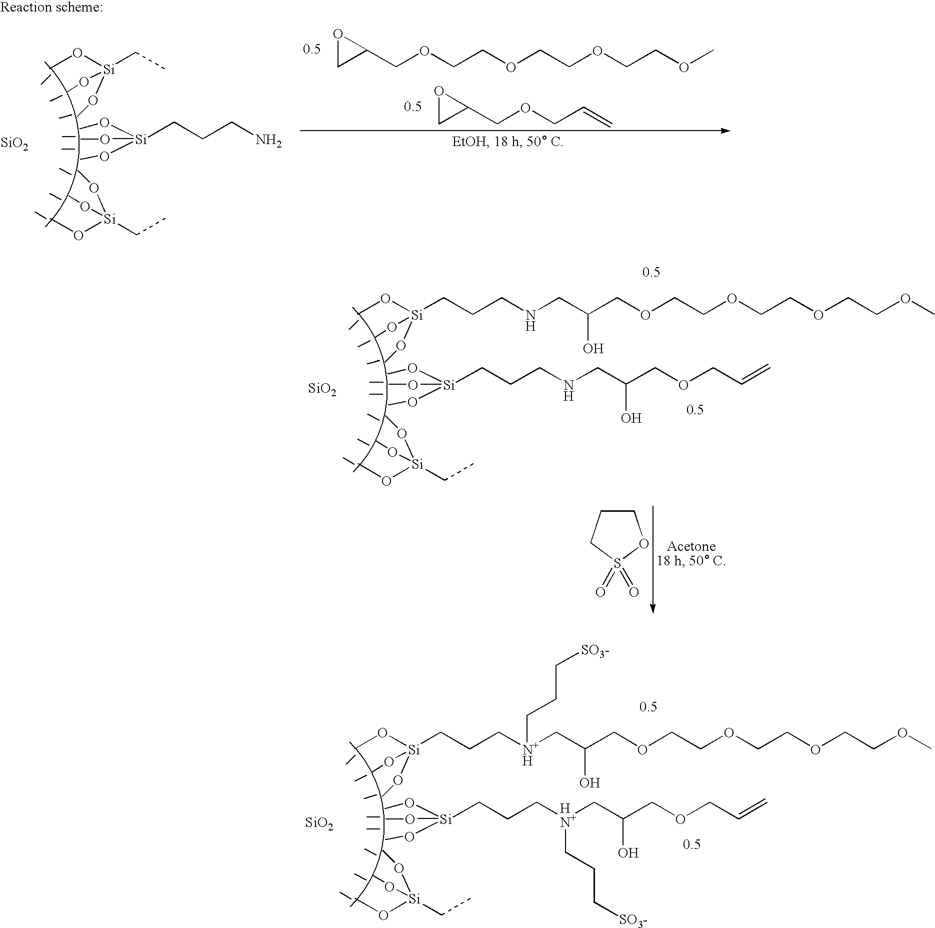

50 g of an aminopropyl modified silica nanoparticle dispersion 27.1 wt. % in EtOH (see Ex. 1 in WO 06/045713; solid content: 13.55 g; nitrogen content: 64.6 mmol) is mixed with 7.56 g (32.3 mmol) glycidyl-triethyleneglycol-monomethylether (see Ex. 1) and 3.68 g (32.3 mmol) allyl-glycidylether (Fluke, purum) and stirred at 50° C. for 18 h. The solvent (EtOH) is evaporated in the rotary evaporator and the residue dispersed in 150 ml acetone. 7.89 g (64.6 mmol) 1,3-propanesulfone (Fluke purum) is added and the mixture stirred for 18 h at 50° C., whereby a brownish precipitate is formed. After evaporation of all solvent in the rotavap, 32.6 g of a brown resin is obtained, which is re-dispersed in water/isopropanol (80/20 v/v) to obtain a 25.0 wt. % dispersion.

### Analytics:

¹H-NMR confirms the structure and shows a ratio of MPEG/allylether of 50/50.

Thermogravimetric analysis (TGA; heating rate: 10° C./min from 50° C. to 800° C.): Weight loss: 72% corresponding well to the calculated organic material (69%).

Dynamic light scattering (DLS): Average diameter d=88.9 nm.

### Example 3

### Modified Silica Nanoparticles with Allylether and Trimethyl-Ammonium Chloride Groups

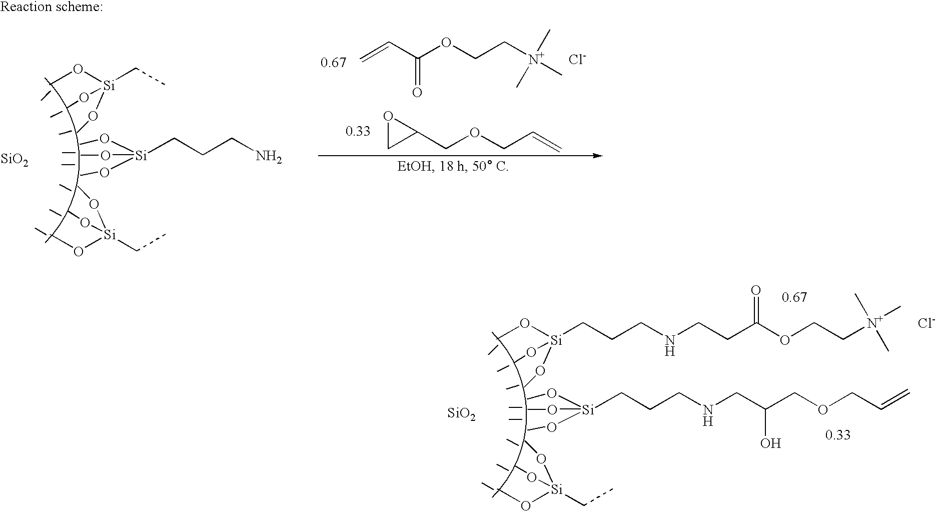

50 g of an aminopropyl modified silica nanoparticle dispersion 27.1 wt. % in EtOH (see Ex. 1 in WO 06/045713; solid content: 13.55 g; nitrogen content: 64.6 mmol) is mixed with 10.38 g of a aqueous solution (80%; dry weight: 8.31 g=43.07 mmol) of an ammoniumethyl acrylate (Ageflex® FA1Q80MC, Ciba Specialty Chemicals), diluted with 20 ml EtOH and stirred at 50° C. for 18 h. 2.45 g (21.53 mmol) allyl-glycidylether (Fluke, purum) is added and stirring at 50° C. continued for another 8 h. The solvent (EtOH) is evaporated in the rotary evaporator and the residue dried in vacuo at 80° C. 23.38 g of a white solid is obtained which is re-dispersed in water/isopropanol (80/20 v/v) to obtain a 25.0 wt. % dispersion.

### Analytics:

Thermogravimetric analysis (TGA; heating rate: 10° C./min from 50° C. to 800° C.): Weight loss: 62% corresponding well to the calculated organic material (59%).

Dynamic light scattering (DLS): Average diameter d=92 nm.

### Example 4

### Modified Silica Nanoparticles with Allylether and Sodium Carboxylate Groups

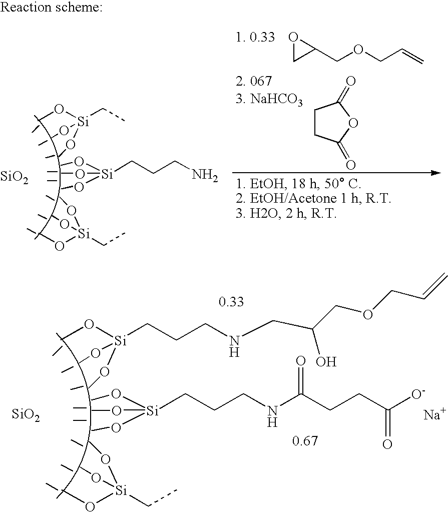

50 g of an aminopropyl modified silica nanoparticle dispersion 27.1 wt. % in EtOH (see Ex. 1 in WO 06/045713; solid content: 13.55 g; nitrogen content: 64.6 mmol) is mixed with 2.45 g (21.52 mmol) allyl-glycidylether (Fluke, purum) and stirred at 50° C. for 18 h. A solution of 4.30 g (43.06 mmol) succinic anhydride in 100 ml acetone is prepared separately and rapidly added to above ethanolic dispersion while mixing it with an ultraturax: Formation of a sticky white product. The solvent (EtOH/acetone) is decanted and the residue dried in vacuo. A solution of 3.61 g (43.06 mmol) NaHCO3 (Fluka puriss) in 100 ml H2O/isopropanol (80/20) is added and the mixture homogenized with an ultraturrax. 120.6 g of a homogeneous dispersion with a solid content of 18% is obtained.

### Analytics:

¹H-NMR confirms the structure and shows a ratio of succinate/allylether of 67/33. Thermographimetric analysis of dried material (TGA; heating rate: 10° C./min from 50° C. to 800° C.): Weight loss: 39% (calculated organic material: 45%).

Dynamic light scattering (DLS): Average diameter d=44.4 nm.

### Example 5

### Modified Silica Nanoparticles with Allylether MPEG(3) and Photoinitiator Groups

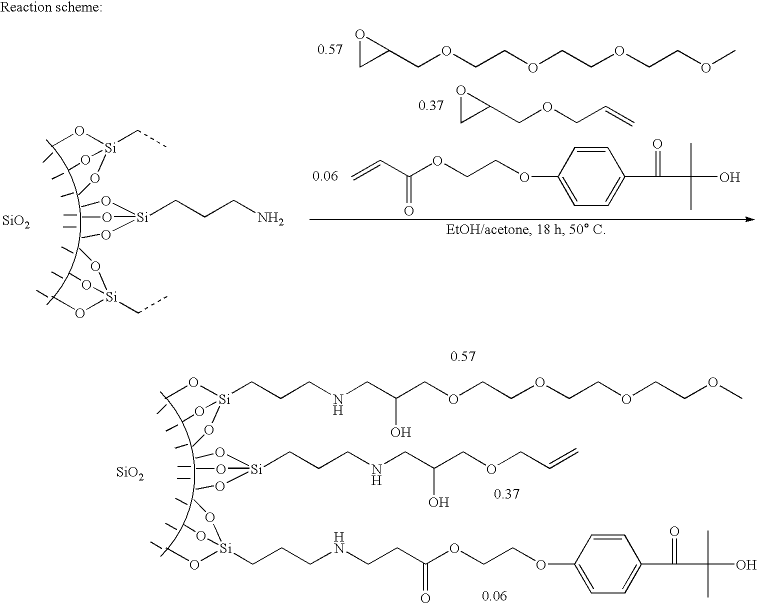

50 g of an aminopropyl modified silica nanoparticle dispersion 27.1 wt. % in EtOH (see Ex. 1 in WO 06/045713; solid content: 13.55 g; nitrogen content: 64.6 mmol) is mixed with 2.73 g (24 mmol) allyl-glycidylether (Fluke, purum) and 8.57 g (36.6 mmol) glycidyl-triethyleneglycol-monomethylether (made from triethyleneglycol monomethylether (Fluka purum) with 5× excess of epichlorohydrine (Fluka purum) in 50% NaOH and azeotropic distillation of H2O/epichlorohydrine at 50° C., 3 h, p=95 mbar); epoxy-content: 4.27 meq/g). A solution of 1.11 g (4.0 mmol) Irgacure® 2957 acrylate (Ciba Specialty Chemicals) in 20 ml acetone is added to the above dispersion and the mixture stirred at 50° C. for 18 h. The solvent (EtOH/acetone) is evaporated in the rotary evaporator to obtain and the residue dried at 80° C. in vacuo. 25.1 g of a slightly yellowish resin is obtained, which is re-dispersed in isopropanol to obtain a 25.0 wt. % dispersion.

### Analytics:

¹H-NMR confirms the structure and shows a ratio of MPEG/allylether/α-hydroxyacetone photoinitiator of 57/37/6.

Thermographimetric analysis (TGA; heating rate: 10° C./min from 50° C. to 800° C.): Weight loss: 63% corresponding well to the calculated organic material (61%).

Dynamic light scattering (DLS): Average diameter d=75.7 nm.

### Example 6

### Modified Silica Nanoparticles with Allylether, PDMS and Photoinitiator Groups

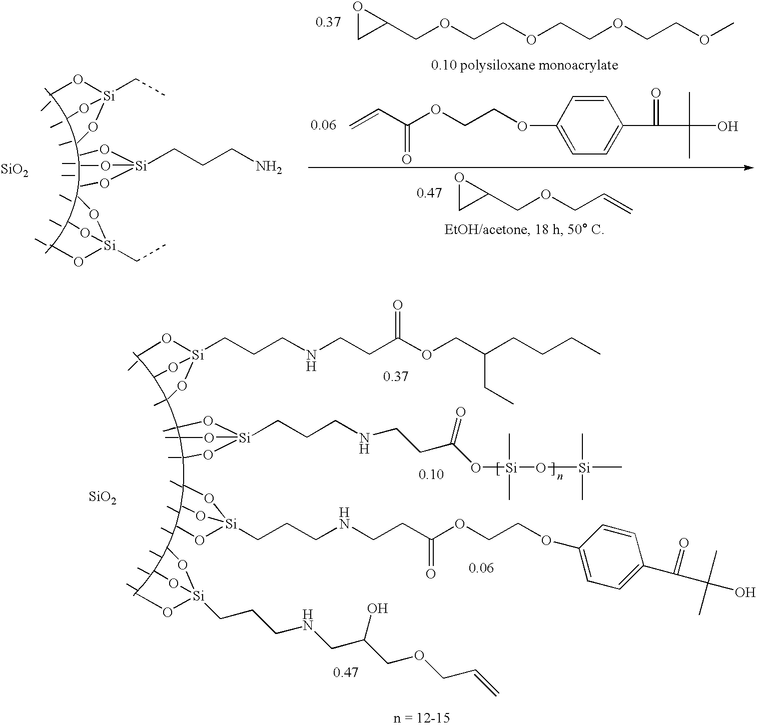

50 g of an aminopropyl modified silica nanoparticle dispersion 27.1 wt. % in EtOH (see Ex. 1 in WO 06/045713; solid content: 13.55 g; nitrogen content: 64.6 mmol) is mixed with 4.38 g (23.8 mmol) 2-ethylhexyl acrylate (Fluka purum), 7.11 g (6.46 mmol) of poly-dimethylsiloxane monoacrylate (number of Si(CH₃)₂O-units=12-15) and 1.11 g (4.0 mmol) of the acrylate of Irgacure® 2959 (photoinitiator ZLI 3331 from Ciba Specialty Chemicals) in 40 ml CH₂Cl₂ (Fluka puriss) and stirred for 90 min. at 50° C. 3.45 g (30.3 mmol) Allyl-glycidylether (Fluka purum) is added and the mixture stirred at 50° C. for 18 h. The solvent (EtOH/CH₂Cl₂) is evaporated in the rotary evaporator and the residue dried at 80° C. in vacuo to obtain 28.95 g of a slightly yellow resin, which is redispersed in toluene to obtain a 25.0 wt. % dispersion.

### Analytics:

¹H-NMR and IR confirm the structure and show the appropriate ratio of the 4 organic modifiers.

Thermogravimetric analysis (TGA; heating rate: 10° C./min from 50° C. to 800° C.): Weight loss: 60.9% (organic material calculated: 49.5%)

Dynamic light scattering in toluene (DLS): Average diameter d=92.6 nm.

### Example 7

### Modified Silica Nanoparticles with Allylether, PDMS and Branched Alkane Groups

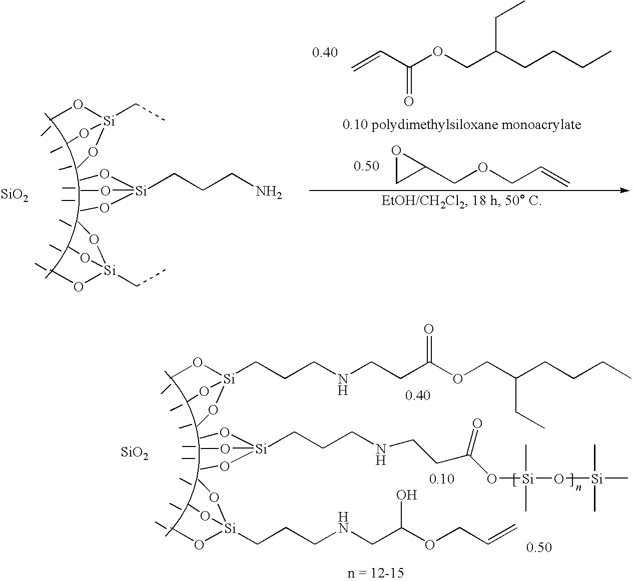

50 g of an aminopropyl modified silica nanoparticle dispersion 27.1 wt. % in EtOH (see Ex. 1 in WO 06/045713; solid content: 13.55 g; nitrogen content: 64.6 mmol) is mixed with 4.75 g (25.8 mmol) 2-ethylhexyl acrylate (Fluka purum) and 7.11 g (6.46 mmol) of poly-dimethylsiloxane monoacrylate (number of Si(CH₃)₂O-units=12-15) in 40 ml CH₂Cl₂ (Fluka puriss) and stirred for 90 min. at 50° C. 3.68 g (32.9 mmol) Allyl-glycidylether (Fluka purum) is added and the mixture stirred at 50° C. for 18 h. The solvent (EtOH/CH₂Cl₂) is evaporated in the rotary evaporator and the residue dried at 80° C. in vacuo to obtain 28.5 g of a transparent resin, which is re-dispersed in toluene to obtain a 25.0 wt. % dispersion.

Analytics: ¹H-NMR and IR confirm the structure and show the appropriate ratio of the 3 organic modifiers.

Thermogravimetric analysis (TGA; heating rate: 10° C./min from 50° C. to 800° C.): Weight loss: 58.7% (organic material calculated: 48.5%)

Dynamic light scattering in toluene (DLS): Average diameter d=86 nm.

### Example 8

### Modified Silica Nanoparticles with Allylether, PDMS and Branched Alkane Groups

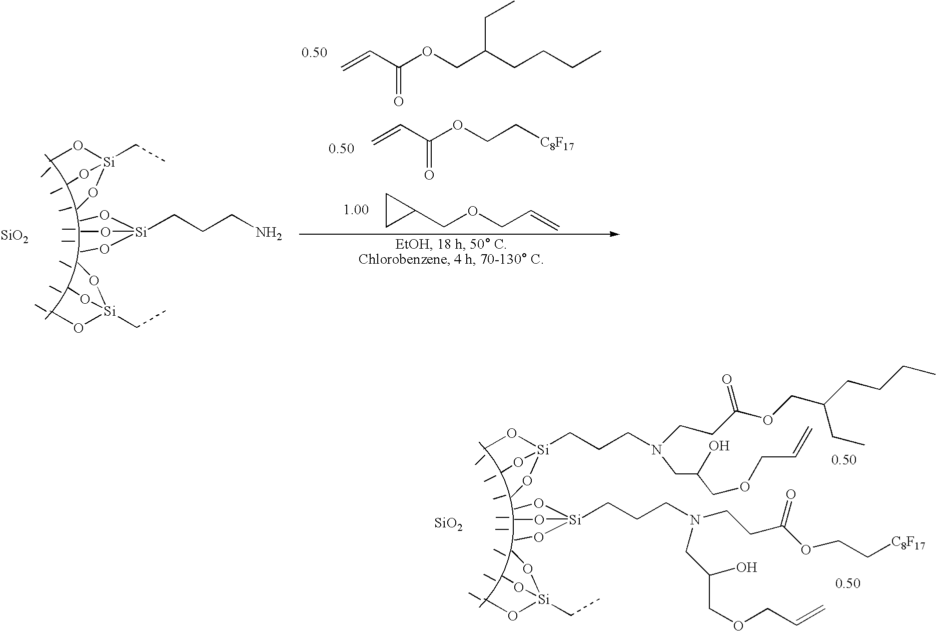

25 g of an aminopropyl modified silica nanoparticle dispersion 27.1 wt. % in EtOH (see Ex. 1 in WO 06/045713; solid content: 6.78 g; nitrogen content: 32.3 mmol) is mixed with 2.98 g (16.5 mmol) 2-ethylhexyl acrylate (Fluka purum) and stirred for 18 h at 50° C. The solvent (EtOH) is evaporated in the rotary evaporator, the residue dried in vacuo and then redispersed in 50 ml chlorobenzene (Fluka purum). 8.36 g (16.5 mmol) Fluoroacrylate (Zonyl-TA-N from DuPont) dissolved in 50 ml hot (70° C.) chlorobenzene is added and the mixture stirred for 12 h at 70° C. followed by 5 h at 130° C. The mixture is then cooled down to 70° C. and 3.68 g (32.3 mmol) allyl-glycidylether (Fluka purum) is added and the mixture stirred at 130° C. for another 4 h. The solvent (chlorobenzene) is evaporated in the rotary evaporator and the residue dried at 90° C. in vacuo to obtain 15.7 g of a transparent resin, which is re-dispersed in chloroform to obtain a 20.0 wt. % dispersion.

Analytics: ¹H-NMR and IR confirm the structure and show the appropriate ratio of the 3 organic modifiers.

Thermogravimetric analysis (TGA; heating rate: 10° C./min from 50° C. to 800° C.): Weight loss: 73.2% (organic material calculated: 77%)

Dynamic light scattering (DLS in CHCl₃): Average diameter d=186.5 nm.

### Example 9

### Preparation of Propyl Methacrylate Modified Silica Nanoparticles

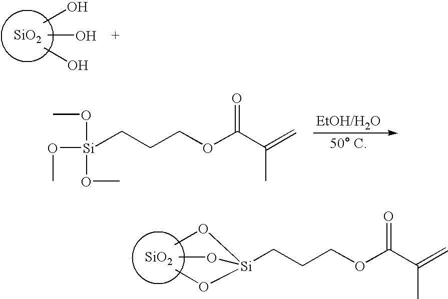

200 g of Ludox TMA® [available from Helm AG; 34% nanosilica dispersion in water] is mixed with 150 g of ethanol. To this mixture is added 114.6 g of 3-(trimethoxysilyl)propyl methacrylate at room temperature. The mixture is stirred at 50° C. for 22 hours. The amount of solvent is halved by evaporation in the rotary evaporator. By adding 100 ml of water the product precipitates and is separated by centrifugation. After re-dispersing the product in 2-propanol a dispersion with 10 wt. % solid content is obtained. Thermogravimetric analysis (TGA; heating rate: 10° C./min from 25° C. to 600° C.): Weight loss: 42%, corresponding to the organic material. DLS: Average diameter d=68 nm.

### Example 10

### Preparation of Photoinitiator/Propyl Methacrylate Modified Silica Nanoparticles

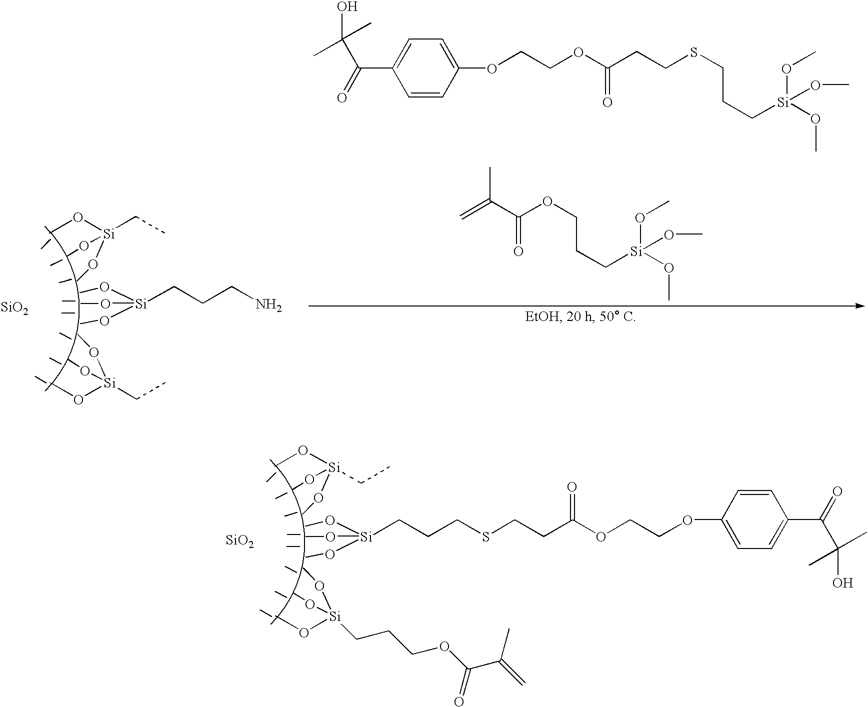

100 g of Ludox TMA® [available from Helm AG; 34% nanosilica dispersion in water] is mixed with 100 ml of ethanol. To this mixture is added 11.7 g (25.6 mmol) of a photoinitiator [see reaction scheme] and 12.7 g (51 mmol) of 3-(trimethoxysilyl)propyl methacrylate at room temperature. The mixture is stirred at 50° C. for 20 hours. The amount of solvent is halved by evaporation in the rotary evaporator. By adding 150 ml of cyclohexane the product precipitates and is separated by centrifugation. After re-dispersing the product in 2-propanol a dispersion with 18.6 wt. % solid content is obtained. The ratio of photoinitiator to methacrylic groups is calculated based on analytical data to be 1 to 1.54. Thermogravimetric analysis (TGA; heating rate: 10° C./min from 25° C. to 600° C.): Weight loss: 28.6%, corresponding to the organic material. Elemental analysis: found: C, 18.68%; H, 2.64%; O: 9.52%; S: 1.72: corresponding to an organic content of 32.6%. DLS: Average diameter d=54 nm.

### Example 11

### Reaction of Amine-Functionalized Silica Particles with Allyl Glycidyl Ether Followed by Acetylation

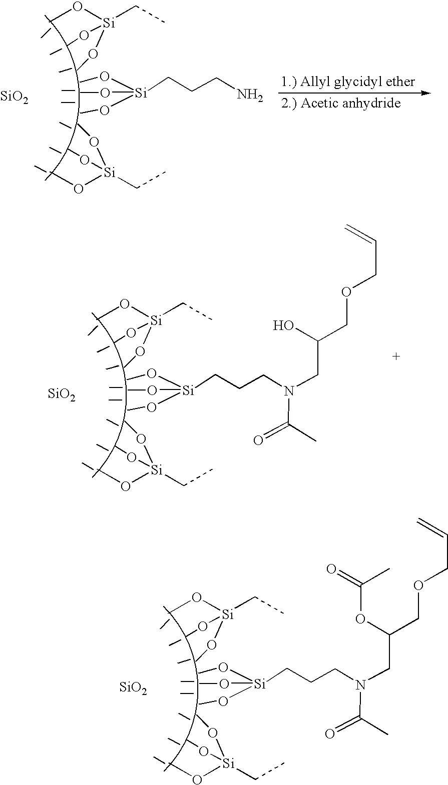

Allyl glycidyl ether (97%; 108 g, 0.92 mol) is slowly added at 55° C. to a dispersion of amine-functionalized silica particles in ethanol (prepared according to Example 1 of WO 06/045713; 25.9%, nitrogen content of particles 6.7%; 743 g, 0.92 mol) and the reaction mixture stirred over night (GLC control). The solvent is distilled off on a rotary evaporator and the residue dispersed in ethylacetate (920 ml). Acetic anhydride (99%; 189 g, 1.83 mol) is slowly added at 25° C. and the reaction mixture stirred over night. The solvent is distilled off on a rotary evaporator and the residue dried on an oil pump at 50° C. to afford 386 g of the title compound as a slightly yellowish, highly viscous oil. TGA analysis (25-1000° C./30° C.×min⁻¹, 1000° C./20 min) gives 63.3% weight loss, corresponding to a silica content of 36.7%. To the crude product redispersed in ethylacetate (200 g) is added tripropylene glycol diacrylate (TPGDA; 212 g). Ethylacetate is distilled off on a rotary evaporator to afford a transparent dispersion of the title compound in TPGDA with a silica content of 24.8% (by TGA).

### Examples 12-14

In analogy to the above examples and starting from silica particles Ludox TMA®, nanoparticles of the following table are obtained.

TABLE
Nanoparticles of examples 12-14

| | | | | | Size |
|---|---|---|---|---|---|
| No. | Reagent 1 | Reagent 2 | Ratio w/w | Solvent | (DLS/H₂O) |
| 12 | 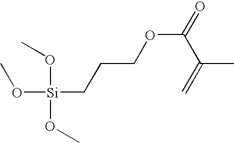 | 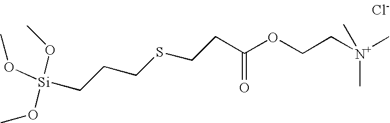 | 1:1 | EtOH/H₂O | 84 nm |
| 13 | 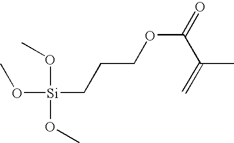 | 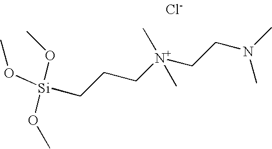 | 1:1 | EtOH/H₂O | 65.8 nm |
| 14 | 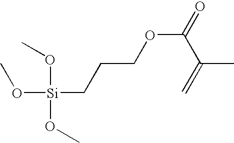 | 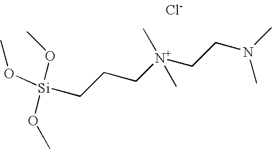 | 1: 5 | EtOH/H₂O | 50.5 nm |

### APPLICATION EXAMPLES

### Example A1

### Application of the Product Obtained According to Example 9 Diluted to a 2 Wt % Dispersion and Abrasion Test==>Strong Adhesion without any Photoinitiator

A BOPP film is treated with corona (ceramic electrode; 0.8 mm distance to substrate; corona discharge 1×500 W at a belt speed of 3 m/min).

A 2% dispersion of nanoparticles from example 9 in isopropanol is applied to the treated side of the films using a 4 μm wire bar.

The samples are stored for a short time until the isopropanol has evaporated and the samples are dry. After drying the samples are irradiated using a UV processor with a mercury lamp with an output of 120 W/cm at a belt speed of 50 m/min.

The abrasion test is carried out using a stamp of 3×3 cm with a weight of 1.2 kg covered with Kimtex® Plus Cloths (Kimberly Clark) which is moved over a specified area of the surface treated foil for 20 times.

Furthermore, the mechanical stability of the nanoparticle coating is tested using ultrasonic treatment in water/ethanol 1 to 1 mixture for 2 minutes.

The samples are analyzed using scanning electron microscopy with a magnification of 50000×, see FIG. 1.

### Example A2

In analogy to example A1, a BOPP foil is treated with nanoparticles from example 10 and analyzed the same way as in example A1; results are shown in FIG. 2.

In the same way, BOPP films treated with nanoparticles from examples 1-8, respectively, are obtained.

### Example A3

### Strong Adhesion of a Blue Printing Ink on a PE Film Treated According to Example A1

A 2% nanoparticle dispersion (according to example 9) is applied according to example A1 on a PE film (manufacturer: Renolit). Afterwards, a radiation-curable flexo cyan ink (Gemini flexo cyan, UFG 50080-408, provided by Akzo) is applied on the pretreated plastic film substrates in a thickness of 1.5 μm with a printing machine (“Prüfbau Probedruckmaschine”).

The printed samples are cured in a UV processor with a mercury lamp and an output of 120 W/cm at a belt speed of 50 m/min.

The adhesive strength of the ink on the treated substrate is determined by the tape test: A Tesa EU tape is applied on the cured ink surface. After one minute the tape is removed. The result of the adhesion is determined in a ranking between 0 and 5. A value “0” indicates that 0% of the ink is removed, while a value “5” indicates 100%, i.e. the complete, remove of the ink. In the case of untreated samples [i.e. only steps a) and d) are performed] the ink is torn off completely (5).

This experiment is repeated three times. With the ink applied on a PE film treated with nanoparticles according to the invention, and in all three cases, a very strong adhesion of the ink on the nanoparticle modified PE film is observed with the tape test: (0/0/0).

### Example A4

### Strong Adhesion of a Blue Printing Ink on a BOPP Film Prepared According to Example A3

To the BOPP film treated with corona discharge and the nanoparticle dispersion according to example A3, the blue flexo ink (cyan) is applied as described in example A3. The experiment is repeated three times. In all three cases, very strong adhesion of the ink on the modified BOPP film is observed with the tape test: (0/0/0).

### Example A5

### Strong Adhesion of a Blue Printing Ink on a PE Film Treated According to Example A2

Example A3 is repeated using a 2% nanoparticle dispersion (according to example 10) and a blue flexo ink (cyan). The experiment is repeated three times. In all three cases, very strong adhesion of the ink on the nanoparticle modified PE film is observed with the tape test: (0/0/0).

### Example A6

### Strong Adhesion of a Blue Printing Ink on a BOPP Film Treated According to Example A2

Example A2 is repeated using a 2% nanoparticle dispersion (according to example 10) and a blue flexo ink (cyan as used in example A3). The experiment is repeated three times. In all three cases, very strong adhesion of the ink on the nanoparticle modified BOPP film is observed with the tape test: (0/1/0).

### Example A7

### Strong Adhesion of a White Printing Ink on a PE Film Treated According to Example A1

A 2% nanoparticle dispersion (according to example 9) is applied according to a PE film as described in example A3. Afterwards, a radiation-curable screen white ink (Screen Ink White 985-UV-1125, provided by Ruco) is applied on the nanoparticle pretreated PE film substrate in a thickness of 8 μm with a screen. The printed samples are cured in a UV processor with a mercury lamp and an output of 120 W/cm at a belt speed of 50 m/min from both sides.

The adhesive strength of the ink on the treated substrate is determined by the tape test as described in example A3. The experiment is done three times.

With the ink applied on a PE film treated with nanoparticles according to the invention, in all three cases a very strong adhesion of the ink on the nanoparticle modified PE film is observed with the tape test: (0/0/0).

### Example A8

### Strong Adhesion of a White Printing Ink on a BOPP Film Treated According to Example A1

Example A4 is repeated, except that a white screen ink according to example A7 is applied. Very strong adhesion of the ink on each of the 3 the nanoparticle modified BOPP film samples is observed in the tape test: (0/0/0).

### Example A9

Example A2 is repeated using nanoparticles from example 4, 5 or 7, respectively, each as a 5% dispersion obtaining corresponding BOPP film samples, and a corresponding BOPP film sample is obtained using the nanoparticles from example 5 as a 10% dispersion.

### Example A10

### Testing the Adhesion of Bacterial Cells on the Treated BOPP Films

One side of the treated BOPP films obtained in example A9 is attached to a glass slide by a sticky tape. A polymeric gasket is placed upon the other side of the treated BOPP film. 100 μl HEPES buffer (150 mM, pH=7.4) and then 400 μl of a solution containing ca. 10⁹ cells/mL of Escherichia coli K12 are added to the gasket. After an incubation at 37° C. for 20 min, the bacterial cells not adhered to the treated BOPP film are washed away with HEPES buffer (10×300 μL). The BOPP films are imaged and the number of bacterial cells adhered to the surface of the treated BOPP films is counted.

The same procedure is also repeated with untreated BOPP film (comparative example 1) and BOPP film corona pre-treated using one ceramic electrode at a distance of 0.8 mm to the BOPP film and a corona discharge of 1×600 W at a belt speed of 3 m/min (comparative example 2). The number of bacterial cells adhered to the untreated BOPP film corresponds to an adhesion of bacterial cells of 100%. The results are summarized in the following table:

| | | Cell |
|---|---|---|
| Particles | Film Treatment | Adhesion [%] |
| none | none | 100 |
| none | corona | 46 |
| example 7 | corona, 5% dispersion | 2 |
| example 5 | corona, 5% dispersion | 2 |
| example 5 | corona, 10% dispersion | 6 |
| example 4 | corona, 5% dispersion | <1 |

Surfaces modified with the present nanoparticles show low adhesion of bacteria.

### BRIEF DESCRIPTION OF FIGURES

FIG. 1 shows SEM pictures of particles made according to example 9 applied on BOPP film (example A1). Starting from left: before washing, after ultrasound treatment in water/ethanol=1/1, after abrasion tests carried out with 1.2 kg pressure on 3×3 cm square covered with Kimtex® Plus Cloths (Kimberly Clark) for 20 times.

FIG. 2 shows SEM pictures of particles applied to a BOPP film (example A2) made according to the procedure of example A1. Starting from left: before washing, after ultrasound treatment in water/ethanol=1/1, after abrasion tests carried out with 1.2 kg pressure on 3×3 cm square covered with Kimtex® Plus Cloths (Kimberly Clark) for 20 times.

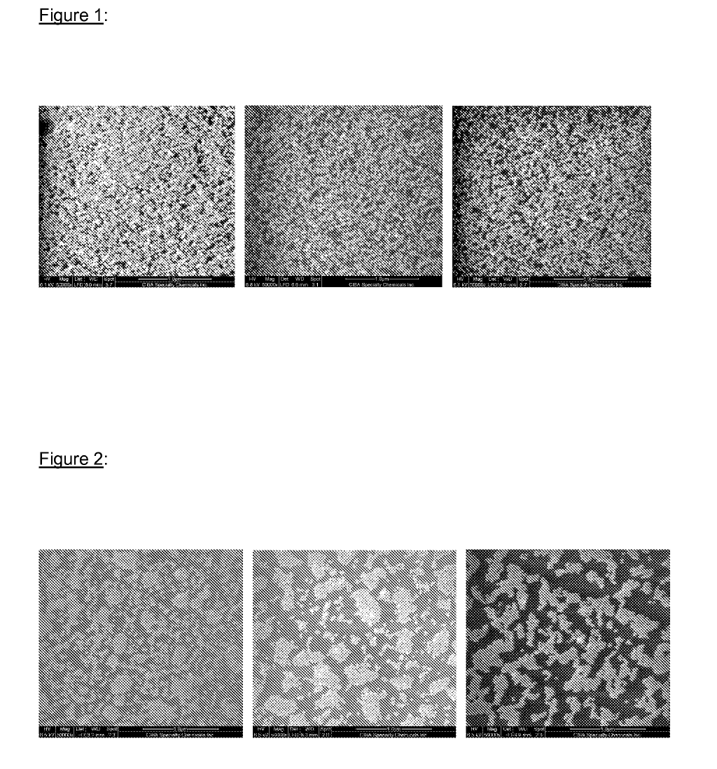

1. A process for modifying the surface of an inorganic or organic substrate with strongly adherent nanoparticles, wherein the surface of the inorganic or organic substrate is
a) subjected to plasma, corona discharge, ozonization, high energy radiation or flame treatment, followed by
b) application to the surface of nanoparticles containing at least one polymerizable group chemically bonded to their surface, or mixtures of said nanoparticles with monomers or/and oligomers, or a solution, suspension or emulsion containing said nanoparticles, without addition of a photoinitiator, and
c) the surface thus pretreated is radiation dried using suitable methods.

2. (canceled)

3. A process according to claim 1 for modifying the surface of an inorganic or organic substrate with strongly adherent nanoparticles, wherein the inorganic or organic substrate is subjected to the following steps
a) a low-temperature plasma treatment, a corona discharge treatment, an ozonization, an ultra-violet irradiation and/or a flame treatment is carried out on the surface,
b) application of nanoparticles containing at least one ethylenically unsaturated group chemically bonded, or mixtures of said nanoparticles with monomers or/and oligomers, or a solution, suspension or emulsion containing said nanoparticles, without addition of a photoinitiator, to the surface, and
c) drying with light from the range 200-700 nm.

4. Process of claim 3, wherein step b is carried out directly after step a, and/or step c is carried out directly after step b.

5. Process according to claim 1, wherein the nanoparticles applied in step b) comprise a nanoparticle of the formula I, 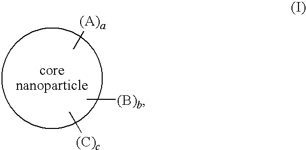
wherein the core nanoparticle contains an inorganic or organic material,
a is a number from 1 to nₐ;
b is a number from 0 to n_{b};
c is a number from 0 to n_{c};
A and, if present, B and/or C are organic substituents bound to the core nanoparticle;
A is the organic substituent containing at least one reactive polymerizable group;
B is an organic substituent containing at least one photoinitiator moiety;
C is an organic substituent containing at least one functional group;
where the sum of nₐ+n_{b}+n_{c} is a number from 1 up to n_{I}, where n_{I} is limited by the geometry and surface area of the core nanoparticle and the steric requirements of the respective substituents A, B, C.

6. (canceled)

7. A process according to claim 1, wherein
d) a further coating is applied and optionally dried or cured, which further coating is
d1) a solvent or waterborne composition curable with UV/VIS radiation or electron beam comprising at least one ethylenically unsaturated monomer or oligomer;
d2) a solvent or waterborne customary drying coating, or
d3) a metal layer.

8. A process according to claim 5, wherein the core nanoparticle comprises on its surface oxygen compounds of the elements Si, Al, In, Ga, Ti, Zn, Sn, Zr, Fe, Sb; oxygen compounds of one of the elements Si, Al, In, Ga, Ti, Zn, Sn, Zr, Fe, Sb doped with another of these elements and/or with phosphorus and/or fluorine; inert metals; or synthetic organic polymer materials.

9. A process according to claim 8, wherein
A is 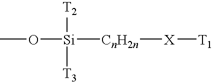
or —Y-T₁;
B is 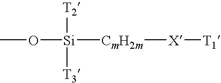
or —Y′-T₁′; and
C is 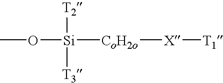
or —Y″-T₁″, where
n, m or o are independently of each other numbers from 0 to 8 and
if n is 0, then X is a single bond;
if m is 0, then X′ is a single bond;
if o is 0, then X″ is a single bond;
X, X′ and X″ are independently of one another —O—, —S—, —NR₁—, —OCO—, —SCO—, —NR₁CO—, —OCOO—, —OCONR₁—, —NR₁COO—, —NR₁CONR₂—, or a single bond;
Y, Y′ and Y″ are independently of one another —O—, —S—, —NR₁—, —OCO—, —SCO—, —NR₁CO—, —OCOO—, —OCONR₁—, —NR₁COO—, —NR₁CONR₂—, —COO—, —CONR₁—, —CO— or a single bond;
R₁ and R₂ are independently of one another hydrogen, C₁-C₂₅ alkyl, C₃-C₂₅ alkyl which is interrupted by oxygen or sulfur, C₆-C₁₂ aryl or R;
T₁ has the meaning of R and contains at least one reactive group L;
T₁′ has the meaning of R and contains at least one photoinitiator moiety G;
T₁″ has the meaning of R and contains at least one moiety Z;
T2, T2′, T2″, T3, T3′, T3″ are independently of one another hydrogen, C₁-C₂₅alkyl, C₃-C₂₅alkyl which is interrupted by oxygen or sulphur, C₂-C₂₄alkenyl, phenyl, C₇-C₉phenylalkyl, —OR₃, 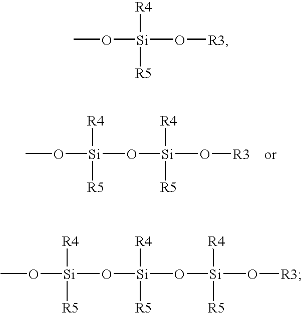
R₃ is hydrogen, C₁-C₂₅alkyl, C₃-C₂₅alkyl which is interrupted by oxygen or sulphur, C₂-C₂₄alkenyl, phenyl, C₇-C₉phenylalkyl, 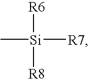
or the nanoparticle surface;
R₄ and R₅ independently of each other are hydrogen, C₁-C₂₅alkyl, C₃-C₂₅alkyl which is interrupted by oxygen or sulphur, C₂-C₂₄alkenyl, phenyl, C₇-C₉phenylalkyl or —OR₃;
R₆, R₇ and R₈ independently of each other are hydrogen, C₁-C₂₅alkyl, C₃-C₂₅alkyl which is interrupted by oxygen or sulphur, C₂-C₂₄alkenyl, phenyl or C₇-C₉phenylalkyl;
R is C₁-C₂₀alkyl, C₅-C₁₂cycloalkyl, C₂-C₂₀alkenyl, C₅-C₁₂cycloalkenyl, C₂-C₂₀alkinyl, C₆-C₁₄aryl, C₁-C₂₀alkyl substituted by one or more D, C₂-C₂₀alkyl interrupted by one or more E, C₂-C₂₀alkyl substituted by one or more D and interrupted by one or more E, C₅-C₁₂cycloalkyl substituted by one or more D, C₂-C₁₂cycloalkyl interrupted by one or more E, C₂-C₁₂cycloalkyl substituted by one or more D and interrupted by one or more E, C₂-C₂₀alkenyl substituted by one or more D, C₃-C₂₀alkenyl interrupted by one or more E, C₃-C₂₀alkenyl substituted by one or more D and interrupted by one or more E, C₅-C₁₂cycloalkenyl substituted by one or more D, C₃-C₁₂cycloalkenyl interrupted by one or more E, C₃-C₁₂cycloalkenyl substituted by one or more D and interrupted by one or more E, or C₆-C₁₄aryl substituted by one or more D or, provided that X, X′, X″, Y, Y′ or Y″ has the meaning of a single bond, R can be L, G, Z, halogen, CN, NO₂ or NCO;
D is L, G, Z, R₉, OR₉, SR₉, NR₉R₁₀, halogen, NO₂, CN, O-glycidyl, O-vinyl, O-allyl, COR₉, NR₉COR₁₀, COOR₉, OCOR₉, CONR₉R₁₀, OCOOR₉, OCONR₉R₁₀, NR₉COOR₁₀, SO₃H, COOM_{C}, COO⁻, SO₃⁻ or SO₃M_{C}, phenyl, C₇-C₉alkylphenyl;
E is O, S, COO, OCO, CO, NR₉, NCOR₉, NR₉CO, CONR₉, OCOO, OCONR₉, NR₉COO, SO₂, SO, 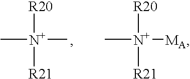
CR₉═CR₁₀, 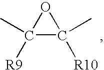
C≡C, N═C—R₉, R₉C═N, C₅-C₁₂cycloalkylene, phenylene or phenylene substituted by D;
L is 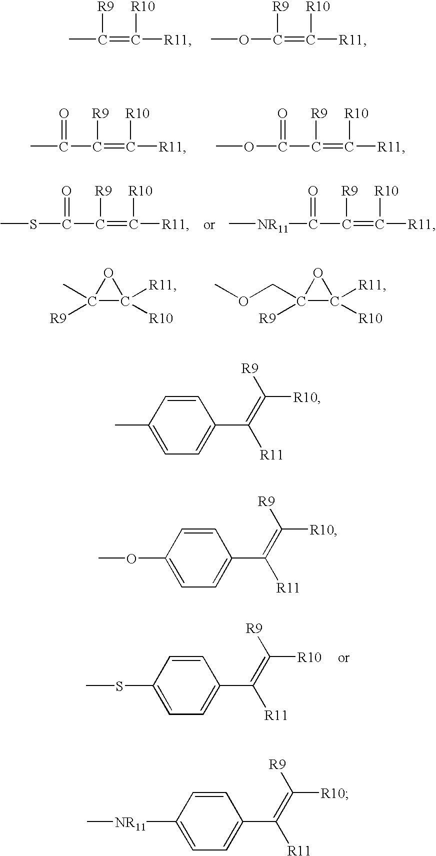
R₉, R₁₀ or R₁₁ independently of one another are hydrogen, C₁-C₁₂alkyl or phenyl;
G is a 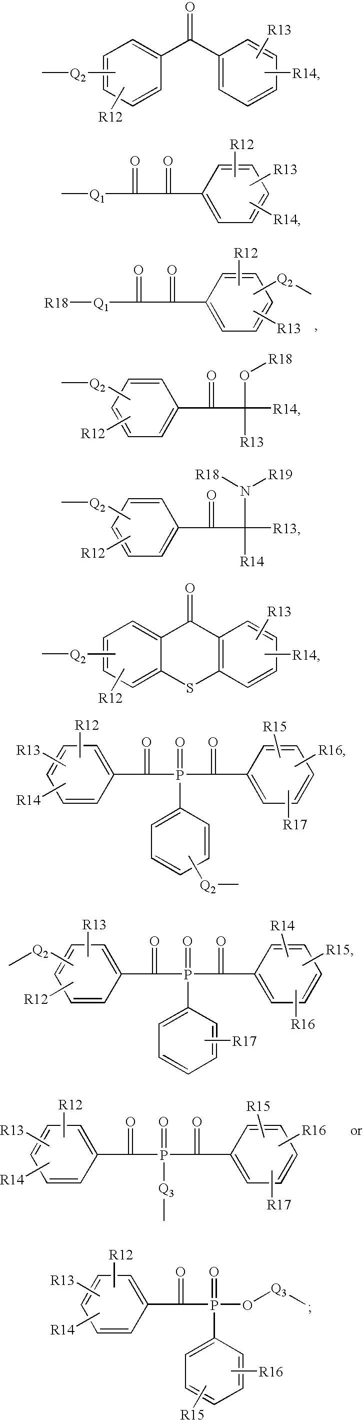
Q₁ is O, S or NR₉;
Q₂ is O, S, NR₉, COO, OCO, CONR₉, NR₉CO, CO, single bond or C₁-C₆ alkylene;
Q₃ is single bond or C₁-C₆ alkylene;
R₁₂, R₁₃, R₁₄, R₁₅, R₁₆ or R₁₇ are each independently of one another Q₄-R_{G} or R_{G}, where two neighbouring substituents selected from R₁₂ to R₁₇ can optionally form a ring;
R₁₈ or R₁₉ are each independently of one another R_{G}, where R₁₈ and R₁₉ can optionally form a ring;
Q₄ is O, S, COO, OCO, CO, NR₉, NCOR₉, NR₉CO, CONR₉, OCOO, OCONR₉, NR₉COO, SO₂, SO or CR₉═CR₁₀;
R_{G} is hydrogen, C₁-C₂₀alkyl, C₆-C₁₂cycloalkyl, C₂-C₂₀alkenyl, C₅-C₁₂cycloalkenyl, C₂-C₂₀alkinyl, C₆-C₁₄aryl, C₁-C₂₀alkyl substituted by one or more D, C₂-C₂₀alkyl interrupted by one or more E, C₂-C₂₀alkyl substituted by one or more D and interrupted by one or more E, C₅-C₁₂cycloalkyl substituted by one or more D, C₂-C₁₂cycloalkyl interrupted by one or more E, C₂-C₁₂cycloalkyl substituted by one or more D and interrupted by one or more E, C₂-C₂₀alkenyl substituted by one or more D, C₃-C₂₀alkenyl interrupted by one or more E, C₃-C₂₀alkenyl substituted by one or more D and interrupted by one or more E, C₆-C₁₂cycloalkenyl substituted by one or more D, C₃-C₁₂cycloalkenyl interrupted by one or more E, C₃-C₁₂cycloalkenyl substituted by one or more D and interrupted by one or more E, or C₆-C₁₄aryl substituted by one or more D;
Z is halogen, C₁-C₅₀alkyl, C₁-C₂₅₀alkyl which is interrupted by one or more oxygen, C₁-C₅₀alkyl which is interrupted by one or more oxygen and substituted by one or more hydroxyl, -Q₂-C₆-C₁₈ aryl, -Q₂-(CF₂)_{f}—CF₃, 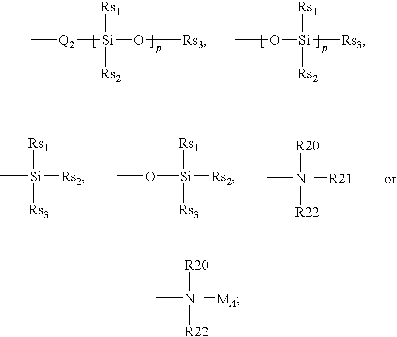
Rₛ₁, Rₛ₂ or Rₛ₃ are independently of one another hydrogen, C₁-C₂₅alkyl, C₁-C₂₅alkyl which is interrupted with oxygen or sulphur, phenyl, C₇-C₉phenylalkyl, —CH₂—CH═CH₂, 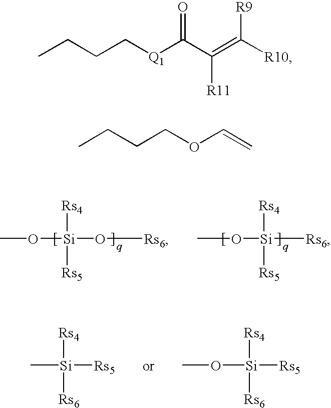
Rₛ₄, Rₛ₅ or Rₛ₆ are independently of one another hydrogen, C₁-C₂₅alkyl, C₁-C₂₅alkyl which is interrupted with oxygen or sulphur, phenyl, C₇-C₉phenylalkyl, —CH₂—CH═CH₂, 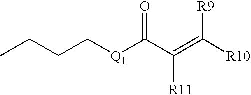
or 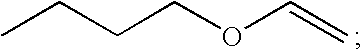
R₂₀, R₂₁ or R₂₂ are independently of one another R_{G};
R₁₀₁ is C₁-C₂₄acyl;
f is a number from 0 to 100;
p is a number from 0 to 100;
q is a number from 0 to 100;
M_{C} is an inorganic or organic cation;
M_{A} is an inorganic or organic anion.

10. A process according to claim 5, wherein the nanoparticles of formula (I) or mixtures thereof with monomers or oligomers in step b) are used in the absence of of additional monomers.

11. A process according to claim 1, wherein the nanoparticles or mixtures thereof with monomers or oligomers in step b) are used in combination with one or more additional components selected from surfactants, anti foaming agents, biocides and solvents.

12. A process according to claim 1, where the substrate is contacted with an inert gas or a mixture of inert gas with reactive gas in step a).

13. A process according to claim 1, wherein the nanoparticles are applied as a layer with a thickness of up to 50 microns.

14. A process according to claim 13, wherein the nanoparticle layer after carrying out the drying step c) has a layer thickness of up to 10 microns.

15. A process according to claim 1, wherein the concentration of the nanoparticles is from 0.0001 to 10%, by weight of the total formulation applied to the substrate.

16. A process according to claim 1, wherein the portion of nanoparticles, or mixtures containing them, which have not been crosslinked after irradiation in the drying step c), are removed by subsequent treatment with an organic solvent and/or water and/or mechanically.

17. A process according to claim 7, wherein after partial irradiation in process step d1), unreacted portions of the further coating are removed by treatment with an organic solvent and/or water and/or mechanically.

18. A process according to claim 9, wherein
X, X′ and X″ are independently of one another —O—, —S—, —NR₁—, —OCO—, —NR₁CO— or a single bond;
n, m or o are independently of each other numbers from 0 to 6;
R is C₁-C₂₀alkyl, phenyl, C₁-C₂₀alkyl substituted by one or more D, C₂-C₂₀alkyl interrupted by one or more E, C₂-C₂₀alkyl substituted by one or more D and interrupted by one or more E or phenyl substituted by one or more D or, provided that X, X′ or X″ has the meaning of a single bond, R can be L, G or Z;
R₁ and R₂ are independently of one another hydrogen, C₁-C₁₂ alkyl, C₃-C₂₅ alkyl which is interrupted by oxygen, phenyl or R;
R₁₀₁ is C₁-C₁₂acyl;
T2, T2′, T2″, T3, T3′, T3″ are independently of one another hydrogen, C₁-C₁₂alkyl, phenyl, —OR₃, 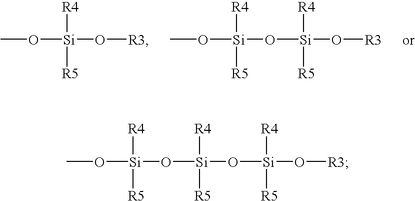
R₃ is hydrogen, C₁-C₁₂alkyl, phenyl, 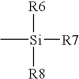
or nanoparticle surface;
R₄ and R₅ independently of each other are hydrogen, C₁-C₁₂alkyl, phenyl or —OR₃;
R₆, R₇ and R₈ independently of each other are hydrogen, C₁-C₁₂alkyl or phenyl;
D is L, G, Z, R₉, OR₉, SR₉, NR₉R₁₀, COR₉, COOR₉, OCOR₉, CONR₉R₁₀, SO₃H, COO⁻, SO₃⁻, COOM_{C} or SO₃M_{C}, phenyl;
E is O, S, COO, OCO, NR₉, 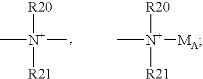
L is 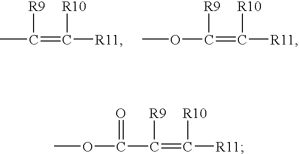
G is a 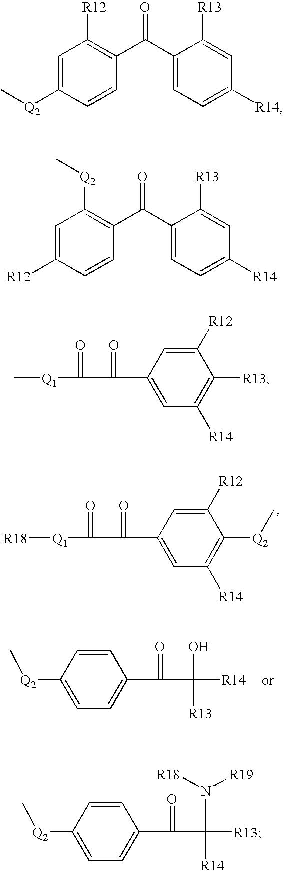
Z is halogen, C₁-C₅₀alkyl, C₁-C₂₅₀alkyl which is interrupted by one or more oxygen, C₁-C₅₀alkyl which is interrupted by one or more oxygen and substituted by one or more hydroxyl, -Q₂-(CF₂)_{f}—CF₃, 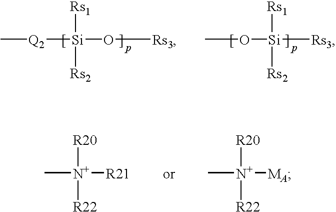
Rₛ₁, Rₛ₂ or Rₛ₃ are independently of one another hydrogen, C₁-C₁₂alkyl, phenyl, —CH₂—CH═CH₂, 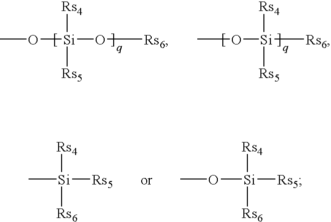
Rₛ₄, Rₛ₆ or Rₛ₆ are independently of one another hydrogen, C₁-C₁₂alkyl, phenyl, —CH₂—CH═CH₂, 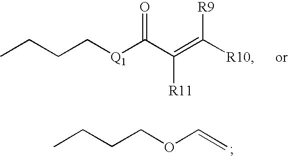
R₉, R₁₀ or R₁₁ independently of one another are hydrogen or C₁-C₁₂alkyl;
R₁₂, R₁₃, R₁₄, R₁₅, R₁₆ or R₁₇ are each independently of one another hydrogen, C₁-C₁₂alkyl, C₁-C₁₂alkoxy or phenyl where two neighbouring substituents R₁₃ and R₁₄ can optionally form a ring;
R₁₈ or R₁₉ are each independently of one another hydrogen, C₁-C₁₂alkyl or phenyl, where R₁₈ and R₁₉ can optionally form a ring;
R₂₀, R₂₁ or R₂₂ are independently of one another hydrogen, C₁-C₁₂alkyl, C₁-C₁₂alkyl interrupted with O, S or NR₉, C₁-C₁₂alkyl substituted with one or more COOM_{C}, SO₃M_{C}, COO⁻, SO₃⁻, or which are phenyl or benzyl.

19. A process according to claim 3, where the irradiation is done with light of a wavelength from the range 200-400 nm.

20. Nanoparticle of the formula I according to claim 9, 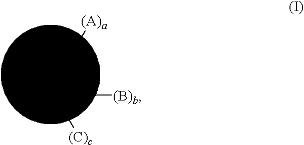
wherein the core nanoparticle contains an inorganic or organic material consisting essentially of silicon oxide, silica gel, aluminum oxide, titanium oxide, silicon oxide-coated TiO₂, zinc oxide, tin oxide, zirconium oxide, Ag, Au, Cu, Sb—SnO₂, Fe₂O₃, magnetite, IndiumTinOxide, antimony-doped tin oxide, indium oxide, antimony oxide, fluorine-doped tin oxide, phosphorous-doped tin oxide, zinc antimonite, indium doped zinc oxide, acrylic polymers, acrylic copolymers, styrenic polymers, styrenic copolymers, polyvinylchloride polymers or vinylchloride copolymers;
Z is selected from a polysiloxane moiety; a halogenated moiety; a perhalogenated moiety; a dye moiety; a phosphorescent moiety; a fluorescent moiety; a cationic moiety; an ammonium moiety; an anionic moiety; an IR-absorbing moiety; a transition metal complex; and
in case that b is 0, A is a moiety of the formula 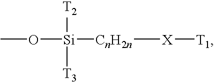
where
X is —NR₁₀₁—, and
R₁₀₁ is C₁-C₂₄acyl.

21. An article comprising an inorganic or organic substrate modified according to the process of claim 1.

22. (canceled)

23. A process according to claim 8, wherein the core nanoparticle comprises on its surface a material selected from silicon oxide, silica gel, aluminum oxide, titanium oxide, silicon oxide-coated TiO₂, zinc oxide, tin oxide, zirconium oxide, Ag, Au, Cu, Sb—SnO₂, Fe₂O₃, magnetite, IndiumTinOxide, antimony-doped tin oxide, indium oxide, antimony oxide, fluorine-doped tin oxide, phosphorous-doped tin oxide, zinc antimonite, indium doped zinc oxide, acrylic polymers, acrylic copolymers, styrenic polymers, styrenic copolymers, polyvinylchloride polymers and vinylchloride copolymers.
